(19) United States
(12) Patent Application Publication
(10) Pub. No.: US 2003/0115327 A1
(43) Pub. Date: Jun. 19, 2003

(54) Method and apparatus for setting up a firewall

(76) Inventors: Takeshi Kokado, Kyotanabe (JP); Yasunori Okada, Hirakata (JP); Kouji Kubota, Osaka (JP); Takahiro Saitou, Kusatsu (JP); Hirokazu Ishikawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/275,491

(22) PCT Filed: Mar. 14, 2002
(86) PCT No.: PCT/JP02/02394

(30) Foreign Application Priority Data
Mar. 16, 2001 (JP) 2001-076507
Jun. 29, 2001 (JP) 2001-199977

(51) Int. Cl. G06F 15/173

(52) U.S. Cl. 709/225

(57) ABSTRACT

The home gateway HGW (1) includes a communication section (31), an authentication function section (32), a directory management function section (33), and a communication path setting function section (34). The communication section (31) receives data transmitted to the HGW (1). The authentication function section (32) authenticates the aforementioned data to be from an authorized user or not. Responsive to a service registration, the directory management function section (33) registers service information, checks the matching between the service information and service permission policies, and requests the communication path setting function section (34) to set a communication path. The communication path setting function section (34) monitors the state of data communication along the communication paths, and closes any unnecessary communication paths that may have been set. As a result, it becomes possible to restrict the users who are entitled to accessing each terminal on an internal network from an external network, and to allow a user to access a selected terminal on an internal network.

### TECHNICAL FIELD

The present invention relates to prevention of unauthorized access from an external network to an internal network, and more particularly to a method and apparatus for setting a fire wall.

### BACKGROUND ART

Conventionally, it has been practiced to provide a fire wall apparatus between an external network, e.g., the Internet, and an internal network, e.g., a LAN (Local Area Network), to control data communication and protect the internal network from external attacks or unauthorized access. One type of fire wall apparatus is known as a packet filtering router type. A fire wall apparatus of the packet filtering router filter type transfers or blocks packets in the course of communications between an internal network and an external network according to certain rules. However, such a fire wall apparatus is not perfect. There is an increasing need for striking up security measures for protecting a network or a computer system from physical or logical acts of intrusion or destruction.

On the other hand, an IP address (Internet Protocol Address) used for an internal network, referred to as a local address (Local Address: hereinafter abbreviated as “LA”), is not valid for external networks. Therefore, through address conversion technique, an IP address is converted to a global address (Global Address: hereinafter abbreviated as “GA”), which is valid for an external network. An improved version of this address conversion technique is called IP masquerade (Masquerade). According to the IP masquerade technique, communication port numbers of TCP/UDP, a higher-level protocol, are identified. Based on the management of the correspondence between LA's and GA's, it becomes possible for a plurality of LA's to simultaneously communicate based on a single GA.

A network address conversion method which supports a plurality of terminals on an internal network, such that a GA can be shared in the aforementioned manner, is disclosed in Japanese Patent Laid-Open Publication No. 2000-59430. This method aims to allow a terminal on an internal network to communicate with a terminal which is connected to an external network, without requiring conversion of port numbers. According to this method, an internal table indicating address conversion rules is provided in an address conversion apparatus. The internal table stores the correspondence between: pairs (LP, IA) each consisting of a port number (LP) used for communication by a terminal on an internal network and an IP address (IA) of a terminal on an external network; and IP addresses (LA) of terminals on the internal network. Therefore, in accordance with this address conversion apparatus, based on the setting of the above-mentioned internal table, it is possible to restrict the external network terminals which are entitled to accessing each internal network terminal. By introducing such an address conversion method in a fire wall apparatus, a security measure is realized which restricts the external network terminals which are entitled to accessing each internal network terminal.

On the other hand, in a situation where various devices are interconnected over networks, a user may desire, by manipulating a device which is connected to one network, to obtain service information (e.g., control information or state information) of a device which is connected to another network, in order to control the latter device based on the obtained service information. However, in terms of network security, it would be undesirable to make all of the service information provided on the network available, and the devices associated with such service information controllable, to every user on the network.

As a solution to this problem, Japanese Patent Laid-Open Publication No. 11-275074 discloses a conventional network service management method in which information of different services is provided to different users on the network. According to this network service management method, when providing information occurring on a network to a user, it is ensured that different contents are provided depending on the status of the user. According to this exemplary method, users are classified as network administrators, service administrators, or users. For a given network shown in FIG. 51, information on the entire network shown in FIG. 52 is provided to a network administrator; information of services shown in FIG. 53 is provided to a service administrator; and only a path from a server to a user as shown in FIG. 54 is provided to a user.

However, the above-described address conversion method merely serves to restrict the terminal apparatuses on an external network which are entitled to accessing terminals on an internal network. In other words, not only authorized users but also anyone (including ill-intentioned third parties) using a terminal apparatus on an external network for which access is granted is entitled to accessing terminals on an internal network. Therefore, the above-described address conversion method is not quite satisfactory in terms of security aspects. Moreover, in the case where a plurality of users may use the same terminal apparatus on an external network, different users can only access the same internal network terminal; it is not that different users can connect to different terminals on the internal network. Furthermore, in the case where an internal network has a plurality of servers (e.g., FTP servers) which provide the same service, a user can only access one fixed server, rather than being able to access a selected one of such servers. Moreover, in the case where the terminal apparatuses on an external network are coupled to a telephone circuit network, for example, the IA's which are used for distinguishing the terminal apparatuses on the external network do not have fixed values but are subject to changes; therefore, the aforementioned internal table needs to be reorganized every time the IA's are changed. However, such reorganization is very cumbersome, making the address conversion for non-fixed value IA's difficult.

Accordingly, an object of the present invention is to provide a method and apparatus for setting a fire wall which can restrict the users who are entitled to accessing each terminal on an internal network from an external network, and which allows a user to access a selected terminal on an internal network.

On the other hand, according to the above-described device controlling method, when a new component element (a user, a service, etc.) is added to a network, it becomes necessary to set the items which can be allowed to be provided from the new component element to the network. In the case of a home network, for example, a user who is not very. familiar with network management may have to take care of such setting when connecting a device to a network. If the items to be allowed to be provided to the network are not well-selected, unrestricted access to such items can occur from outside of the house. Such situations are not desirable in terms of network security.

Accordingly, another object of the present invention is to provide an apparatus and method which, when a new component element is added to a network, sets preferable access restrictions responsive to a mere connection of the device, thereby providing sufficient security.

### DISCLOSURE OF THE INVENTION

To achieve the above objects, the present invention has the following aspects.

A first aspect of the present invention is directed to a fire wall apparatus for preventing unauthorized external access to an internal network having a plurality of servers which are coupled to an external terminal via an external network, wherein each of the plurality of servers provides a service, comprising:

a data processing section for processing communication data which is transmitted from the external terminal and setting a communication path between at least one of the plurality of servers and the external terminal based on the communication data, wherein the communication data at least comprises an external address of the external terminal and user identification data for identifying a user of the external terminal; and

a switching section for connecting the at least one server and the external terminal based on the communication path which is set by the data processing section,

wherein the data processing section includes:

a plurality of function sections; and

a communication section for receiving at least the communication data and requesting the plurality of function sections to perform processing based on the contents of the data,

wherein the plurality of function sections comprise:

an authentication function section for authenticating the user identification data;

a directory management function section for registering units of service information, where each unit of service information represents an internal address of one of the plurality of servers and a service type in association with predetermined permitted-recipient data designating an external user who is entitled to connecting to the server, and allowing a user who is given authentication by the authentication function section to select one of the units of service information whose permitted-recipient data designates the user; and

a communication path setting function section for setting the communication path using the internal address of the server represented by the unit of service information selected by means of the directory management function section and the external address of the external terminal.

Thus, according to the first aspect, limited external users are entitled to external accessing. After confirming user authentication, the external address of an external terminal used by a particular external user is acquired, and a communication path is set based on the acquired external address. As a result, a service provided on an internal network can be permitted for access by limited external users who are entitled to external accessing. Even if the external terminal used by the external user is altered, or if the external address of the external terminal used by the external user is changed, similar access can still be realized. When requesting a communication path to be set, the external user can selectively access an accessible service, and even if the same service is being provided by a plurality of servers on the internal network, the external user can access a selected one of such servers. On the other hand, it is possible to designate external users who are entitled to connecting a server on the internal network on a service-to-service basis. Therefore, the security level for each server can be easily adjusted by designating different external users who are entitled to accessing a plurality of servers providing the same service on an internal network.

According to a second aspect based on the first aspect, each unit of service information registered in the directory management function section is registered based on service data at least comprising the internal address and the service type, wherein the service data is transmitted from the server.

Thus, according to the second aspect, the service(s) to be permitted for access from an external network can be registered or altered in accordance with an instruction from a server which is connected to an internal network.

According to a third aspect based on the second aspect, the service data further comprises service deletion data indicating that the service provided by the server is unavailable, and

wherein each unit of service information registered in the directory management function section is deletable based on the service deletion data.

Thus, according to the third aspect, it is possible to instruct from a server on an internal network whether or not to permit each service on the server for access from an external network.

According to a fourth aspect based on the second aspect, the service data further comprises permitted-recipient alteration data for altering the permitted-recipient data, and

wherein an external user who is entitled to connecting to a service, as designated in each unit of service information registered in the directory management function section, is alterable based on the permitted-recipient alteration data.

Thus, according to the fourth aspect, from an internal network, it is possible to alter or designate external users who are entitled to accessing a service provided on the server.

According to a fifth aspect based on the second aspect, the service data further comprises server identification information for identifying the server in a fixed manner, and

wherein the directory management function section updates each unit of service information with respect to the internal address based on the server identification information.

Thus, according to the fifth aspect, when the internal address of a server on an internal network is altered, it is still possible to associate the server with the altered internal address by recognizing a fixed value which identifies the server. As a result, the alteration of a table which is necessary for internal address conversion can be automatically processed.

According to a sixth aspect based on the first aspect, each unit of service information registered in the directory management function section is registered based on service data at least comprising the internal address and the service type, wherein the service data is acquired from the server by the directory management function section.

Thus, according to the sixth aspect, a service to be permitted for access from an external network can be registered or altered without an instruction from a server which is connected to an internal network.

According to a seventh aspect based on the first aspect, the directory management function section registers each unit of service information based on service data at least comprising the internal address and the service type, and

wherein, if no permitted-recipient data is registered in association with the internal address of one of the plurality of servers and the service type in the directory management function section, the directory management function section automatically generates permitted-recipient data for the service data.

Thus, according to the seventh aspect, even if permitted-recipient data has not been registered, e.g., when a new server is connected to a network, corresponding permitted-recipient data can be dynamically generated. Therefore, a user does not need to set access restrictions at each time.

According to an eighth aspect based on the seventh aspect, the directory management function section comprises preset permitted-recipient data storage means for storing preset permitted-recipient data to be applied if no permitted-recipient data is registered in association with the internal address of one of the plurality of servers and the service type, and

wherein, if no permitted-recipient data is registered in association with the internal address of one of the plurality of servers and the service type in the directory management function section, the directory management function section newly generates the permitted-recipient data for the service data based on the preset permitted-recipient data.

Thus, according to the eighth aspect, if no corresponding permitted-recipient data is present, preferable permitted-recipient data can be generated on predetermined preset permitted-recipient data.

According to a ninth aspect based on the seventh aspect, if no permitted-recipient data is registered in association with the internal address of one of the plurality of servers and the service type in the directory management function section, the directory management function section selects from among the currently registered permitted-recipient data those permitted-recipient data which match a set of conditions stipulated in the service data except for one or more of the conditions, and newly generates the permitted-recipient data for the service data based on the selected permitted-recipient data.

Thus, according to the ninth aspect, if no corresponding permitted-recipient data is present, preferable permitted-recipient data can be generated on permitted-recipient data which is already registered.

According to a tenth aspect based on the seventh aspect, the directory management function section comprises preset permitted-recipient data storage means for storing preset permitted-recipient data to be applied if no permitted-recipient data is registered in association with the internal address of one of the plurality of servers and the service type, and

wherein, if no permitted-recipient data is registered in association with the internal address of one of the plurality of servers and the service type in the directory management function section, the directory management function section selects from among the currently registered permitted-recipient data those permitted-recipient data which match a set of conditions stipulated in the service data except for one or more of the conditions, and

a) newly generates the permitted-recipient data for the service data based on the selected permitted-recipient data if the number of selected permitted-recipient data is equal to or greater than a predetermined value; or

b) newly generates the permitted-recipient data for the service data based on the preset permitted-recipient data if the number of selected permitted-recipient data is smaller than the predetermined value. Thus, according to the tenth aspect, if no corresponding permitted-recipient data is present, either of the following operations is performed. If a predetermined number or more of permitted-recipient data are available for inferring the relevant permitted-recipient data from, then the relevant permitted-recipient data is generated based on inference from the predetermined number or more of permitted-recipient data. If a predetermined number or more of permitted-recipient data are not present, then the relevant permitted-recipient data is generated based on preset permitted-recipient data. As a result, it is possible to preclude the danger of any undesirable settings being made by relying on an insufficient amount of permitted-recipient data to infer the relevant permitted-recipient data with.

According to an eleventh aspect based on the first aspect, each unit of service information registered in the directory management function section is deleted when a predetermined period of time expires.

Thus, according to the eleventh aspect, a validity term is defined for each service which can be permitted for access from an external network. Since a communication path is temporarily set only while the service is valid, and since the communication path is dedicated to each service, further enhanced security can be provided.

According to a twelfth aspect based on the first aspect, the communication path setting function section monitors data transmitted through the communication path having been set, and closes the communication path if no data is transmitted through the communication path in a predetermined period.

Thus, according to the twelfth aspect, even after setting a communication path for a service which can be permitted for access from an external network, if the communication path is not used by external users during a period which is previously set with respect to that service, the communication path is closed. Thus, further enhanced security can be provided.

According to a thirteenth aspect based on the first aspect, the communication path setting function section closes the communication path upon receiving service communication termination data transmitted from the external terminal, wherein the service communication termination data indicates termination of a service communication with the server.

According to a fourteenth aspect based on the first aspect, the communication path setting function section closes the communication path upon receiving service communication termination data transmitted from the server, wherein the service communication termination data indicates termination of a service communication with the external terminal.

Thus, according to the thirteenth and fourteenth aspects, a communication path can be closed upon receiving service communication termination data from an external terminal or a server. Therefore, external access can be prevented beyond a period for which the service can be permitted for access.

A fifteenth aspect of the present invention is directed to a fire wall apparatus for preventing unauthorized external access to an internal network having a plurality of servers which are coupled to a plurality of external terminals via an external network, wherein each of the plurality of servers provides a service, comprising:

a data processing section for processing communication data containing service data which is transmitted from at least one of the plurality of servers and setting a communication path between the server and at least one of the plurality of external terminals based on the communication data, wherein the service data at least comprises an internal address of the server and a service type; and

a switching section for connecting the server and the external terminal based on the communication path which is set by the data processing section,

wherein the data processing section includes:

a plurality of function sections; and

a communication section for receiving at least the service data and requesting the plurality of function sections to perform processing based on the contents of the data,

wherein the plurality of function sections comprise:

a directory management function section for registering units of service information, where each unit of service information represents the internal address and the service type in association with predetermined permitted-recipient data designating at least one of the plurality of external terminals which is entitled to connecting to the server; and

a communication path setting function section for, when the service information is registered, setting the communication path using the external address of at least one of the plurality of external terminals designated by the permitted-recipient data and the internal address of the server.

Thus, according to the fifteenth aspect, when service information is registered in the directory management function section based on an instruction from a server, a communication path to the designated permitted recipient can be set even in the absence of communication data from an external terminal.

According to a sixteenth aspect based on the fifteenth aspect, the permitted-recipient data registered in the directory management function section designate all of the plurality of external terminals to be entitled to connecting to the server.

Thus, according to the sixteenth aspect, a service provided by a server on an internal network can be permitted for access by the external terminals without limitation.

A seventeenth aspect of the present invention is directed to a fire wall setting method for preventing unauthorized external access to an internal network having a plurality of servers which are coupled to an external terminal via an external network, wherein each of the plurality of servers provides a service, comprising:

a data processing step of processing communication data which is transmitted from the external terminal and setting a communication path between at least one of the plurality of servers and the external terminal based on the communication data, wherein the communication data at least comprises an external address of the external terminal and user identification data for identifying a user of the external terminal; and

a connection step of connecting the at least one server and the external terminal based on the communication path which is set by the data processing step,

wherein the data processing step includes:

a communication step of receiving at least the communication data and requesting a plurality of steps to perform processing based on the contents of the data,

wherein the plurality of steps comprise:

an authentication step of authenticating the user identification data;

a directory management step of registering units of service information, where each unit of service information represents an internal address of one of the plurality of servers and a service type in association with predetermined permitted-recipient data designating an external user who is entitled to connecting to the server, and allowing a user who is given authentication by the authentication step to select one of the units of service information whose permitted-recipient data designates the user; and

a communication path setting step of setting the communication path using the internal address of the server represented by the unit of service information selected by means of the directory management step and the external address of the external terminal.

According to an eighteenth aspect based on the seventeenth aspect, each unit of service information registered in the directory management step is registered based on service data at least comprising the internal address and the service type, wherein the service data is transmitted from the server.

According to a nineteenth aspect based on the eighteenth aspect, the service data further comprises service deletion data indicating that the service provided by the server is unavailable, and

wherein each unit of service information registered in the directory management step is deletable based on the service deletion data.

According to a twentieth aspect based on the eighteenth aspect, the service data further comprises permitted-recipient alteration data for altering the permitted-recipient data, and

wherein an external user who is entitled to connecting to a service, as designated in each unit of service information registered in the directory management step, is alterable based on the permitted-recipient alteration data.

According to a twenty-first aspect based on the eighteenth aspect, the service data further comprises server identification information for identifying the server in a fixed manner, and

wherein the directory management step updates each unit of service information with respect to the internal address based on the server identification information.

According to a twenty-second aspect based on the seventeenth aspect, each unit of service information registered in the directory management step is registered based on service data at least comprising the internal address and the service type, wherein the service data is acquired from the server by the directory management step.

According to a twenty-third aspect based on the seventeenth aspect, the directory management step registers each unit of service information based on service data at least comprising the internal address and the service type, and

wherein, if no permitted-recipient data is registered in association with the internal address of one of the plurality of servers and the service type in the directory management step, the directory management step automatically generates permitted-recipient data for the service data.

According to a twenty-fourth aspect based on the twenty-third aspect, the directory management step comprises a preset permitted-recipient data storage step of storing preset permitted-recipient data to be applied if no permitted-recipient data is registered in association with the internal address of one of the plurality of servers and the service type, and

wherein, if no permitted-recipient data is registered in association with the internal address of one of the plurality of servers and the service type in the directory management step, the directory management step newly generates the permitted-recipient data for the service data based on the preset permitted-recipient data.

According to a twenty-fifth aspect based on the twenty-third aspect, if no permitted-recipient data is registered in association with the internal address of one of the plurality of servers and the service type in the directory management step, the directory management step selects from among the currently registered permitted-recipient data those permitted-recipient data which match a set of conditions stipulated in the service data except for one or more of the conditions, and newly generates the permitted-recipient data for the service data based on the selected permitted-recipient data.

According to a twenty-sixth aspect based on the twenty-third aspect, the directory management step comprises a preset permitted-recipient data storage step of storing preset permitted-recipient data to be applied if no permitted-recipient data is registered in association with the internal address of one of the plurality of servers and the service type, and

wherein, if no permitted-recipient data is registered in association with the internal address of one of the plurality of servers and the service type in the directory management step, the directory management step selects from among the currently registered permitted-recipient data those permitted-recipient data which match a set of conditions stipulated in the service data except for one or more of the conditions, and

a) newly generates the permitted-recipient data for the service data based on the selected permitted-recipient data if the number of selected permitted-recipient data is equal to or greater than a predetermined value; or

b) newly generates the permitted-recipient data for the service data based on the preset permitted-recipient data if the number of selected permitted-recipient data is smaller than the predetermined value.

According to a twenty-seventh aspect based on the seventeenth aspect, each unit of service information registered in the directory management step is deleted when a predetermined period of time expires.

According to a twenty-eighth aspect based on the seventeenth aspect, the communication path setting step monitors data transmitted through the communication path having been set, and closes the communication path if no data is transmitted through the communication path in a predetermined period.

According to a twenty-ninth aspect based on the seventeenth aspect, the communication path setting step closes the communication path upon receiving service communication termination data transmitted from the external terminal, wherein the service communication termination data indicates termination of a service communication with the server.

According to a thirtieth aspect based on the seventeenth aspect, the communication path setting step closes the communication path upon receiving service communication termination data transmitted from the server, wherein the service communication termination data indicates termination of a service communication with the external terminal.

A thirty-first aspect of the present invention is directed to a fire wall setting method for preventing unauthorized external access to an internal network having a plurality of servers which are coupled to a plurality of external terminals via an external network, wherein each of the plurality of servers provides a service, comprising:

a data processing step of processing communication data containing service data which is transmitted from at least one of the plurality of servers and setting a communication path between the server and at least one of the plurality of external terminals based on the communication data, wherein the service data at least comprises an internal address of the server and a service type; and

a connection step of connecting the server and the external terminal based on the communication path which is set by the data processing step,

wherein the data processing step includes:

a communication step of receiving at least the service data and requesting a plurality of steps to perform processing based on the contents of the data,

wherein the plurality of steps comprise:

a directory management step of registering units of service information, where each unit of service information represents the internal address and the service type in association with predetermined permitted-recipient data designating at least one of the plurality of external terminals which is entitled to connecting to the server; and

a communication path setting step of, when the service information is registered, setting the communication path using the external address of at least one of the plurality of external terminals designated by the permitted-recipient data and the internal address of the server.

According to a thirty-second aspect based on the thirty-first aspect, the permitted-recipient data registered in the directory management step designate all of the plurality of external terminals to be entitled to connecting to the server.

### BRIEF DESCRIPTION OF THE DRAWINGS

FIG. 1 is a diagram illustrating the fundamental structure of a fire wall apparatus according to a first embodiment of the present invention.

FIG. 2 is a block diagram illustrating the fundamental structure of the internal hardware of the fire wall apparatus according to the first embodiment of the present invention.

FIG. 3 is a block diagram illustrating the fundamental software structure of the fire wall apparatus according to the first embodiment of the present invention.

FIG. 4 is a flowchart illustrating the operation of a communication path setting process performed in the fire wall apparatus according to the first embodiment of the present invention.

FIG. 5 is a flowchart showing the subroutine shown as step S104 in FIG. 4.

FIG. 6 is a flowchart illustrating the operation by the fire wall apparatus according to the first embodiment of the present invention in which a communication path is externally set for an authentication-requiring service.

FIG. 7 is a flowchart illustrating the operation of the service validity term management performed by the fire wall apparatus according to the first embodiment of the present invention.

FIG. 8 shows an example of service information which may be stored in a directory management function section 33 of the fire wall apparatus according to the first embodiment of the present invention.

FIG. 9 shows exemplary basic service permission policies which may be previously set in a directory management function section 33 of the fire wall apparatus according to the first embodiment of the present invention.

FIG. 10 shows exemplary detailed service permission policies which may be set in a directory management function section 33 of the fire wall apparatus according to the first embodiment of the present invention.

FIG. 11 illustrates information pertaining to a packet filter which is set in an IP filter function section 23 of the fire wall apparatus according to the first embodiment of the present invention for permitting communications from an internal network to an external network.

FIG. 12 shows: (a) a communication sequence for an FTP service, (b) an address conversion table which is set in a address conversion function section 25 by a directory management function section 33, and (c) a packet filter which is set in an IP filter function section 23, of the fire wall apparatus according to the first embodiment of the present invention.

FIG. 13 is a flowchart illustrating the operation of a portion of a communication path setting process performed in the fire wall apparatus according to the first embodiment of the present invention.

FIG. 14 is a flowchart illustrating the operation of a portion of a communication path setting process performed in the fire wall apparatus according to the first embodiment of the present invention.

FIG. 15 shows an example of service information which may be stored in a directory management function section 33 of the fire wall apparatus according to the first embodiment of the present invention.

FIG. 16 shows exemplary detailed service 'permission policies which may be set in a directory management function section 33 of the fire wall apparatus according to the first embodiment of the present invention.

FIG. 17 illustrates the structure of a communication apparatus 100 according to a second embodiment of the present invention, as well as networks and devices connected thereto.

FIG. 18 shows an example of element information which may be stored in a network information storage section 123 of the communication apparatus 100.

FIG. 19 shows an operation sequence of the communication apparatus 100 in the case where a controlled device 151 is newly connected to an IEEE1394 bus 170.

FIG. 20 shows an exemplary displayed image of a control menu acquired by a controlling terminal 141 from the communication apparatus 100.

FIG. 21 shows examples of restriction entries which may be stored in a restriction entry management section 130 of the communication apparatus 100.

FIG. 22 shows other examples of restriction entries which may be stored in a restriction entry management section 130 of the communication apparatus 100.

FIG. 23 illustrates an operation sequence of the communication apparatus 100 in the case where a control menu is requested from a controlling terminal 141.

FIG. 24 shows exemplary preset restriction entries which may be registered in a preset restriction entry storage section 132 of the communication apparatus 100.

FIG. 25 is a flowchart illustrating the operation of a restriction entry generation section 131 of the communication apparatus 100.

FIG. 26 shows an exemplary displayed image of a control menu acquired by a controlling terminal 141 from the communication apparatus 100.

FIG. 27 illustrates the structure of a communication apparatus 1000 according to a third embodiment of the present invention, as well as networks and devices connected thereto.

FIG. 28 illustrates an operation sequence of the communication apparatus 1000 in the case where a controlled device 151 is newly connected to an IEEE1394 bus 170.

FIG. 29 shows an example of information which may be stored in a network information storage section 123 of the communication apparatus 1000.

FIG. 30 illustrates an operation sequence of the communication apparatus 1000 in the case where a control menu is requested from a controlling terminal 141.

FIG. 31 shows examples of restriction entries which may be stored in an individual restriction entry storage section 133 of the communication apparatus 1000.

FIG. 32 is a flowchart illustrating the operation of a restriction entry generation section 131 of the communication apparatus 1000.

FIG. 33 shows an exemplary displayed image of a control menu acquired by a controlling terminal 141 from the communication apparatus 1000.

FIG. 34 shows an exemplary displayed image of a control menu acquired by a controlling terminal 141 from the communication apparatus 1000.

FIG. 35 illustrates the structure of a communication apparatus 1800 according to a fourth embodiment of the present invention, as well as networks and devices connected thereto.

FIG. 36 illustrates an operation sequence of the communication apparatus 1800 in the case where a controlled device 151 is newly connected to an IEEE1394 bus 170.

FIG. 37 shows an example of information which may be stored in a network information storage section 123 of the communication apparatus 1800.

FIG. 38 illustrates an operation sequence of the communication apparatus 1800 in the case where a control menu is requested from a controlling terminal phone 141, particularly in the case where the number of matching restriction entries is smaller than three.

FIG. 39 shows examples of restriction entries which may be stored in an individual restriction entry storage section 133 of the communication apparatus 1800.

FIG. 40 shows examples of preset restriction entries which may be stored in a preset restriction entry storage section 132 of the communication apparatus 1800.

FIG. 41 illustrates an operation sequence of the communication apparatus 1800 in the case where a control menu is requested from a controlling terminal phone 141, particularly in the case where the number of matching restriction entries is equal to or greater than three.

FIG. 42 is a flowchart illustrating the operation of a restriction entry generation section 1831 of the communication apparatus 1800.

FIG. 43 shows an exemplary displayed image of a control menu acquired by a controlling terminal 141 from the communication apparatus 1800.

FIG. 44 illustrates the structure of a communication apparatus 2700 according to a fifth embodiment of the present invention, as well as networks and devices connected thereto.

FIG. 45 illustrates an operation sequence of the communication apparatus 2700 in the case of acquiring service information.

FIG. 46 shows an example of information which may be stored in a network information storage section 123 of the communication apparatus 2700.

FIG. 47 illustrates an operation sequence of the communication apparatus 2700 in the case where a control menu is requested from a controlling terminal 141.

FIG. 48 shows examples of individual restriction entries which may be stored in an individual restriction entry storage section 133 of the communication apparatus 2700.

FIG. 49 shows examples of preset restriction entries which may be stored in a preset restriction entry storage section 132 of the communication apparatus 2700.

FIG. 50 is a flowchart illustrating the operation of a restriction entry generation section 131 of the communication apparatus 2700.

FIG. 51 shows the overall configuration of a network according to a conventional network service management system.

FIG. 52 shows the network information which is provided to a network administrator under a conventional network service management system.

FIG. 53 shows network information which is provided to a service administrator under a conventional network service management system.

FIG. 54 shows network information which is provided to a user of a user terminal under a conventional network service management system.

### BEST MODE FOR CARRYING OUT THE INVENTION

Hereinafter, various embodiments of the present invention will be described with reference to the figures.

### FIRST EMBODIMENT

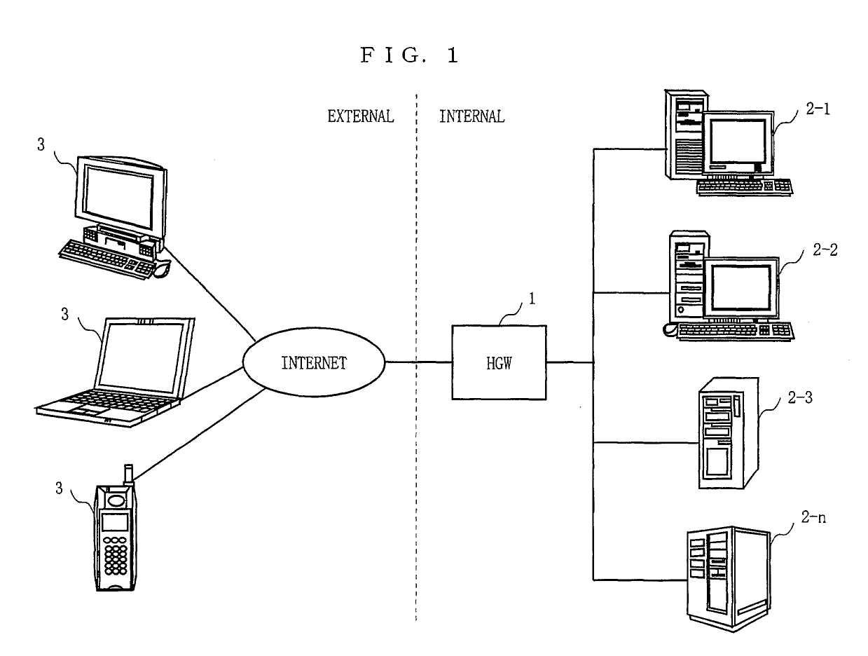

FIG. 1 is a diagram illustrating the fundamental structure of a fire wall apparatus according to a first embodiment of the present invention. Hereinafter, the present embodiment will be described with reference to FIG. 1.

As shown in FIG. 1, according to the present embodiment, a plurality of servers 2-1 to 2-n are coupled to a home gateway apparatus (hereinafter abbreviated as “HGW”) 1 via bus connection, thereby creating a LAN as an internal network. As an external network, a plurality of external terminals 3 are coupled to the HGW 1 via the Internet. Any internal terminals other than the servers 2-1 to 2-n may also be coupled to the internal network, and any external servers other than the external terminals 3 may also be coupled to the external network.

The HGW 1 has a global IP address (GA) assigned thereto, which is used for the purpose of transmission/reception with an external network. Moreover, the HGW 1 performs transmission/reception of packets by using a plurality of port numbers (GP). Each of the servers 2-1 to 2-n has a uniquely assigned local IP address (LA) 1 to n, respectively. Moreover, each of the servers 2-1 to 2-n has port numbers (LP) 1 to n, which respectively correspond to different services provided by that server, for receiving communications from a client terminal. Each external terminal 3 has assigned thereto a global IP address (IA) used for the purpose of transmission/reception with an external network and a port number (IP) employed for such transmission/reception.

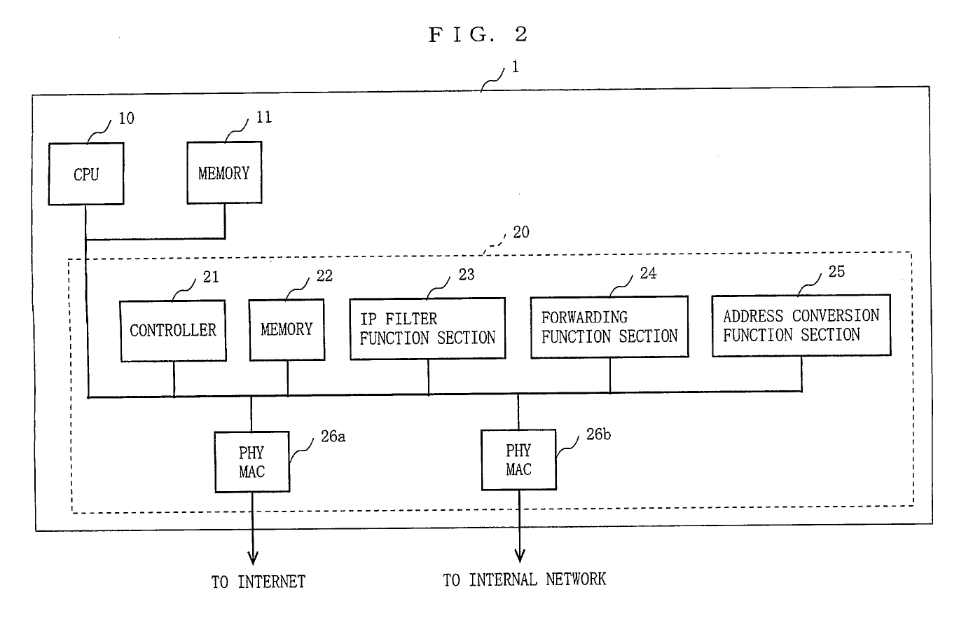

Next, the fundamental structure of the internal hardware of the HGW 1 above will be described. FIG. 2 is a block diagram illustrating the fundamental structure of the internal hardware of the HGW 1 according to the present embodiment. Hereinafter, the HGW 1 will be described with reference to FIG. 2.

As shown in FIG. 2, the HGW 1 comprises a CPU 10, a memory 11, and an IP switching section 20. The IP switching section 20 includes: a controller 21, a memory 22, an IP filter function section 23, a forwarding function section 24, an address conversion function section 25, and PHY/MAC (Physical Layer Protocol/Media Access Control) function sections 26a and 26b. The CPU 10 controls the respective function sections and performs processing to transmitted or received data. The memory 11 stores operation programs, data, and the like for the HGW 1. The controller 21 receives setting information from the CPU 10, and sets the IP filter function section 23, the forwarding function section 24, and the address conversion function section 25 based on the setting information. The PHY/MAC function sections 26 perform data transmission/reception to or from an external network or an internal network. The controller 21 instructs the IP filter function section 23, the forwarding function section 24, and the address conversion function section 25 to process data which is received by the PHY/MAC function sections 26. The memory 22 temporarily stores packet data which has been received by the PHY/MAC function sections 26. The IP filter function section 23, which has an internal register for storing a filtering condition, checks the packet data stored in the memory 22 based on the filtering condition stored in the register. If given packet data fails to satisfy the filtering condition, the IP filter function section 23 destroys that packet data. The forwarding function section 24, which has an internal register for storing forwarding information, determines which PHY/MAC function section 26 to transfer given packet data stored in the memory 22 based on the information stored in the register, thereby controlling the transfer of the packet data. The address conversion function section 25, which has an internal register for storing address conversion information, performs IP address conversion for the packet data stored in the memory 22 based on the address conversion information stored in the register.

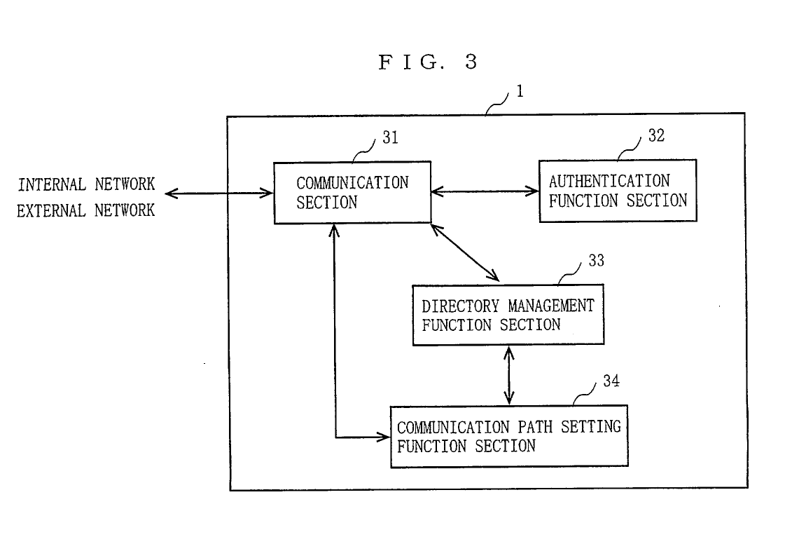

Next, the fundamental software structure of the above-described HGW 1 will be illustrated. FIG. 3 is a block diagram illustrating the fundamental software structure of the HGW 1 according to the present embodiment. Hereinafter, the HGW 1 will be described with reference to FIG. 3.

As shown in FIG. 3, the HGW 1 includes a communication section 31, an authentication function section 32, a directory management function section 33, and a communication path setting function section 34. The communication section 31 receives data transmitted from an external terminal 3 or a server 2 to the HGW 1, and requests appropriate function sections to process the data depending on the contents of the data. The authentication function section 32 manages the authentication information, and authenticates the aforementioned data to be from an authorized user or not. Responsive to a service registration from a server 2, the directory management function section 33 registers and manages service information (the details of which will be described later), checks the matching between the service information and service permission policies (the details of which will be described later), and requests the communication path setting function section 34 to set a communication path as necessary. The communication path setting function section 34 sets the IP filter function section 23, the forwarding function section 24, the address conversion function section 25, an application GW (gateway), and the like, and sets a communication path. The communication path setting function section 34 monitors the state of data communication along the communication paths, and closes any unnecessary communication paths that may have been set.

Once the present fire wall apparatus sets a communication path in the switching section 20 of the HGW 1, an external terminal 3 on an external network and a server 2 on an internal network become capable of connecting to each other, so that a service on the server 2 is permitted for access from an external network. The services which are provided on the server 2 on the internal network and which can be permitted for access are managed in the form of service information (the details of which will be described later), and communication paths are set based on this service information. In accordance with the present fire wall apparatus, either “authentication free” services (which do not require authentication of an external user), “permitted after authentication” services (which require authentication of an external user), or “non-permitted” services (which are not permitted for access from any external networks) can be set as a mode of permission. As for the above-defined “authentication free” service, a communication path is set as soon as the service is registered in the service information, so that any user becomes entitled to access from an external network. As for the above-defined “permitted after authentication” service, a communication path is temporarily set when an authorized user desires access to that service, so that only authorized users are entitled to access. Each of the aforementioned services which can be permitted for access has a validity term, and after the validity term is over, is deleted from the service information. Hereinafter, each of the aforementioned communication path setting processes will be described.

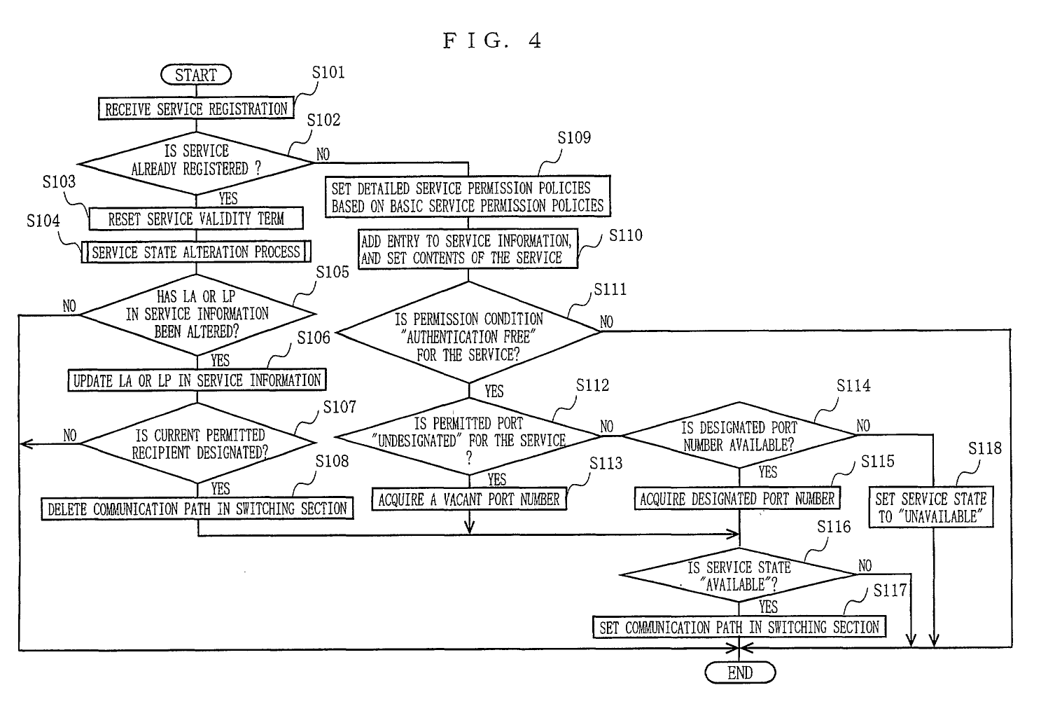

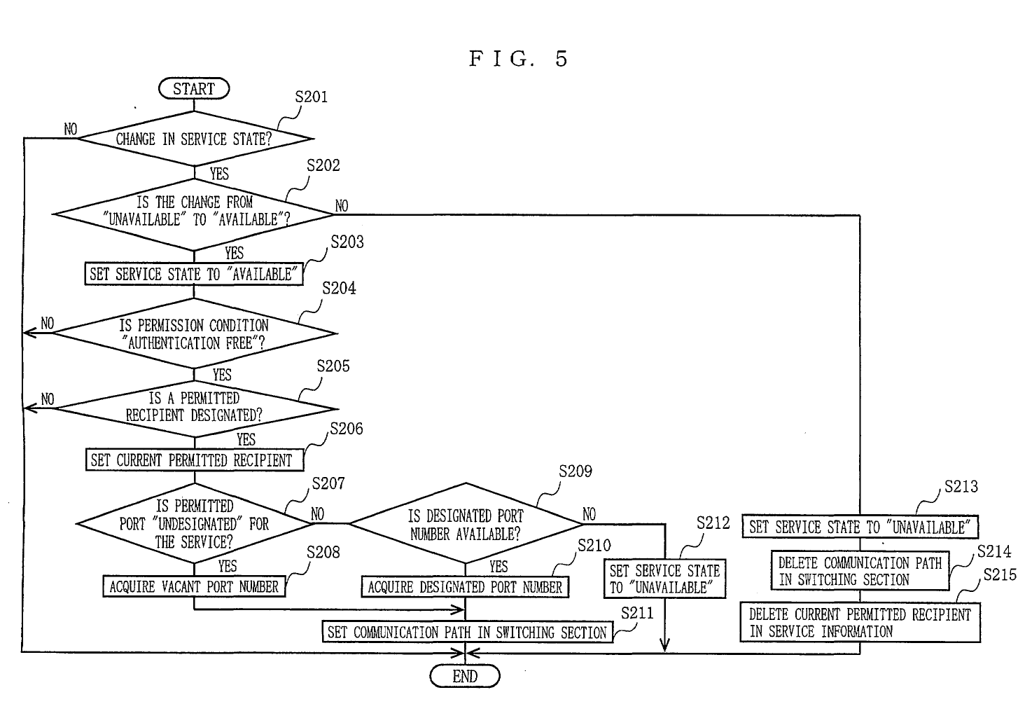

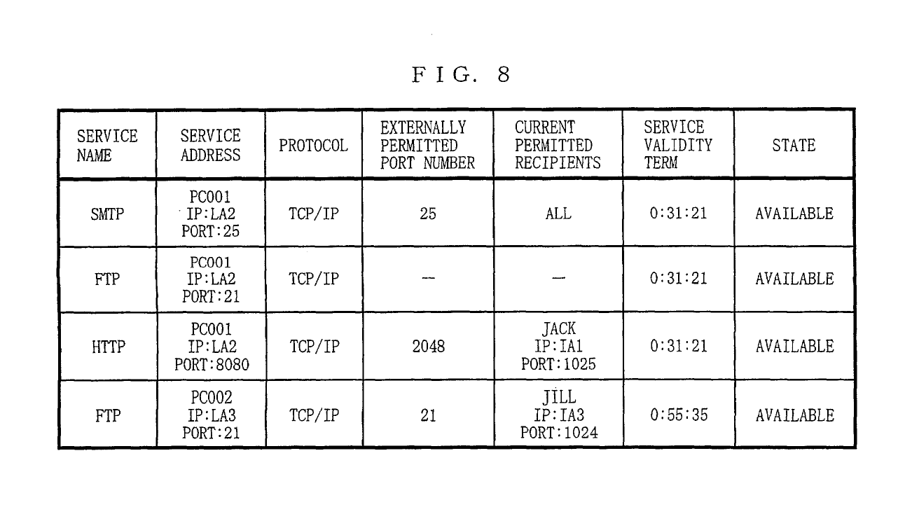

First, the service information setting process and the communication path setting process for “authentication free” services, which are performed in the HGW 1, will be described. FIGS. 4 and 5 are flowcharts illustrating the operation of a communication path setting process performed in the HGW 1. FIGS. 8 to 10 show information tables which are generated and used during the communication path setting process performed in the HGW 1. Hereinafter, with reference to FIGS. 4, 5, and 8 to 10, the communication path setting process will be described.

Referring to FIG. 4, the HGW 1 receives a service registration from a server 2 for registering a service which is compliant with SMTP (Simple Mail Transfer Protocol), FTP (File Transfer Protocol), or HTTP (Hyper Text Transfer Protocol), etc., in the directory management function section 33 (step S101).

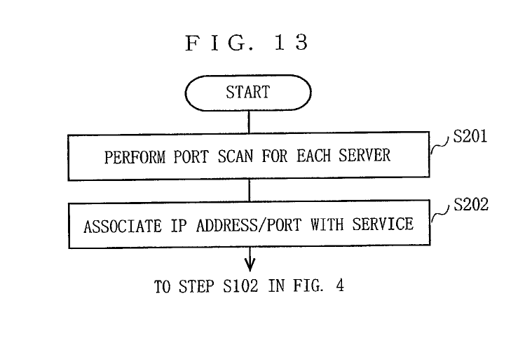

Although the present example illustrates the case where a server 2 makes a service registration to the HGW 1, the present invention is not limited thereto; alternatively, the HGW 1 may acquire service information from a server 2. In that case, the directory management function section 33 executes a process shown in FIG. 13 instead of step S101 in FIG. 4. Specifically, the directory management function section 33 first scans for ports on a server 2 connected to an internal network to search for any ports which are being used by the server 2 (S201). If a port being used by the server is a port which is predetermined under the service specifications (i.e., a so-called “well-known port”), it is certain that a service corresponding to that port is being provided by the server (S202). If a port being used by a server is not a well-known port, the service being provided by the server can be detected by confirming a reply message to the port scan. Examples of methods for the HGW 1 to know that a new server has been connected include detection upon the assignment of a new IP address by DHCP (Dynamic Host Configuration Protocol) and detection through monitoring the MAC address of an ARP (Address Resolution Protocol) packet. In the case of using a network which is designed to be capable of detecting the connection of a new device, as in the case of IPover1394, the HGW 1 detects the connection of a new device by utilizing the mechanism of the network, and acquires service information from this server.

Next, with respect to the service which is subjected to the service registration received, the HGW 1 refers to the service information stored in the directory management function section 33 to determine whether or not a pair consisting of a service type and the server identification information of the service has already been registered in the service information (step S102).

FIG. 8 shows an example of service information which may be stored in the directory management function section 33. The service information is the information indicating which services on a server 2 on the internal network can be permitted for access from an external network, and also manages therewithin the information for setting a communication path in the switching section 20. The service information is stored in the directory management function section 33 in the form of a table which associates service names, service addresses, protocols, externally permitted port numbers (GP), currently permitted recipients, service validity terms, and states with one another. A “service name” represents a service type to be permitted for access from an external network. A “service address” represents server identification information, an LA, and an LP of a server 2. As used herein, “server identification information” means a fixed value by which each server 2 is identified, e.g., a MAC address or a serial number of a server apparatus. A “currently permitted recipient” represents a permitted recipient to which a communication path is set in the switching section 20 of the HGW 1. In the case of a service which is permitted for access by limited users or terminals that are entitled to externally accessing, the user names of such users as well as the IA's and IP's of the external terminals 3 are indicated as the currently permitted recipients. A “service validity term” represents a remainder of the permission validity term of each service type, which is previously set for each service type. A “state” represents whether a given service is currently available or not. Note that, when services are registered in the service information, any service which has the same service type as an existing service but has different server identification information therefrom will be processed as a new service, rather than being regarded as already registered. In other words, services which are supported by each server 2 are registered in the service information on a server to server basis.

If step S102 determines that a pair consisting of a service type and server identification information of the service which is subjected to the aforementioned service registration has not been registered in the service information, the HGW 1 sets detailed service permission policies, based on basic service permission policies which are previously set in the directory management function section 33 (step S109).

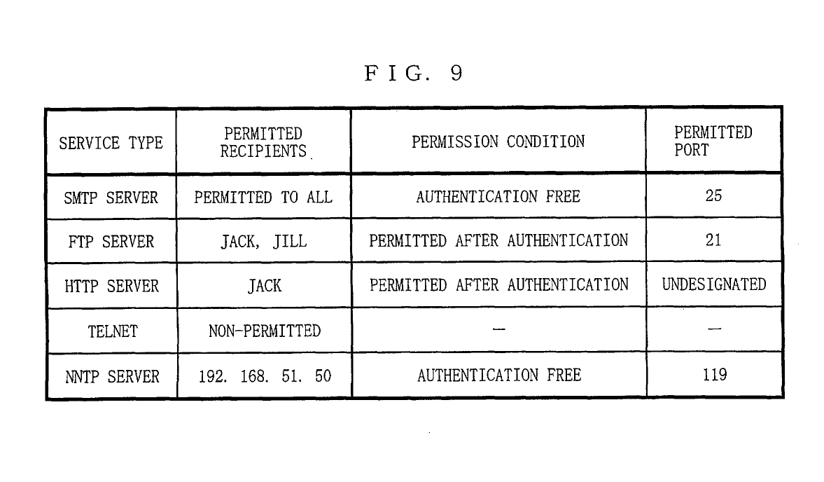

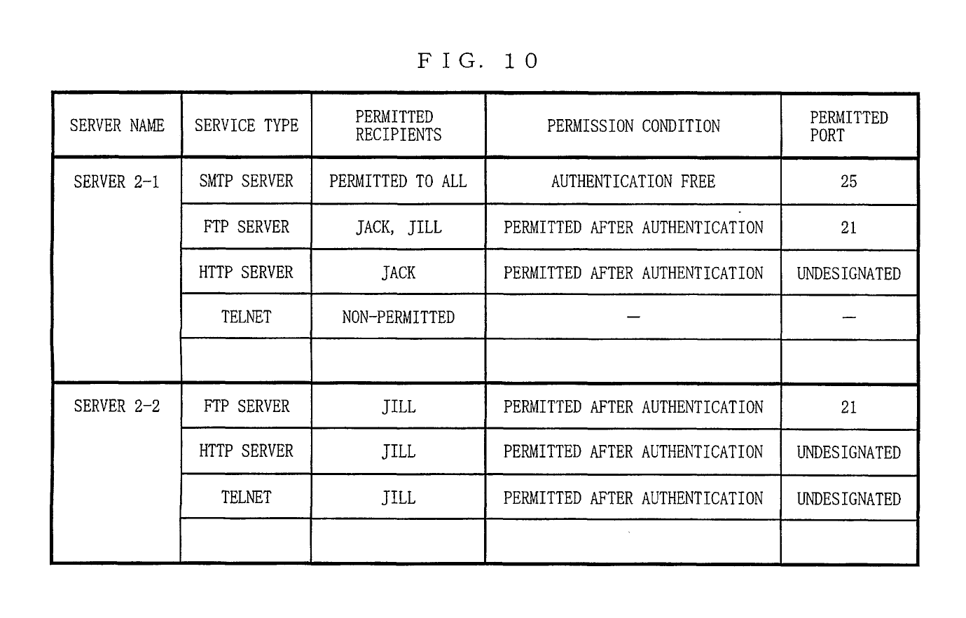

FIG. 9 shows exemplary basic service permission policies which may be previously set in the directory management function section 33. FIG. 10 shows exemplary detailed service permission policies which may be set in the directory management function section 33. The basic service permission policies comprise a permitted recipient, a permission condition, and a permitted port, which are previously set in the directory management function section 33 as conditions for being entitled to externally accessing each service type. As the permitted recipient(s), one or more user names are set in the case where permission is directed to limited users who are entitled to externally accessing; or in the case where permission is directed to limited external terminals 3 which are entitled to connecting, the IA(s) of one or more terminals are set. If the permission condition is “authentication free” and the permitted recipient is “permitted to all”, the service is meant to be accessible to any external users, and therefore a communication path is set in the switching section 20 as soon as the service is registered in the service information. If the permission condition is “authentication free” and the permitted recipient is the IA of an external terminal 3, a communication path is set in the switching section 20 once the service is registered in the service information. On the other hand, if the permission condition is “permitted after authentication”, a communication path is temporarily set in the switching section 20 when a user who is registered as a permitted recipient user wishes to access the service. At step S109, based on the above-described basic permission policies, the aforementioned connecting conditions are set as the detailed service permission policies for each service type, with respect to each server 2. Accordingly, since the aforementioned connecting conditions are set for each server 2 as the detailed service permission policies, the administrator of the server 2 can alter the connecting conditions according to the circumstances. In the case where it is unnecessary to alter the connecting conditions, the connecting conditions stipulated in the aforementioned basic service permission policies are applied as the detailed service, permission policies. In the case where the relevant service type is not found in the basic service permission policies, then the permitted recipient is set to “non-permitted”.

Next, the HGW 1 adds the service subjected to the service registration as an entry to the service information, and sets the contents of the service indicated in the service information (step S110). Then, the HGW 1 refers to the detailed service permission policies to determine whether the permission condition for the service of interest is “authentication free” or not (step S111). If the permission condition is not “authentication free” the HGW 1 ends the flow. If the permission condition is “authentication free”, the HGW 1 then determines whether the permitted port in the detailed service permission policies is “undesignated” or not (step S112). If the permitted port is “undesignated”, the HGW 1 sets a vacant port number (GP) (step S113), and then proceeds to step S116. On the other hand, if the permitted port is designated, the HGW 1 determines whether the designated port (GP) is available or not (step S114). If the designated GP is available, the HGW 1 acquires that GP (step S115), and proceeds to step S116. Next, the HGW 1 refers to the service information to determine whether the state of the service is “available” or not (step S116). If the state is “unavailable”, the flow is ended. If the state is “available” and the permitted recipient is “permitted to all”, the HGW 1 acquires the internal address information (LA and LP) and the address information for external permission (GA of the HGW 1 and GP above) with respect to the service of interest, and sets the IP filter function section 23 and the address conversion function section 25, thereby setting a communication path in the switching section-20 (step S117); thereafter, the flow is ended. If step S117 determines that the state is “available” and the permitted recipient is the IA of an external terminal 3, the HGW 1 acquires the internal address information (LA and LP), the address information for external permission (GA of the HGW 1 and GP above) and the address information of the external terminal 3 (IA and IP of external terminal 3) with respect to the service of interest, and sets the IP filter function section 23 and the address conversion function section 25, thereby setting a communication path in the switching section 20.

On the other hand, if it is determined at step S114 that the designated GP is unavailable, the HGW 1 refers to the service information and sets the state of the service of interest to “unavailable” (step S118), and ends the flow. This means that the address conversion function section 25 cannot be set using the designated port number GP. For example, if a given external terminal 3 makes a communication request for an FTP service, to a plurality of servers 2 on the internal network by using the same port number, then the address conversion function section 25 cannot set address conversion conditions, and thus the designated GP is determined as unavailable.

On the other hand, if it is determined at step S102 that a pair consisting of the service type and the server identification information of the service of interest has already been registered in the service information, the HGW 1 refers to the service information to reset the service validity term of the service of interest (step S103). The resetting of the service validity term may be performed by initializing to a permission validity term which is previously determined for each service type, or a new permission validity term may be set. Next, if the state of the service should change, a state alteration process is performed (step S104). The details of step S104 will be described later. Then, the HGW 1 refers to the service information to determine whether the LA or LP for the service have been altered or not (step S105). If no alteration has been made, the HGW 1 ends the flow. If it is determined at step S105 that the LA or LP for the service has been altered, the HGW 1 updates, with respect to the service, the LA or LP of the service address that is indicated in the service information (step S106). Thereafter, the HGW 1 determines whether or not a currently permitted recipient is designated in the service information of the service of interest (step S107). If a currently permitted recipient is designated, the HGW 1 deletes the communication path which is set in the switching section 20 (step S108), and proceeds to the aforementioned step S116. On the other hand, if it is determined at step S107 that no currently permitted recipient is designated, the HGW 1 ends the flow.

Next, the detailed operation of the aforementioned step S104 will be described. FIG. 5 shows the subroutine shown as step S104 in FIG. 4. Referring to FIG. 5, the HGW 1 refers to the service information to determine whether the aforementioned service registration results in a change of state or not (step S201). If the service registration does not result in a change of state, the HGW 1 ends the flow. On the other hand, if the state changes in response to the service registration from “available” to “unavailable”, or from “unavailable” to “available”, the HGW 1 then determines whether the change of state is from “unavailable” to “available” or not (step S202). If it is determined that the service registration causes the state to change from “unavailable” to “available”, the HGW 1 updates the service state indicated in the service information to “available” (step S203). Thereafter, with respect to the service, the HGW 1 determines whether the permission condition stipulated in the detailed service permission policies is “authentication free” or not (step S204), and whether a permitted recipient is designated or not (step S205). If the permission condition is “authentication free” and a permitted recipient is designated, the HGW 1 sets the aforementioned designated permitted recipient as the currently permitted recipient in the service information (step S206). Thereafter, with respect to the service of interest, the HGW 1 determines whether the permitted port stipulated in the detailed service permission policies is “undesignated” or not (step S207). If the permitted port is “undesignated”, the HGW 1 acquires a vacant port number (GP) (step S208) and then proceeds to step S211. If the permitted port is “designated”, the HGW 1 determines whether the designated port (GP) is available or not (step S209). If the designated GP is available, the HGW 1 acquires that GP (step S210). Thereafter, if the IA of an external terminal 3 is being designated as the permitted recipient, the HGW 1 acquires the address information of the permitted recipient (IA and IP of the external terminal 3), the internal address information (LA and LP), and the address information for external permission (GA of the HGW 1 and GP above) with respect to the service of interest; and the HGW 1 sets the IP filter function section 23 and the address conversion function section 25, thereby setting a communication path in the switching section 20(step S211), and ends the flow. If the permitted recipient is designated to be “permitted to all”, the HGW 1 acquires the internal address information (LA and LP) and the address information for external permission (GA of the HGW 1 and GP above) with respect to the service, and sets the IP filter function section 23 and the address conversion function section 25, thereby setting a communication path in the switching section 20. Thus, a communication path is set in the switching section 20 in the case where the service state is altered from “unavailable” to “available”. On the other hand, if it is determined at step S209 that the designated GP is unavailable, the HGW 1 refers to the service information and sets the service state to “unavailable” (step S212), and ends the flow.

On the other hand, if it is determined at step S202 that the service registration causes the state to change from available to unavailable, the HGW 1 refers to the service information and sets the state of the service of interest to “unavailable” (step S213). Thereafter, with respect to the service of interest, the HGW 1 deletes the communication path which is set in the switching section 20 (step S214) and the currently permitted recipient indicated in the service information (step S215), and ends the flow. Thus, in the case where the service state is altered from “available” to “unavailable”, the communication path in the switching section 20 is eliminated.

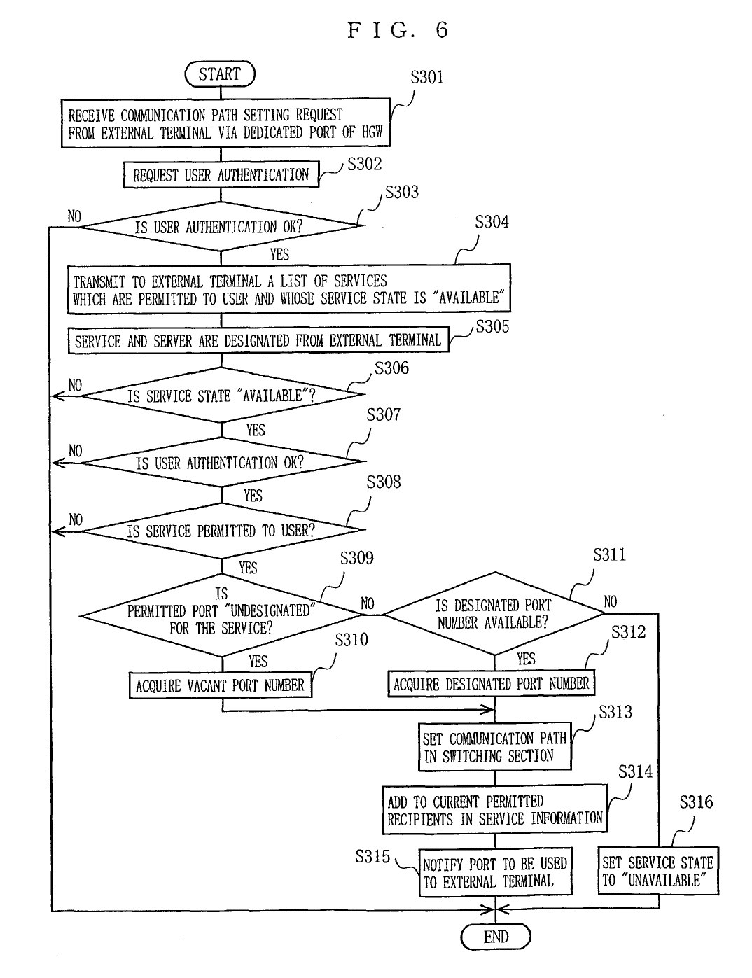

Next, an operation will be described in which a communication path in the switching section 20 is externally set for a service such that the permission condition stipulated in the detailed service permission policies is “permitted after authentication” (hereinafter such a service will be referred to as an “authentication-requiring service”). FIG. 6 is a flowchart illustrating the operation in which the HGW 1 allows a communication path to be externally set for an authentication-requiring service.

Referring to FIG. 6, the HGW 1 receives a communication path setting request from an external terminal 3, via a dedicated GP (which may typically be the port 80) of the HGW 1 (step S301). Then, the HGW 1 requests a user authentication to the external terminal 3 which has transmitted the communication path setting request (step S302). The request for a user authentication may typically be made by requesting a user name and a password to be inputted. Then, the HGW 1 receives the resultant input to the user authentication request from the external terminal 3, and determines in the authentication registration section 32 whether the resultant input matches a user registration which is previously stored in the authentication registration section 32 (step S303). If the resultant input does not match the user registration, the HGW 1 ends the flow. If the resultant input matches the user registration, the HGW 1 transmits to the external terminal 3, a list of authentication-requiring services for which the user is authorized as a permitted recipient in the detailed service permission policies and for which the state indicated in the service information is “available” (step S304). Next, the HGW 1 receives an authentication-requiring service and a server which provides the authentication-requiring service, which are selected by the user from within the list (step S305).

Thereafter, with respect to the authentication-requiring service, the HGW 1 determines whether the state indicated in the service information is available or not (step S306), reconfirms user authentication in a similar manner to step S303 (step S307), and reconfirms whether or not the user is authorized as a permitted recipient in the detailed service permission policies (step S308). This serves as a security measure in the case where the user makes no selection within the aforementioned list, for example. The user password confirmation at step S307 may be based on a password which is specially dedicated to the authentication-requiring service independently of that used in step S303. If any of the determinations of steps S306 to S308 produces a negative result, the HGW 1 ends the flow.

If step S308 determines that the aforementioned user is authorized as a permitted recipient, the HGW 1 determines whether or not the permitted port stipulated in the detailed service permission policies is “undesignated” with respect to the authentication-requiring service (step S309). If the permitted port is “undesignated”, the HGW 1 acquires a vacant port number (GP)(step S310), and then proceeds to step S313. On the other hand, if the permitted port is designated, the HGW 1 determines whether the designated port (GP) is available or not (step S311). If the designated GP is available, the HGW 1 acquires that GP (step S312), and thereafter acquires the internal address information (LA and LP), the address information for external permission (GA of the HGW 1 and GP above) with respect to the authentication-requiring service, and address information of the external terminal 3 (IA and IP of the external terminal 3), and sets the IP filter function section 23 and the address conversion function section 25, thereby temporarily setting a communication path in the switching section 20 (step S313). Then, the HGW 1 adds the aforementioned user name and the address information of the permitted recipient (IA and IP of the external terminal 3) as a currently permitted recipient of the service information (step S315). The address information of the external terminal 3 may be obtained by acquiring an IP address of the transmission source of the communication path setting request data, or may be newly designated by the above user.

Thus, services which are “permitted after authentication” can only be accessed by authorized users. After the user authentication, a communication path is set in the switching section 20 based on the address information of the external terminal 3 currently used by the user. Thereafter, the HGW 1 notifies to the external terminal 3 a port number to be used for the communication with the server 2 to which a communication path is set (step S314), and ends the flow. On the other hand, if it is determined at step S311 that the designated GP is unavailable, the HGW 1 refers to the service information and sets the state of the authentication-requiring service to “unavailable” (step S316), notifies to the external terminal 3 that the service of interest is unavailable, and ends the flow.

The communication path which is set to the user in the aforementioned manner is temporarily set with respect to the service of interest. The communication path setting function section 34 of the HGW 1 monitors the amount of data communication along the data communication path, and if no data communication is detected in a predetermined period, deletes the communication path. The monitoring of the data communication amount may be carried out in the switching section 20, and the result may be notified to the communication path setting function section 34. Furthermore, the HGW 1 may delete the communication path upon receiving a notification from the external terminal 3 or the server 2 used by the user that the access to the service has been completed.

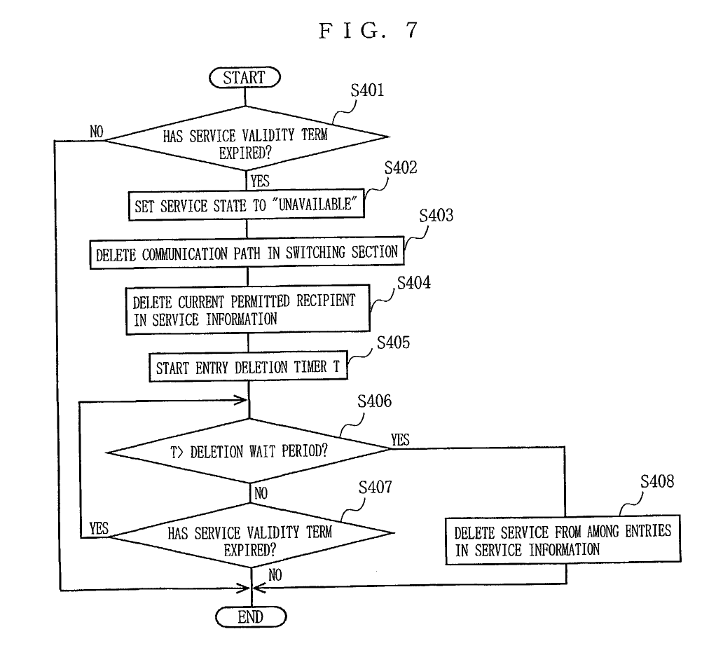

Next, the service validity term management performed by the HGW 1 will be described. FIG. 7 is a flowchart illustrating the operation of the service validity term management performed by the HGW 1. Hereinafter, the service validity term management will be described with reference to FIG. 7.

Referring to FIG. 7, the HGW 1 determines whether each service that is registered in the service information has a remaining service validity term or not (step S401). If there is any remaining service validity term, the HGW 1 ends the flow, and keeps checking service validity terms. On the other hand, if the service validity term of a service has expired, the HGW 1 sets the state in the service information to “unavailable” with respect to that service (step S402). Then, the HGW 1 deletes the communication path which is set in the switching section 2 (step S403) and the currently permitted recipient in the service information, with respect to this service (step S404). Next, with respect to this service, the HGW 1 starts an entry deletion timer T (step S405), and observes a predetermined deletion wait period (step S406). If the above-described service registration is performed during this waiting period and re-setting of a service validity term occurs with respect to the above service, the HGW 1 ends the flow (step S407). Thus, by observing a deletion wait period, it is ensured that external access using the same port number (GP) will become possible once the state becomes available again. On the other hand, if the entry deletion timer T overruns the deletion wait period, the HGW 1 deletes the above service from among the entries in the service information (step S408), and ends the flow. Thus, once the service validity term expires, the service is deleted from the service information following the aforementioned deletion wait period.

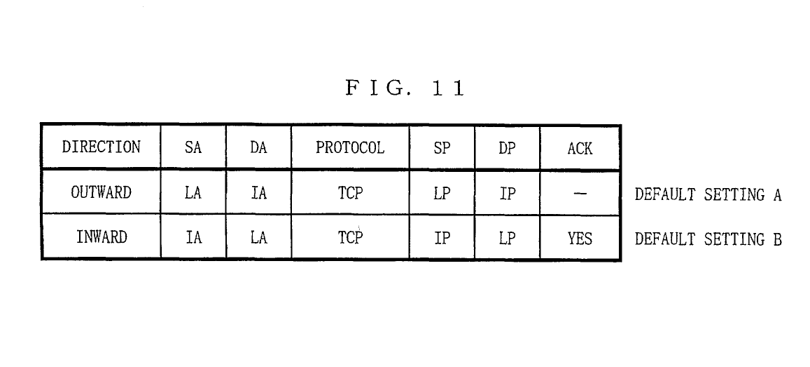

Next, the operation in which the switching section 20 is set with respect to the communication path which is set in the aforementioned manner will be described. Firstly, it is assumed in the present embodiment that the IP filter function section 23 and the address conversion function section 25 are set in such a manner that a dynamic IP masquerade is automatically applied to the communications from an internal network to an external network, so that communications are enabled without requiring the directory management function section 33 to set a communication path in the switching section 20. FIG. 11 illustrates information pertaining to a packet filter which is set in the IP filter function section 23 for permitting communications from an internal network to an external network.

In FIG. 11, any direction refers to a direction in which the PHY/MAC function section 26 transmits data. “Outward” indicates a packet which is to be received by the PHY/MAC function section 26b connected to an internal network and transmitted from the PHY/MAC function section 26a connected to an external network. “Inward” indicates a packet which is to be received by the PHY/MAC function section 26a connected to an external network, and transmitted from the PHY/MAC function section 26b connected to an internal network. “SA” (source address) and “DA” (destination address) represent a transmission source address and a receiving destination address, respectively, which are assigned to a packet. “SP” (source port) and “DP” (destination port) represent a port number of the transmission source and a port number of the receiving destination, respectively, which are assigned to a packet. “ACK” (Acknowledgement Flag) indicates whether an ACK check is to be made or not. An ACK is not set in a packet used for establishing connection, but rather is set in subsequent packets. The information which is set in the IP filter function section 23 is preset as either default setting A or B. When a packet for commencing communications is transmitted from a server 2 on an internal network to the HGW 1, the packet is permitted to pass through the packet filter according to default setting A. A response packet from an external terminal 3 on an external network to the HGW 1 is permitted to pass through the packet filter according to default setting B. On the other hand, when a packet for commencing communications is transmitted from an external terminal 3 on an external network to the HGW 1, the packet is not permitted to pass through according to default setting B, because no ACK is set in this packet. In other words, communications cannot be commenced from an external network to an internal network unless a new packet filter setting is added.

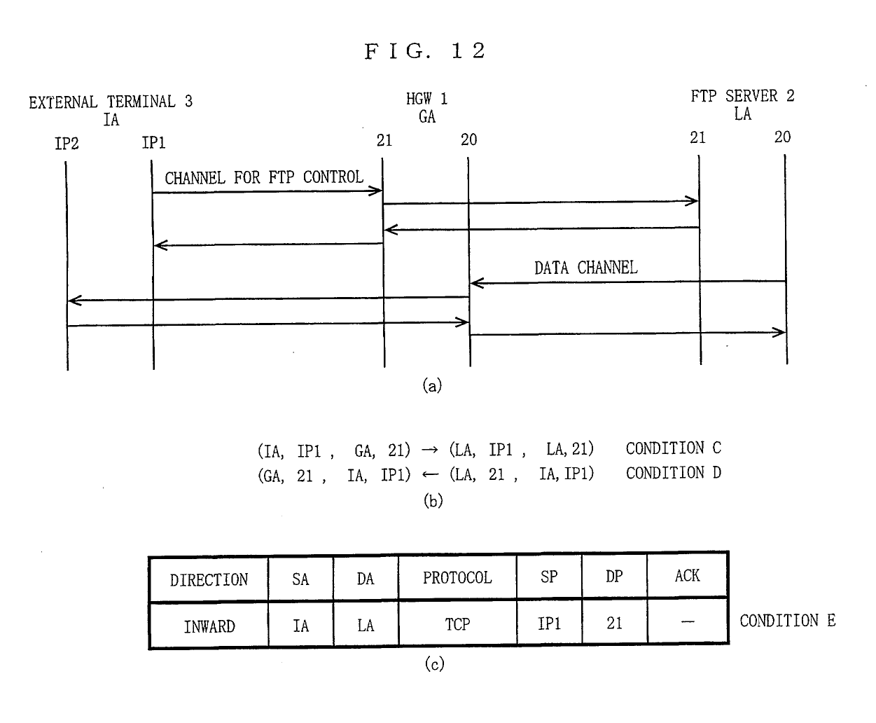

Next, the information which is set in the IP filter function section 23 and the address conversion function section 25 of the switching section 20 will be described with respect to the case where an FTP service is permitted for access from an external network. FIG. 12(a) shows a communication sequence for an FTP service. FIG. 12(b) illustrates an address conversion table which is set in the address conversion function section 25 by the directory management function section 33. FIG. 12(c) illustrates a packet filter which is set in the IP filter function section 23 by the directory management function section 33. Hereinafter, with reference to FIG. 12, the manner in which packets in a control-related session are transferred in the case where a communication path setting request for an FTP service is made will be described.

First, a packet having assigned therewith a source address IA, a source port number IP1, a destination address GA, and a destination port number 21 is transmitted from an external terminal 3. Next, the HGW 1 receives the packet, and converts the destination address GA and the destination port number 21 to an LA and an LP21 for the FTP server 2, respectively, by applying condition C in the address conversion table of the address conversion function section 25. Thereafter, the IP filter function section 23 performs a filtering process for the packet by applying condition E of the packet filter, whereby the passage of the packet is permitted. Next, the forwarding function section 24 transmits the packet to the FTP server 2 via the PHY/MAC function section 26b which is connected to an internal network.

After receiving the packet from the external terminal 3, the FTP server 2 transmits to the HGW 1 a response packet having assigned therewith a source address LA, a source port number 21, a destination address IA, and a destination port number IP1. Having received the response packet, the HGW 1 performs a filtering process for the response packet by applying default setting A of the packet filter in the IP filter function section 3, whereby the passage of the response packet is permitted. hereafter, by applying condition D in the address conversion table of the address conversion function section 25, the source address LA and the source port number 21 are converted to a GA and GP21 for the HGW 1, respectively. Next, the forwarding function section 24 transmits the response packet to the external terminal 3 via the PHY/MAC function section 26a which is connected to an external network.

In the case of the above FTP service, not only the aforementioned control-related session but also a data-related session is established between the external terminal 3 and the FTP server 2 by using-a port number 20. Since the data-related session is established by commencing communications from the FTP server 2, communications from an internal network are enabled based on dynamic IP masquerade and the default filtering setting, without requiring a special setting by means of the directory management function section 33.

In the manner of transfer according to the aforementioned FTP service, the IP filter function section 23 and the address conversion function section 25 are set in such a manner that dynamic IP masquerade is automatically applied to the communications from the internal network to the external network, so that communications from the internal network are enabled without requiring the directory management function section 33 to set the switching section 20. However, in order to provide an even higher level of security for the HGW 1, the setting of the dynamic IP masquerade or the default packet filter can be omitted. In that case, in order for an external terminal 3 on an external network to access the FTP server 2, a number of settings must be made for the address conversion suitable for an LP of the FTP server 2 and the packet filter. By providing a template (which supports LP) for a number of settings depending on the service type, the settings for the IP filter function section 23 and the address conversion function section 25 can be easily made. In the case where no such template for setting purposes is provided for the service type of a service which has been registered, a template for setting purposes may be acquired from the server 2 or a predetermined server on the external network to enable setting of the IP filter function section 23 and the address conversion function section 25.

Although the present embodiment illustrates the internal network as one network, a plurality of internal networks may be connected to the HGW 1. This can be achieved by adding a third PHY/MAC function section 26 in the switching section 20, and connecting to the third PHY/MAC function section 26 a second internal network (DMZ: DeMilitarized Zone) embracing servers which may be permitted for access from an external network. Thus, the present invention can provide an enhanced level of security in such cases.

Although the present embodiment illustrates the case where validity term timeout information or registration information from a server is utilized for the transition of the service state from “available” to “unavailable” or from “unavailable” to “available”, or for the registration or deletion of service information, the present invention is not limited thereto. Alternatively, the HGW 1 may perform a port scan for the server and, on the basis of changes in the open ports on the server, carry out the transition of the service state or the registration or deletion of service information. Similarly, PING (packet internet groper) may be employed instead of a port scan.

Although the present embodiment illustrates an example where access to the server 2 on the internet work is made from an external network, such access may be made from another device on the internal network. This can be realized by adding detailed service permission policies for a device on the internal network as a currently permitted recipient, or providing another table for permitted recipients. Thus, the security level can be varied depending on whether access is made from an internal location or from an external location, thereby introducing increased convenience.

When generating detailed service permission policies for a given server, an external agent, e.g., the manufacturer of the server may be accessed, and initial values of the detailed service permission policies may be acquired therefrom. As a result, the manufacture is able to alter the detailed service permission policies stored in that server even after shipment of the server.

As described above, according to the present fire wall apparatus, limited users are permitted to be entitled to externally accessing. After user authentication is confirmed, the address information (IA, IP) of an external terminal used by the user is acquired, and a communication path is set based on the address information. As a result, a service on an internal network can be permitted for access by limited users who are entitled to accessing externally, and a communication path can be set only during a period for which the user requests permission of the service. Access can be similarly made even if the external terminal used by the user is changed, or the IA of the external terminal used by the user is changed. When the user requests for a communication path to be set, the user can selectively access services which are accessible, and even if the same service is provided by a plurality of servers on an internal network, the user can selectively access a relevant server. On the other hand, users who are entitled to accessing a server on an internal network can be designated for each service provided by the server. Therefore, by designating a different user(s) to be entitled to accessing each of a plurality of servers on an internal network which provide the same service, the security level for each server can be easily adjusted. Furthermore, in the case where the address information (LA, LP) of a server on an internal network is altered, the present fire wall apparatus can still associate the server with the altered address information by recognizing a fixed value which identifies the server. Therefore, the alteration of tables used for address conversion can be automatically processed with ease. Moreover, the present fire wall apparatus provides a validity term for any service which can be provided to an external network, and temporarily sets a communication path only while the service is valid, and the communication path is dedicated to that service. Thus, a more enhanced level of security can be realized.

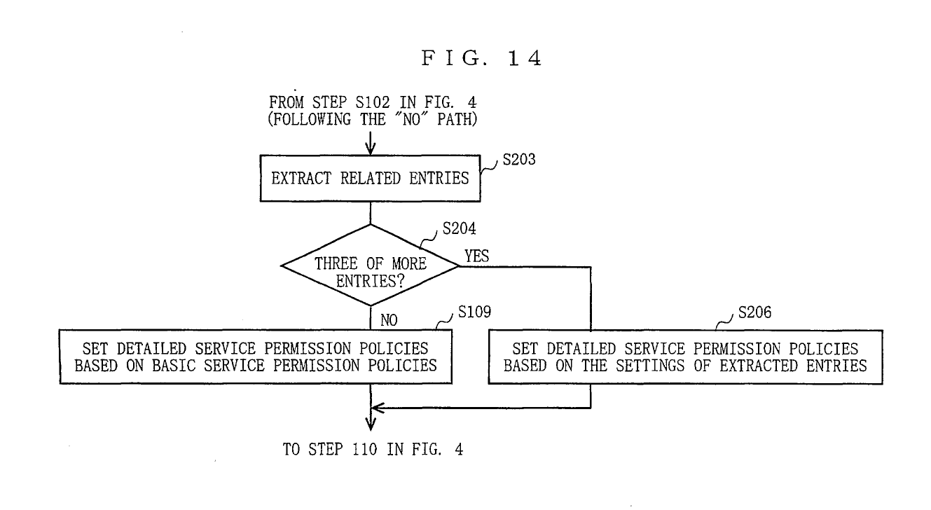

In the present embodiment, when a pair consisting of the service type and the server identification information of a service to be registered has not been registered in the directory management function section 33, detailed service permission policies are set based on basic service permission policies, as shown in step S109 of FIG. 4. Alternatively, the detailed service permission policies may be determined by other methods. For example, among the entries which are already registered in the detailed service permission policies, the number of those which are of the same service type as that of the service to be newly registered may be counted, and detailed service permission policies may be set based on the already registered entries if that number is equal to or greater than a certain threshold value; or, if the number is smaller than the threshold value, detailed service permission policies may be set based on the basic service permission policies. In other words, the process shown in FIG. 14 maybe executed in stead of step S109 shown in FIG. 4. Hereinafter, this will be described more specifically with reference to FIG. 14 to FIG. 16.

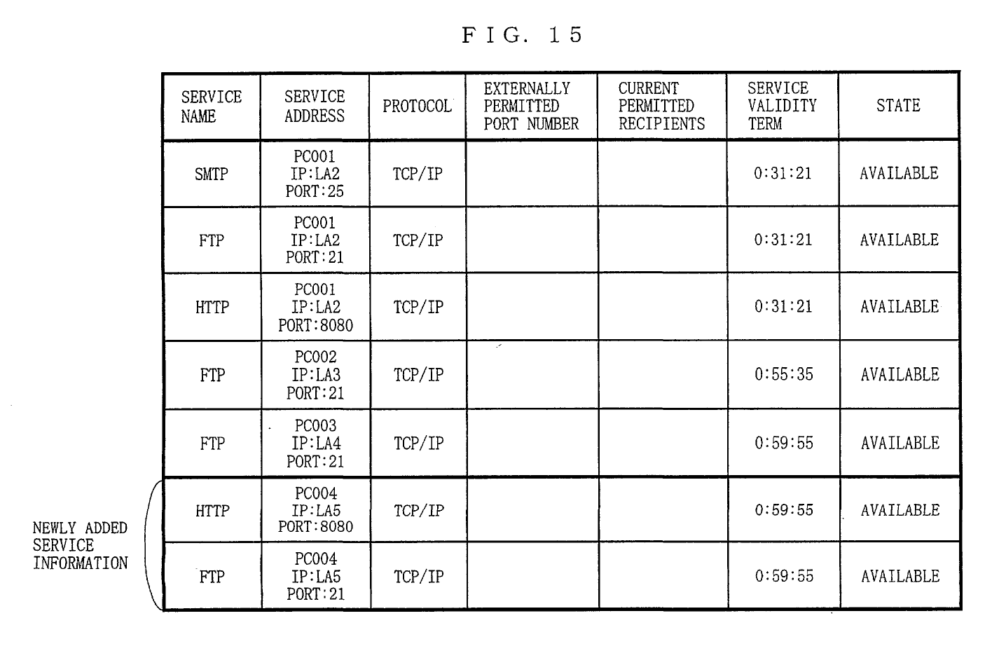

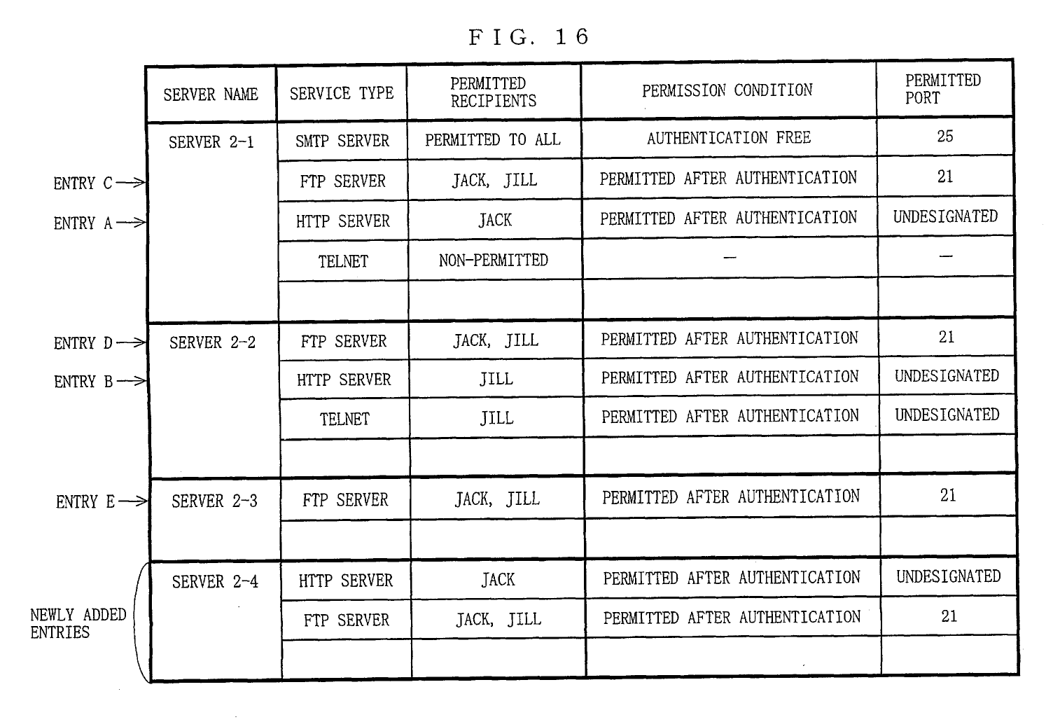

Assume, for example, that a server 2-4 whose IP is LA5 is newly introduced to the internal network. In other words, the case in which service information as shown in FIG. 15 is newly registered in the directory management function section 33. Upon determining at step S102 in FIG. 4 that a service being provided by the server 2-4 is unregistered, the directory management function section 33 at step S203 in FIG. 14 extracts entries concerning the service to be newly registered, from among the detailed service permission policies which are already managed in the directory management function section 33. Next, at step S204, the directory management function section 33 determines whether the number of extracted entries is equal to or greater than three, and if it is smaller than three, sets detailed service permission policies through a process similar to step S109 in FIG. 4. On the other hand, if it is determined at step S204 that the number of entries is equal to or greater than three, detailed service permission policies are set at step S206 based on the content of the settings of the extracted entries. This process will be described more specifically with reference to FIG. 16. With respect to the service of the type “HTTP server” on the newly-added server 2-4, two entries (i.e., entries A and B in FIG. 16) are found to match this service type. Therefore, the permitted recipient, the permission condition, and the permitted port for the service of the type “HTTP server” on this server 2-4 are determined based on the basic service permission policies shown in FIG. 9. On the other hand, with respect to the service of the type “FTP server” on the server 2-4, three entries (i.e., entries C to E in FIG. 16) are found to match this service type. Therefore, the permitted recipient, the permission condition, and the permitted port for the service of the type “FTP server” on this server 2-4 are determined based on the content of the settings of entries C to E. In this case, those settings which are common to entries C to E will be reflected on the settings of the service of the type “FTP server” on the server 2-4.

As for the specific methods for setting detailed service permission policies based on the content of the settings of the extracted entries, various methods are possible. For example, although the above description illustrates that the detailed service permission policies are generated in such a manner that the content of the settings of the new service is determined based on a logical AND of the contents of the settings of the already registered entries, the present invention is not limited thereto. For example, the content of the settings of the new service may be determined based on a logical OR or on a majority among the contents of the settings of the already registered entries. These or various other setting methods will also become apparent from the following descriptions of other embodiments of the present invention.

### SECOND EMBODIMENT

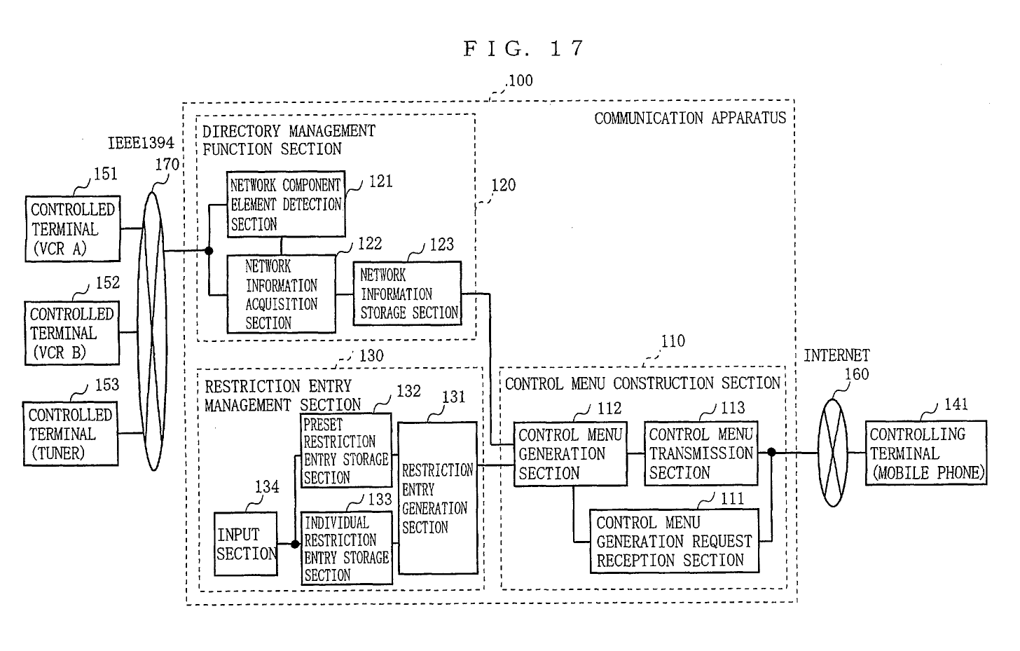

FIG. 17 illustrates the structure of a communication apparatus 100 according to a second embodiment of the present invention. The communication apparatus 100 comprises a control menu construction section 110, a directory management function section 120, and a restriction entry management section 130. The control menu construction section 110 includes a control menu generation request reception section 111, a control menu generation section 112, and a control menu transmission section 113. The directory management function section 120 includes a network component element detection section 121, a network information acquisition section 122, and a network information storage section 123. The restriction entry management section 130 includes a restriction entry generation section 131, a preset restriction entry storage section 132, an individual restriction entry storage section 133, and an input section 134.

The communication apparatus 100 has the function of, when a user wishes to control a “controlled” terminal from a “controlling” terminal via a network, either permitting such control, partially restricting such control, or prohibiting such control, based on predetermined restriction entries. For example, a VCR (video cassette recorder) connected to a network (IEEE1394 bus) which is installed in the home of a person named “Jack” may be controlled as a “controlled” terminal via the network in the following manner. That is, the communication apparatus 100 may allow Jack to control the VCR from either a “controlling” terminal which is connected to the in-home network or from a mobile phone as a “controlling” terminal connected to the Internet, while allowing a daughter of Jack named “Jill” to control the VCR only from a “controlling” terminal which is connected to the in-home network, but not from a mobile phone. Thus, the control over the “controlled” terminal is restricted under certain conditions.

FIG. 17 shows an exemplary configuration in which “controlled” terminals 151 to 153 (e.g., VCR's or tuners) which are connected to an IEEE1394 bus 170 (as an in-home network) are controlled from a “controlling” terminal 141 (e.g., a mobile phone) which is connected to the Internet 160 (as an out-of-home network), where the controlled terminals 151 to 153 are equipped with AV/C commands.

Hereinafter, the operation of the communication apparatus 100 will be described.

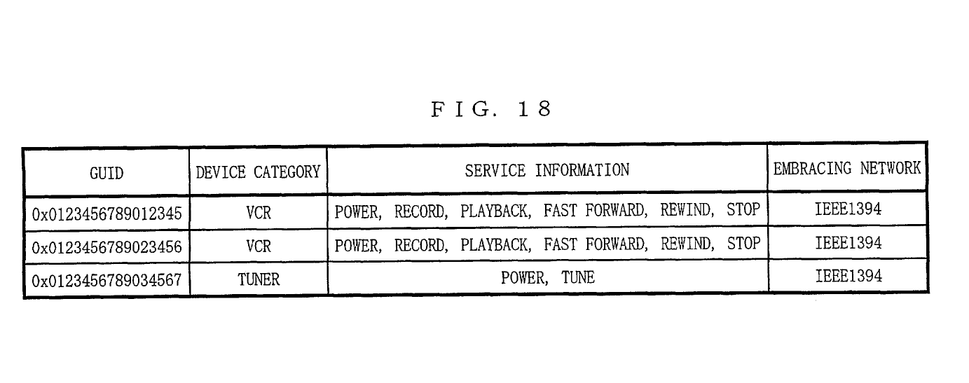

The directory management function section 120 manages as element information the information concerning the devices which are connected to the network. FIG. 18 shows an example of element information which is managed by the network information storage section 123. In FIG. 18, “GUID” is a 64-bit identifier which is uniquely assigned to each device; “device category” indicates a device type; “service information” indicates the service(s) which the device can provide to the network; and “embracing network” indicates the network to which the device belongs. Thus, the element information shown in FIG. 18 indicates that two VCR's which can be controlled over the network with respect to “power” “record”, “playback”, “fast forward”, “rewind”, and “stop”, as well as a tuner which can be controlled over the network with respect to “power” and “tune”, are connected as devices the IEEE1394 bus.

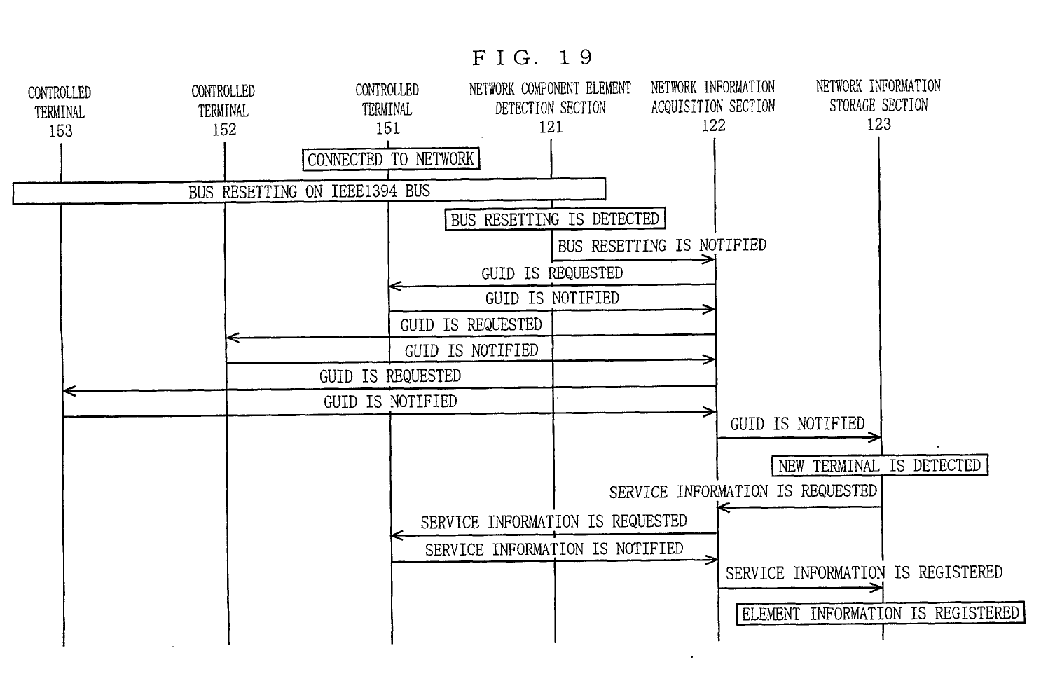

The directory management function section 120 has the function of detecting any new device that is connected to the network to which the communication apparatus 100 is connected, and updating the element information. Hereinafter, this function will be described with respect to a specific example. FIG. 19 illustrates an operation sequence in the case, where devices 152 and 153 are already connected to the IEEE1394 bus 170, a device 151 is newly connected to the IEEE1394 bus 170. Note that, in the following description and also in the subsequent embodiments, the controlled terminal 151 or the like in FIG. 17 will merely be referred to as a “device” 151, etc. The reason behind this is that a device which is connected to a network does not need to be predesignated to be a “controlling” or “controlled” terminal. If the device is a PC (Personal Computer) or the like, the device may be utilized as a controlling terminal or as a controlled terminal depending on the situation. Thus, references to a “device 151” or the like will be made where the device is not yet determined to be an agent or an object of control.

A bus resetting occurs when a new device (i.e., the device 151 in this example) is connected to the IEEE1394 bus 170. The bus resetting is detected by the network component element detection section 121, which notifies the occurrence of bus resetting to the network information acquisition section 122. Upon receiving this notification, the network information acquisition section 122 acquires the GUID's of the devices which are connected to the IEEE1394 bus 170. The network information acquisition section 122 notifies the acquired GUID to the network information storage section 123.

Referring to the element information which is already stored, the network information storage section 123 compares the GUID notified from the network information acquisition section 122 against the GUID(S) of the device(s) which was connected prior to the occurrence of bus resetting. As a result, it is confirmed that the GUID of the device 151 has been added. Accordingly, in order to update the element information, the network information storage section 123 requests the network information acquisition section 122 to acquire the service information provided from the newly-connected device 151 and the device category thereof. Using an AV/C command, the network information acquisition section 122 acquires the service information provided from the device 151 and information indicating the device category thereof.

The network information acquisition section 122 notifies the acquired service information provided from the VCR (A) 151 and the information indicating the device category thereof to the network information storage section 123. The network information storage section 123 updates the element information by registering the notified information in the element information.

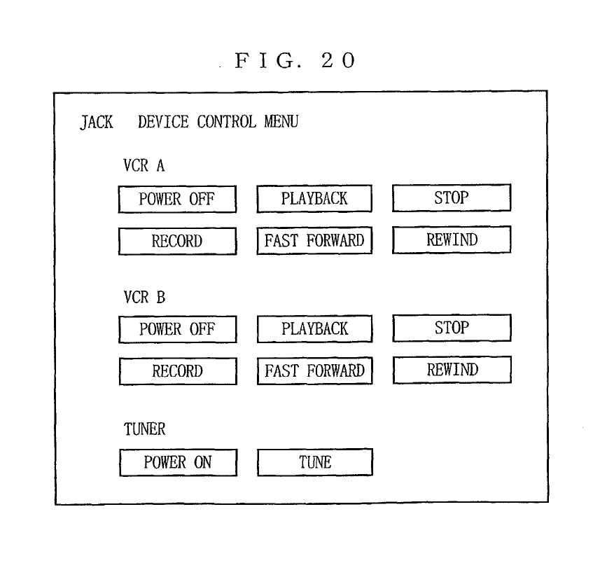

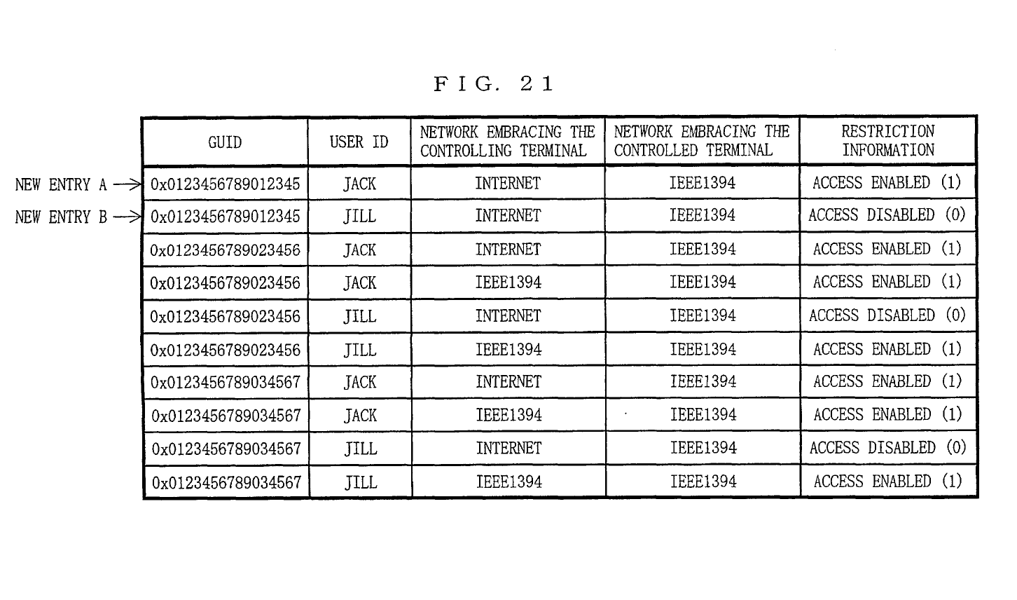

In order to control a “controlled” terminal from a “controlling” terminal, a user first makes a request to the communication apparatus 100 for a control menu for controlling the controlled terminal. In response to the request from the controlling terminal, the control menu construction section 110 constructs a control menu and sends it to the controlling terminal. FIG. 20 shows an exemplary displayed image of a control menu which is sent to the controlling terminal. Based on this control menu, the user can control the controlled terminal (e.g., begin recording on the VCR (A) 151) from the controlling terminal. In the restriction entry management section 130, predetermined restriction entries which stipulate whether to permit or prohibit controlling of controlled terminals under various conditions are registered. FIG. 21 shows examples of restriction entries which are managed in the restriction entry management section 130. In the examples shown in FIG. 21, restriction information which indicates whether to permit or prohibit controlling of controlled terminal is designated for each set of control conditions, which is defined by a combination of: a controlled terminal; a user who wishes control ability; a network to which the controlling terminal belongs; and a network which embraces the controlled terminal. In the case of FIG. 21, for any controlled terminal having a GUID “0×0123456789012345” which is connected to “IEEE1394”, control is permitted to “Jack”, who wishes to exert control from a controlling terminal connected to the “Internet”, because “access enabled (1) ” is set as the restriction information. On the other hand, for any controlled terminal having a GUID “0×0123456789012345” which is connected to “IEEE1394”, control is not permitted to “Jill”, who wishes to exert control from a controlling terminal connected to the “Internet”, because “access disabled (0)” is set as the restriction information. To each controlling terminal, a control menu is sent which is generated based on the corresponding restriction entry managed in the restriction entry management section 130 and which only contains items that are permitted for control from the controlling terminal. Thus, control of the controlled terminal from a controlling terminal is restricted based on the corresponding restriction entry which is managed in the restriction entry management section 130.

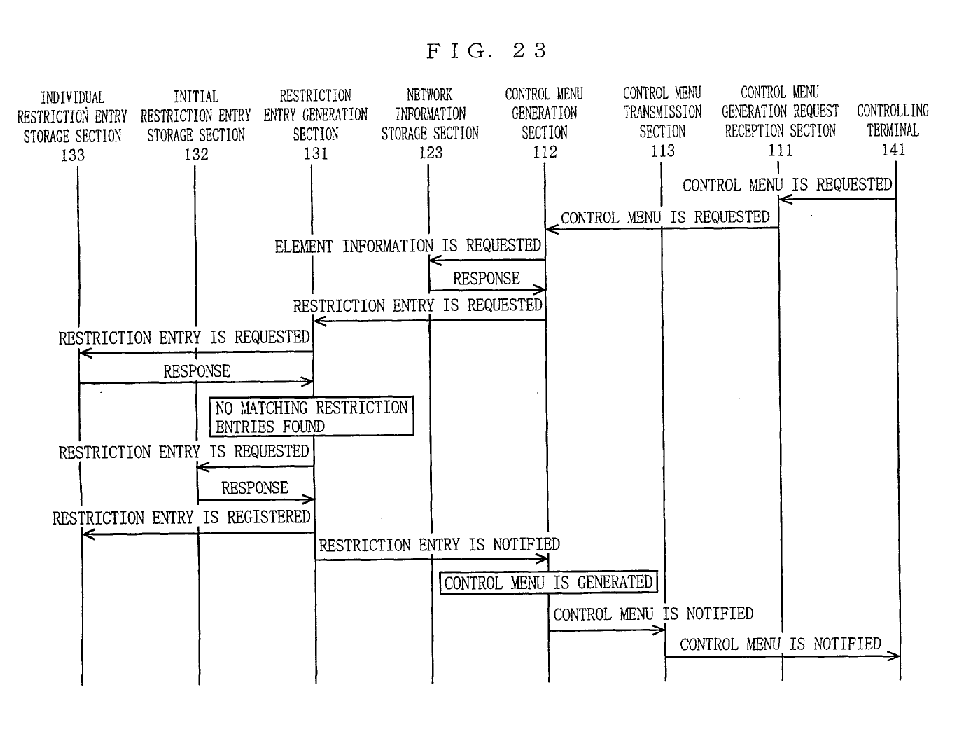

Hereinafter, an exemplary process in which a user acquires a control menu from a controlling terminal will be specifically described. FIG. 23 illustrates an operation sequence in the case where a control menu is acquired at the controlling terminal 141. The following description is directed to the case where a control menu is requested for the first time after the device 151 is newly connected to the IEEE1394 bus 170. In order to obtain a control menu, a user manipulates the controlling terminal 141 to issue a control menu request to the communication apparatus 100. Upon receiving the request, the control menu generation request reception section 111 identifies a user ID of the user who has issued the control menu request and the network to which the controlling terminal 141 is connected. The acquisition of the information for user identification only needs to be made in time for the issuance of a control menu request by the controlling terminal 141. However, from the perspective of security, it would be desirable that, after the connection between the controlling terminal 141 and the communication apparatus 100 is established, a user ID and a password are sent from the controlling terminal 141 for user authentication.

To the control menu generation section 112, the control menu generation request reception section 111 sends the user ID and the network information concerning the controlling terminal, and requests a control menu to be generated. Upon receiving the request, the control menu generation section 112 first requests element information (i.e., information concerning devices which are currently connected to the IEEE1394 bus 170) to the network information storage section 123. The element information which is requested at this point comprises a device GUID, a device category, service information, and the type of the network. Based on the element information which is managed in the aforementioned manner, the network information storage section 123 notifies the element information to the control menu generation section 112.

Next, the control menu generation section 112 notifies the user ID and the network information concerning the controlling terminal received from the control menu generation request reception section 111 and the element information received from the network information storage section 123 to the restriction entry generation section 131, and requests a restriction entry corresponding to such information.

Upon receiving the restriction entry request from the control menu generation section 112, the restriction entry generation section 131 transmits the “GUID”, “user ID”, “network embracing the controlled terminal”, “network embracing the controlling terminal”, which have been notified from the control menu generation section 112, to the individual restriction entry storage section 133. The individual restriction entry storage section 133, where the aforementioned restriction entries shown in FIG. 21 are previously registered, searches for restriction information that matches the information transmitted from the restriction entry generation section 131, and notifies the matching information to the restriction entry generation section 131. For example, if the element information contains information concerning a device whose GUID is “0×0123456789012345”, then the restriction information corresponding to a combination consisting of “IEEE1394” (i.e., the network to which this device is currently connected), “Jack” (i.e., the ID of the user who wishes to control this device), and “Internet” (i.e., the network to which the controlling terminal is connected) is searched for. The result of the search in this example indicates that “access enabled (1)” is set as the restriction information. Similar searches are made with respect to devices having any other GUID's that are contained in the element information. The individual restriction entry storage section 133 notifies the restriction information thus obtained to the restriction entry generation section 131.

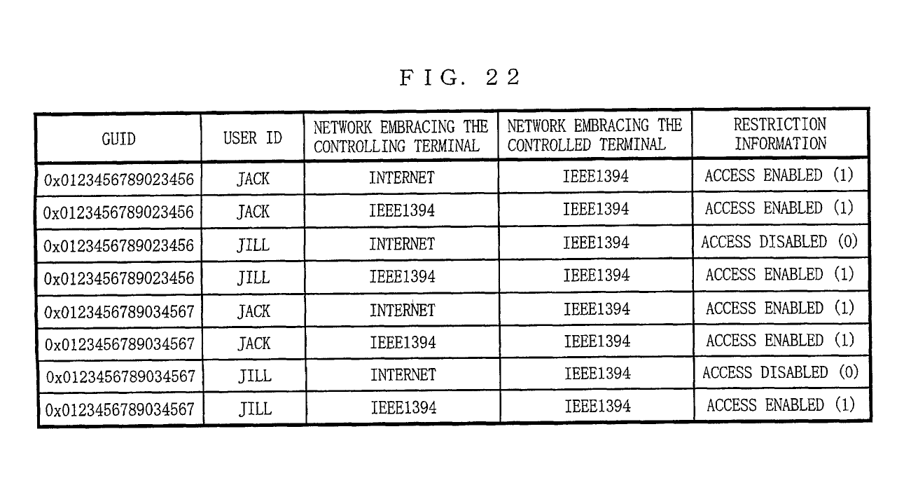

Note that the individual restriction entries shown in FIG. 21 include individual restriction entries for the newly-connected device 151 (shown as new entries A, B in FIG. 21) having already been registered through the below-described process and the like. On the other hand, the presently-described operation sequence is based on the assumption that such new entries A and B are yet to be registered. Therefore, the individual restriction entries which exist at this point would appear as shown in FIG. 22.

On the other hand, the search result by the individual restriction entry storage section 133 may indicate that no restriction entries which match the particular set of conditions are registered. Such a situation may occur when a new device is connected to the network as a controlled terminal, or in some cases, when a device is connected to a different network, for example. A similar situation may also occur in the case where Jack has been registered but Jill has not been registered yet. In such situations, conventional techniques have a problem, as described earlier, in that the user needs to set restriction entries for any newly-connected device. Therefore, if a person without sufficient knowledge on network management (e.g., a member of the family) happens to connect a device to a network, unrestricted access to such items might occur from outside of the house based on improper settings.

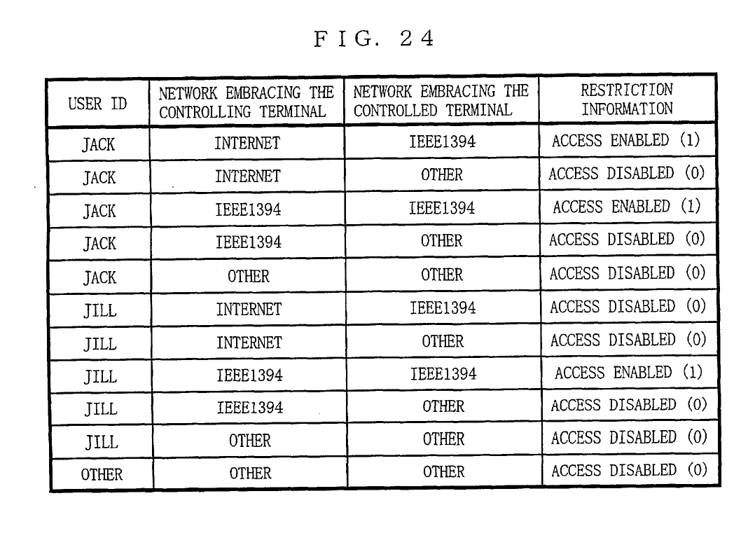

In contrast, according to the present embodiment of the invention, if the search result by the individual restriction entry storage section 133 indicates that no restriction entries which match a particular set of conditions are registered yet, then restriction information which matches the set of conditions is acquired based on the preset restriction entries which are previously set in the preset restriction entry storage section 132. As a result, restriction information which designates preferable restrictions is automatically set, without requiring the user to perform a setting operation. More specifically, for a set of conditions which does not have any corresponding restriction entries registered, the restriction entry generation section 131 transmits the “user ID”, “network embracing the controlling terminal”, and the “network embracing the controlled terminal” to the preset restriction entry storage section 132. Then, the preset restriction entry storage section 132 searches for restriction information which matches these conditions among the preset restriction entries, and notifies such restriction information to the restriction entry generation section 131. FIG. 24 shows exemplary preset restriction entries which may be registered in the preset restriction entry storage section 132. In FIG. 24, if a new device is connected to “IEEE1394” and thereafter “Jack” requests a control menu from a controlling terminal connected to the “Internet”, for example, a result of the search for preset restriction entries corresponding to the above conditions would indicate that “access enabled (1)” is set as restriction information matching these conditions. Accordingly, “access enabled (1)” is notified to the restriction entry generation section 131.

Based on the restriction information notified from the preset restriction entry storage section 133, the restriction entry generation section 131 registers a new restriction entry to the individual restriction entry storage section 133. For example, if the controlled terminal 151 having the GUID “0×0123456789012345” is newly connected to the IEEE1394 bus 170 and thereafter “Jack” requests a control menu from the controlling terminal 141 which is connected to the Internet 160, “access enabled (1)” is set for the preset restriction entry which matches these conditions (that is, except for the GUID). Accordingly, in the individual restriction entry storage section 133, a new restriction entry (i.e., new entry A shown in FIG. 21) is registered which associates the restriction information “access enabled (1)” with the following control conditions: “0×0123456789012345” (GUID), “Jack” (user ID), “Internet” (network embracing the controlling terminal), and “IEEE1394” (network embracing the controlled terminal).

Through the above process, the restriction entry generation section 131 acquires restriction information, and notifies the restriction entries to the control menu generation section 112. Based on the “network embracing the controlled terminal” information, service information, and device category notified from the network information storage section 123 and on the restriction entry notified from the restriction entry generation section 131, the control menu generation section 112 generates a control menu. The control menu may be in the form of an application which is executable by the controlling terminal 141, but is preferably a source which is described in HTML. In the case where the control menu is described in HTML, the controlling terminal 141 needs to be equipped with an HTML browser to be able to control the device. Furthermore, it is preferable that the items displayed in the control menu are associated with control commands based on CGI or the like.

The control menu generation section 112 transmits the generated control menu to the control menu transmission section 113. In turn, the control menu transmission section 113 transmits the received control menu to the controlling terminal (i.e., the controlling terminal 141 in this example). The controlling terminal 141 displays the control menu on a browser, and the user is allowed to manipulate the controlled terminals 151 to 153 based on the control menu.

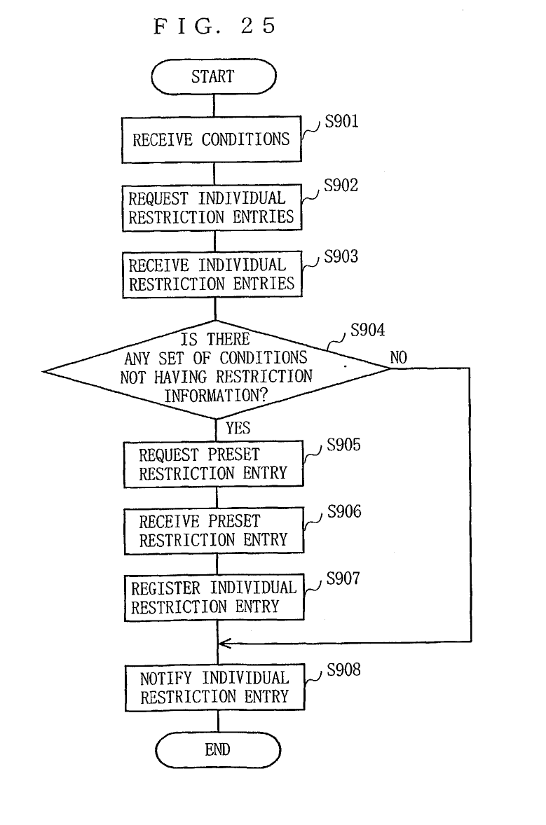

Now, with reference to the flowchart of FIG. 25, the operation of the restriction entry generation section 131 will be described. For clarity, the following description will be directed to a specific exemplary case where the element information shown in FIG. 18 is stored in the network information storage section 123, and the preset restriction entries shown in FIG. 24 are stored in the preset restriction entry storage section 132, further assuming that the restriction entries concerning the controlled terminal 151 whose GUID is “0×0123456789012345” (i.e., new entries A, B in FIG. 21) among the individual restriction entries shown in FIG. 21 have not been registered (that is, only the restriction entries shown in FIG. 22 are registered).

At step S901, the restriction entry generation section 131 receives from the control menu generation section 112 the conditions based on which to generate restriction information, i.e., the “GUID”, “user ID”, “network embracing the controlling terminal” information, and “network embracing the controlled terminal” information. Specifically, the following entries are received at this step:

GUID=0×0123456789012345

user ID=Jack

“network embracing the controlled terminal” information=IEEE1394 (hereinafter simply referred to as “in-home”)

“network embracing the controlling terminal” information=Internet (hereinafter simply referred to as “out-of-home”)

GUID=0×0123456789123456

user ID=Jack

“network embracing the controlled terminal” information=in-home

“network embracing the controlling terminal” information=out-of-home

GUID=0×0123456789234567

user ID=Jack

“network embracing the controlled terminal” information=in-home

“network embracing the controlling terminal” information=out-of-home

At step S902, based on the above conditions, a request for sending individual restriction entries is made to the individual restriction entry storage section 133. At step S903, the restriction information corresponding to the above conditions are received. Specifically, the following entries are received at this step:

GUID=0×0123456789012345

user ID=Jack,

“network embracing the controlled terminal” information=in-home

“network embracing the controlling terminal” information=out-of-home

restriction information=

GUID=0×0123456789123456

user ID=Jack

“network embracing the controlled terminal” information=in-home

“network embracing the controlling terminal” information=out-of-home

restriction information=access enabled

GUID=0×0123456789234567

user ID=Jack,

“network embracing the controlled terminal” information=in-home

“network embracing the controlling terminal” information=out-of-home

restriction information=access enabled

At step S904, it is confirmed whether or not any set of conditions exists which does not have corresponding restriction information. If there is such a set of conditions, the control proceeds to step S905; otherwise, the control proceeds to step S908. In this example, the set of conditions beginning with GUID =0×0123456789012345 is a set of conditions which does not have corresponding restriction information.

At step S905, with respect to the set of conditions which does not have corresponding restriction information, a request for notifying restriction entries corresponding to this set of conditions (that is, except for the GUID and the restriction information) is made to the preset restriction entry storage section 132. At step S906, restriction information matching such conditions is received. Specifically, the following entry is received at this step:

user ID=Jack,

“network embracing the controlled terminal” information=in-home

“network embracing the controlling terminal” information=out-of-home

restriction information=access enabled

At step S907, the restriction entry received at step S906 is registered in the individual restriction entry storage section 133. As a result, an individual restriction entry (indicated as new entry A in FIG. 21) is newly registered. At step S908, an entry which associates the control conditions with restriction information is notified to the control menu generation section 112.

Thereafter, the control menu generated by the control menu generation section 112 is transmitted to the controlling terminal 141 via the control menu transmission section 113. The control menu generation section 112 generates a control menu by selecting, from the service information shown in FIG. 18, only those items for which access is permitted based on the individual restriction entries shown in FIG. 21. Thus, as shown in FIG. 20, a control menu including the VCR (A) 151, the VCR (B) 152, and the tuner 153 is displayed on the controlling terminal 141 which is manipulated by the user “Jack”.

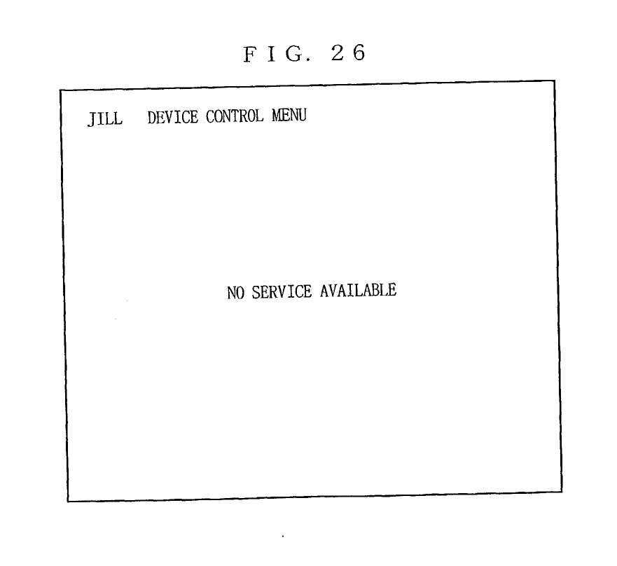

On the other hand, if the user who has requested a control menu is Jill, new entry B shown in FIG. 21 is newly registered through similar processes to those described above, and the control menu generation section 112 generates a control menu by selecting, from the service information shown in FIG. 18, only those items for which access is permitted based on the individual restriction entries shown in FIG. 21. However, since the user “Jill” is denied access via the Internet 160 with respect to all restriction entries in this example, an image as shown in FIG. 26, in which no controllable control items are displayed, is presented on the controlling terminal 141 manipulated by the user “Jill”.

The individual restriction entries stored in the individual restriction entry storage section 133 can be set by the user by means of the input section 134. The individual restriction entries which are generated by the restriction entry generation section 131 and registered in the individual restriction entry storage section 133 can also be set by the user by means of the input section 134. The preset restriction entries stored in the preset restriction entry storage section 132 can also be set by the user by means of the input section 134.

Although a request for a control menu from the controlling terminal 141 which is connected to the Internet 160 is illustrated as an example of access from outside of the home in the present embodiment, the out-of-home network may be any network other than the Internet. Moreover, a control menu may be requested from a controlling terminal connected to an in-home network, e.g., the IEEE1394 bus 170 or any other network to control a “controlled” apparatus.

Although the present embodiment illustrates “Jack” and “Jill” as user ID's, these are merely exemplary of ID's for identifying users, and may instead be set up to the discretion of each user. Although user ID's which are directed to individuals such as “Jack” and “Jill” are illustrated as a condition concerning users, the condition may instead be classified based on an attribute of users, e.g., network administrators, family members, or guests.

Although the present embodiment illustrates the IEEE1394 bus 170 as a network to which controlled terminals are connected and the Internet 160 as a network to which controlling terminals are connected, any other network may be used instead. The networks may be wired or wireless. Examples of other networks include ECHONET, Bluetooth, etc.

Although the present embodiment illustrates an example where two networks are connected to the communication apparatus 100, any number of networks, e.g., one, or three or more, may be connected to the communication apparatus 100.

Although the services illustrated in the present embodiment are independently provided by each device, the present invention is also applicable to services which involve the use of two devices, e.g., dubbing operations between VCR's or setting of a communication path.

As conditions for restriction entries, any parameters other than those used in the present embodiment may be used instead. For example, device categories, service information, usage time, or processing abilities of devices, e.g., displaying ability/sound reproduction ability, may also be used.

Although the present embodiment illustrates VCR's (A) and (B), and a tuner as examples of “controlled” terminals, any one of these devices may act as a “controlling” terminal with which to control the other controlled devices. For example, the tuner may control the VCR (A) via the communication apparatus.

Although the present embodiment illustrates VCR's and tuners as device categories, other types of categories may also be used, such as “AV (Audio/Visual) device”, “air-conditioning device”, etc.

In the present embodiment, restriction of control is made based on the element information stored in the network information storage section 123. Alternatively, when the control menu generation section 112 requests element information, the network information acquisition section 122 may acquire element information, and notify it to the control menu generation section 112. In the case where element information is stored, there is an advantage in that the an improved response to user manipulation is provided. In the case where element information is acquired on demand, on the other hand, there is an advantage in that storage capacity for storing element information is unnecessary.

Although the present embodiment illustrates an example where restriction entries corresponding to new conditions are generated when generating a control menu, it is also possible to generate such restriction entries at an earlier time. For example, the generation of such restriction entries may occur upon detection of a new component element. In this case, there is an advantage in that the length of the time which lapses after a user requests a control menu until the control menu is received is reduced as compared to the case where such restriction entries are generated at the time of generating a control menu.

As described above, according to the second embodiment, even if no individual restriction entries are found that correspond to a given set of conditions, access restrictions can be realized based on preset restriction entries. Therefore, a user does not need to set access restrictions at each time. Thus, it is possible to start using any new service to be used without having to make access settings for each service.

Since access restrictions are set based on the type of network to which a controlling device is connected, both convenience-oriented and security-oriented restrictions can be realized by, for example, permitting access with respect to a network which are open to the indefinite public (e.g., the Internet) while prohibiting access with respect to in-home networks such as IEEE1394 buses.

### THIRD EMBODIMENT

Hereinafter, a communication apparatus according to a third embodiment of the present invention will be described with reference to the figures.

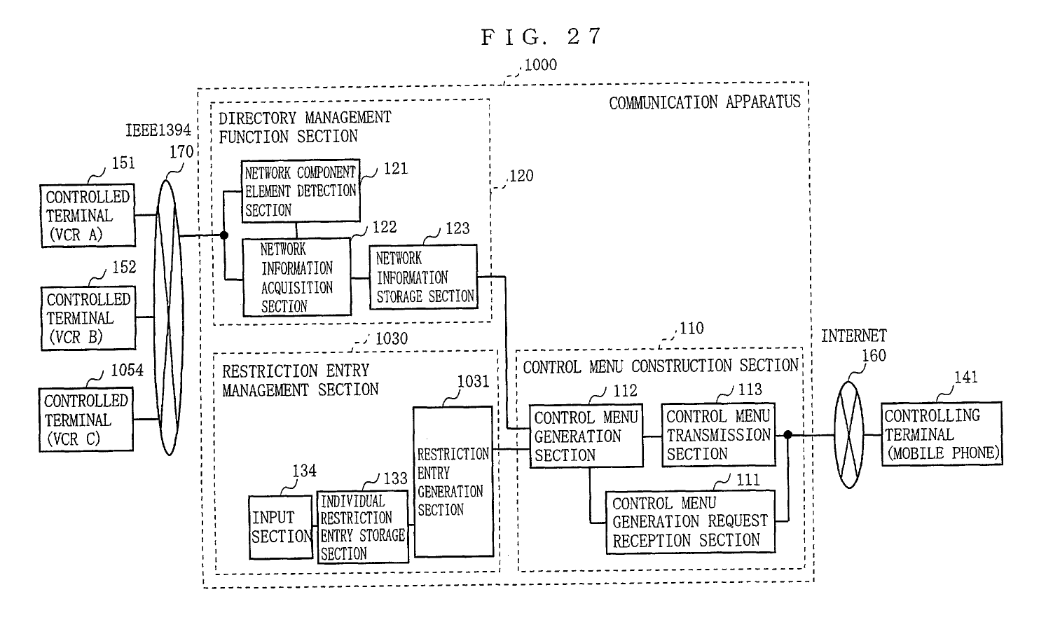

FIG. 27 illustrates the communication apparatus 1000 according to the present embodiment, networks connected thereto, and controlling terminals and controlled terminals connected to the networks. As shown in FIG. 27, the communication apparatus 1000 includes a control menu construction section 110, a directory management function section 120, and a restriction entry management section 1030. The control menu construction section 110 includes a control menu generation request reception section 111, a control menu generation section 112, and a control menu transmission section 113. The directory management function section 120 includes a network component element detection section 121, a network information acquisition section 122, and a network information storage section 123. The restriction entry management section 1030 includes a restriction entry generation section 1031, an individual restriction entry storage section 133, and an input section 134. The communication apparatus 1000 is connected to the Internet 160 and an IEEE1394 bus 170. A controlling terminal 141 (e.g., a mobile phone) is connected to the Internet 160. Controlled terminals 151, 152, and 1054 (e.g., VCR's (A), (B), and (C)), which are equipped with AV/C commands, are connected to the IEEE1394 bus 170. In FIG. 27, the constituent elements which also appear in FIG. 17 are denoted by the same reference numerals as those used therein, and the descriptions thereof are omitted.

Hereinafter, the operation of the communication apparatus 1000 will be described, especially with respect to differences from the operation of the communication apparatus 100 according to the second embodiment. The following description is directed to the case where the device 151 is newly connected, and a user (“Jack”) requests a control menu in order to control the devices 151, 152, and 1054 from the device 141, which is connected to the Internet 160.

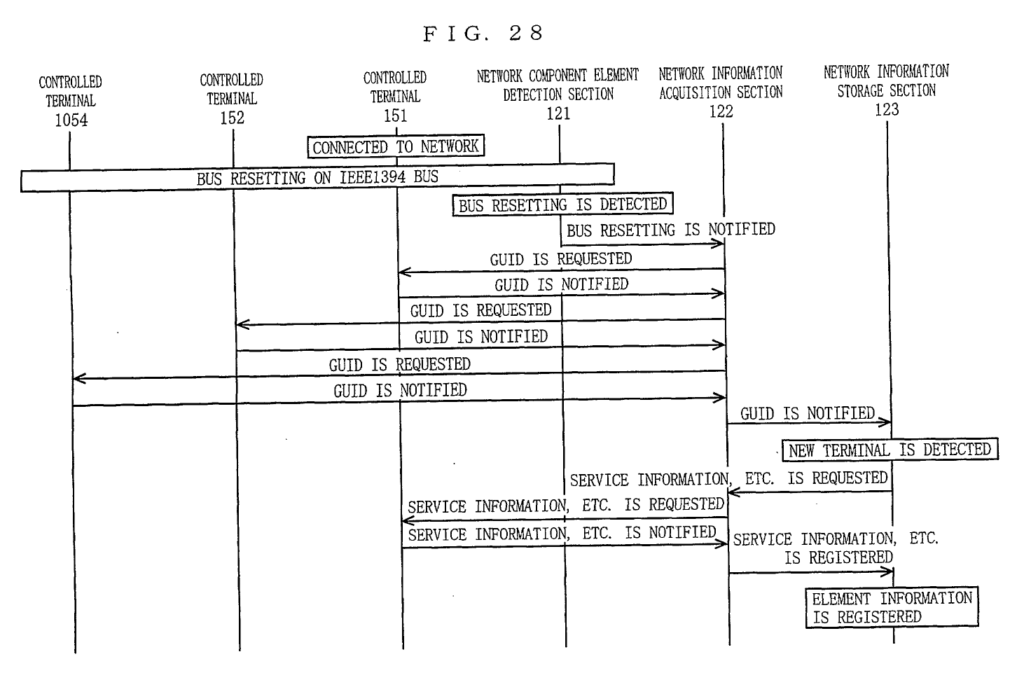

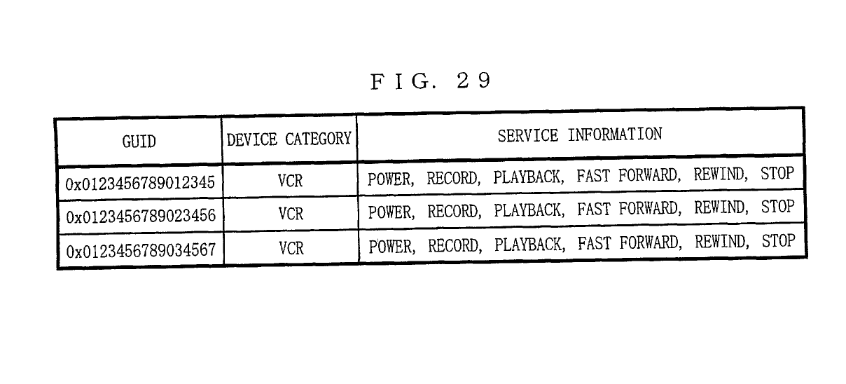

FIG. 28 illustrates an operation sequence in the case where the device 151 is connected to the IEEE1394 bus 170. As shown in FIG. 28, through an operation similar to that according to the second embodiment, element information is updated and registered in the network information storage section 123. FIG. 29 shows an example of element information stored in the network information storage section 123. Note that the element information shown in FIG. 29 does not contain the “network embracing the controlled terminal” information shown in FIG. 18. This is because information concerning the network embracing a controlled terminal is not included as a condition in the restriction entries for setting restriction information.

As in the second embodiment, the control menu construction section 110 generates a control menu in response to a request from the controlling terminal 141. At this time, a request for restriction entries is made to the restriction entry management section 1030. The restriction entry management section 1030 returns to the control menu generation section 112 any restriction entries that correspond to a set of conditions which is notified from the control menu generation section 112. However, unlike in the second embodiment, a preset restriction entry storage section is omitted in the present embodiment. Instead, in the case where no restriction entry that matches the notified set of conditions is found in the individual restriction entry storage section 133, restriction information which designates preferable restrictions (that correspond to the set of conditions which does not have any corresponding restriction entries registered) is automatically determined based on the restriction entries which are already stored in the individual restriction entry storage section 133. Hereinafter, the details of this operation will be described.

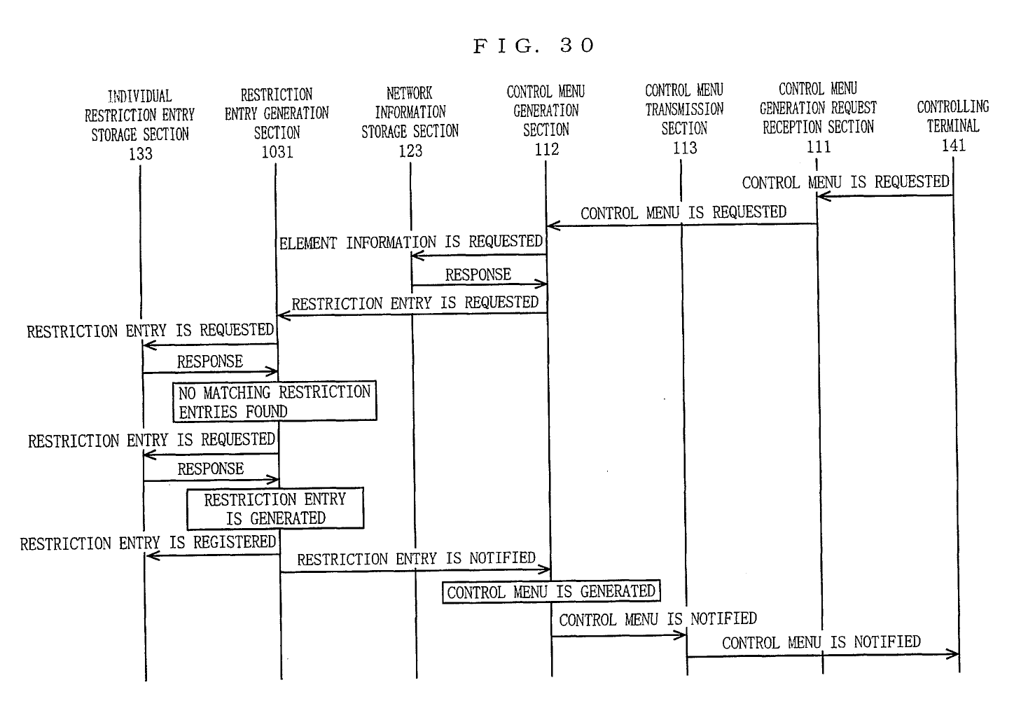

FIG. 30 illustrates an operation sequence in the case where a user which is registered with the user ID “Jack” acquires a control menu for controlling the controlled terminal 151 using the mobile phone 141 connected to the Internet. The series of processes from requesting a control menu through manipulation of the controlling terminal 141 to the issuance of a restriction entry request to the restriction entry generation section 1031 is similar to that in the second embodiment, and the descriptions thereof are omitted.

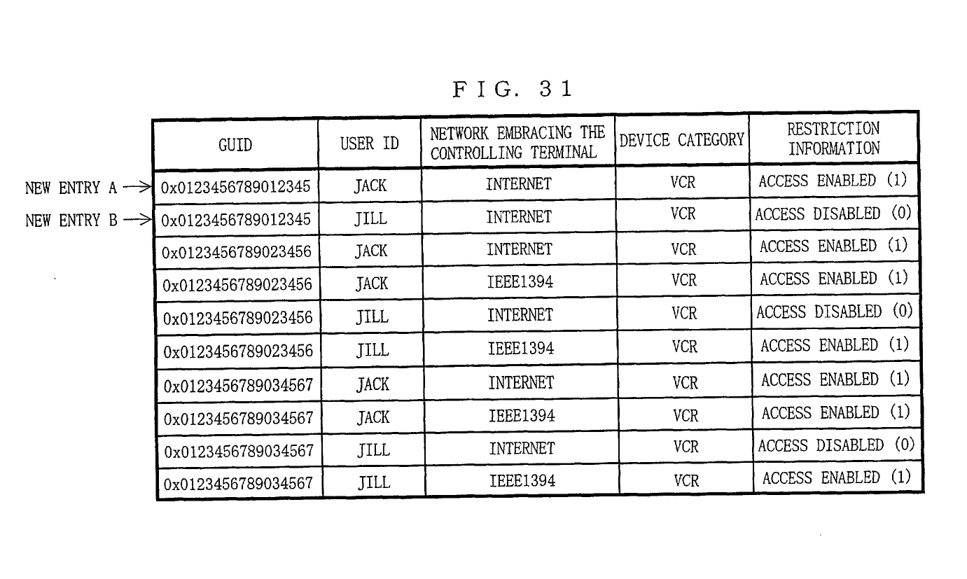

The restriction entry generation section 1031 sends the received set of conditions to the individual restriction entry storage section 133, and requests issuance of corresponding restriction entries. The individual restriction entry storage section 133 searches for restriction information that matches the received set of conditions, and notifies the result of the search to the restriction entry generation section 1031. FIG. 31 shows examples of restriction entries which may be stored in the individual restriction entry storage section 133.

Note that the individual restriction entries shown in FIG. 31 include individual restriction entries for the newly-connected device 151 (shown as new entries A, B in FIG. 31) having already been registered through the below-described process. On the other hand, the presently-described operation sequence is based on the assumption that such new entries A and B are yet to be registered. Since the controlled terminal 151 is a newly-added device to the IEEE1394 bus 170, the GUID of the controlled terminal 151 is not registered in the individual restriction entry storage section 133 yet. Because no restriction entries having a matching GUID are found registered in the individual restriction entry storage section 133, the restriction entry generation section 1031 requests the individual restriction entry storage section 133 to search for restriction entries which match the conditions with respect to “user ID”, “device category”, and “network embracing the controlling terminal” information, from among the restriction entries which are registered in order to be applied to the other devices. Upon receiving this request, the individual restriction entry storage section 133 searches for the associated restriction information, and notifies the result of the search to the restriction entry generation section 1031. Based on such restriction information, the restriction entry generation section 1031 determines restriction information to be associated with the set of conditions which does not have any corresponding restriction entries registered. Specifically, the restriction information is determined based on a logical AND among the acquired units of restriction information, where an access enabled state of restriction information is defined as “1” and an access disabled state defined as “0”. The determination based on a logical AND is advantageous in that any newly-connected device or service will not become accessible unless all units of restriction information that has been set are in an “access enabled” state. Thus, grant of access based on insufficient stochastic reasoning can be prevented.

The restriction entry which has been newly created in the above manner is registered in the individual restriction entry storage section 133 as in the fashion of the second embodiment. The restriction entry generation section 1031 notifies the requested restriction entries to the control menu generation section 112, and the control menu generation section 112 generates the control menu based on the notified restriction entry. The control menu is transmitted to the controlling terminal 141 via the control menu transmission section 113. The controlling terminal 141 displays a control menu on a browser, and the user is allowed to manipulate the controlled terminal 151 based on the control menu.

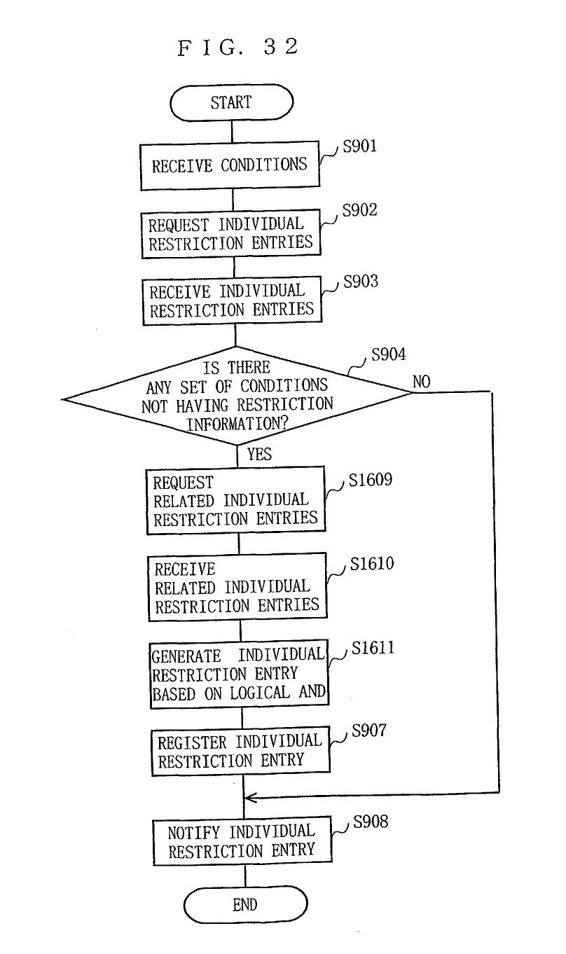

Now, with reference to the flowchart of FIG. 32, the operation of the restriction entry generation section 1031 will be described. For clarity, the following description will be directed to a specific exemplary case where the element information shown in FIG. 29 is stored in the network information storage section 123, further assuming that the restriction entries concerning the controlled terminal 151 whose GUID is “0×0123456789012345” (i.e., new entries A, B in FIG. 31) among the individual restriction entries shown in FIG. 31 have not been registered. In the following description, any processing steps in FIG. 32 which are identical to their counterparts in the flow shown in FIG. 25 will be denoted by the same reference numerals as those used therein, and the descriptions thereof will be omitted.

The restriction entry generation section 1031 notifies a set of conditions received from the control menu generation section 112 to the individual restriction entry storage section 133, and acquires restriction entries that correspond to the notified set of conditions from the individual restriction entry storage section 133. Specifically, the following entries are acquired:

GUID=0×0123456789012345

user ID=Jack

“network embracing the controlling terminal” information=Internet

device category=VCR

restriction information=

GUID=0×0×0123456789123456

user ID=Jack

“network embracing the controlling terminal” information=Internet

device category=VCR

restriction information=access enabled

GUID=0×0123456789234567

user ID=Jack

“network embracing the controlling terminal” information=Internet

device category=VCR

restriction information access enabled

At step S904, it is confirmed whether or not any set of conditions exists which does not have corresponding restriction information. If there is such a set of conditions, the control proceeds to step S1609; otherwise, the control proceeds to step S908. In this example, the set of conditions beginning with GUID=0×0123456789012345 is a set of conditions which does not have corresponding restriction information. At step S1609, with respect to the set of conditions which does not have corresponding restriction information, a request for notifying restriction entries corresponding to this set of conditions (that is, except for the GUID and the restriction information) is made to the individual restriction entry storage section 133. At step S1610, the restriction entries requested at the preceding step S1609 are received. Specifically, the following entries are received at this step:

user ID=Jack

“network embracing the controlling terminal” information=Internet

device category=VCR

restriction entry=access enabled

user ID=Jack

“network embracing the controlling terminal” information=Internet

device category=VCR

restriction entry=access enabled

At step S1611, a logical AND among the units of restriction information in these restriction entries is determined as the restriction information for the aforementioned set of conditions which does not have any corresponding restriction entries registered. Thus, the following restriction entry is generated:

GUID=0×0123456789012345

user ID=Jack

“network embracing the controlling terminal” information=Internet

device category=VCR

restriction entry=access enabled

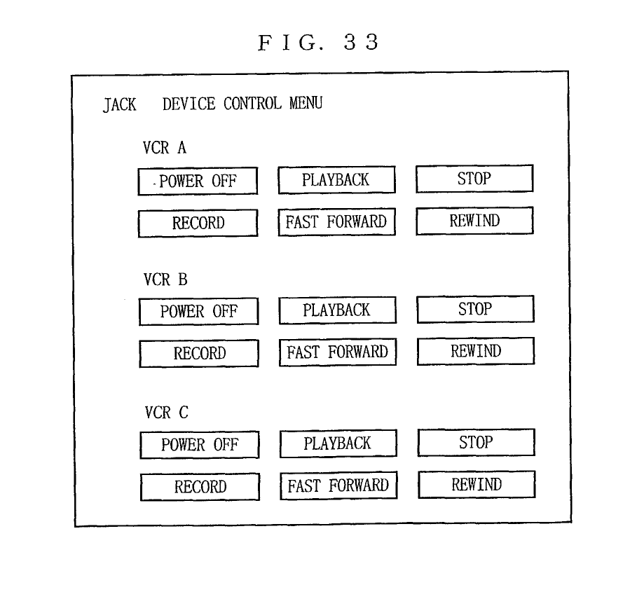

At step S907, the newly-generated restriction entry is registered in the individual restriction entry storage section 133. As a result, an individual restriction entry (indicated as new entry A in FIG. 31) is newly registered. At step S908, a restriction entry which corresponds to the request is notified to the control menu generation section 112. The control menu generation section 112 generates a control menu by selecting, from the service information shown in FIG. 29, only those items for which access is permitted based on the individual restriction entries shown in FIG. 31. Thus, as shown in FIG. 33, a control menu including the VCR (A) 151, the VCR (B) 152, and the VCR (C) 1054 is displayed on the controlling terminal 141 manipulated by the user “Jack”.

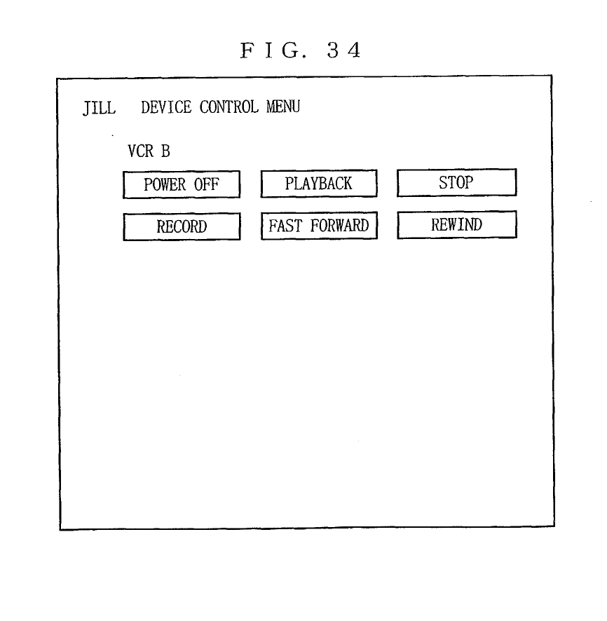

On the other hand, if the user “Jill” has requested a control menu from the controlling terminal 141, new entry B shown in FIG. 31 is newly registered through similar processes to those described above, and the control menu generation section 112 generates a control menu by selecting, from the service information shown in FIG. 29, only those items for which access is permitted based on the individual restriction entries shown in FIG. 31, as is the case for Jack. As a result, as shown in FIG. 34, a control menu which is directed only to the VCR (B) 152 is displayed on the controlling terminal 141 manipulated by the user “Jill”.

The individual restriction entries stored in the individual restriction entry storage section 133 can be set by the user by means of the input section 134. The individual restriction entries which are generated by the restriction entry generation section 1031 and registered in the individual restriction entry storage section 133 can also be set by the user by means of the input section 134.

Although a request for a control menu from the controlling terminal 141 which is connected to the Internet 160 is illustrated as an example of access from outside of the home in the present embodiment, the out-of-home network may be any network other than the Internet. Moreover, a control menu may be requested from a controlling terminal connected to an in-home network, e.g., the IEEE1394 bus 170 or any other network to control a “controlled” apparatus.

Although the present embodiment illustrates “Jack” and “Jill” as user ID's, these are merely exemplary of ID's for identifying users, and may instead be set up to the discretion of each user. Although user ID's which are directed to individuals such as “Jack” and “Jill” are illustrated as a condition concerning users, the condition may instead be classified based on an attribute of users, e.g., network administrators, family members, or guests.

Although the present embodiment illustrates the IEEE1394 bus 170 as a network to which controlled terminals are connected and the Internet 160 as a network to which controlling terminals are connected, any other network may be used instead. The networks may be wired or wireless. Examples of other networks include ECHONET, Bluetooth, etc.

Although the present embodiment illustrates an example where two networks are connected to the communication apparatus 1000, any number of networks, e.g., one, or three or more, may be connected to the communication apparatus 1000.

Although the services illustrated in the present embodiment are independently provided by each device, the present invention is also applicable to services which involve the use of two devices, e.g., dubbing operations between VCR's or setting of a communication path.

As conditions for restriction entries, any parameters other than those used in the present embodiment may be used instead. For example, service information, “network embracing the controlled terminal” information, usage time, or processing abilities of devices, e.g., displaying ability/sound reproduction ability, may also be used.

Although the present embodiment illustrates VCR's (A), (B), and (C) as examples of “controlled” terminals, any one of these devices may act as a “controlling” terminal with which to control the other controlled devices. For example, the VCR (A) may control the VCR (B) via the communication apparatus.

Although the present embodiment illustrates VCR's as device categories, other types of categories may also be used, such as “AV device”, “air-conditioning device”, etc.

Although restriction entries are generated from individual restriction entries based on a logical AND of restriction information according to the present embodiment, the restriction entries may be generated based on a logical OR or a majority of restriction information.

In the present embodiment, restriction of control is made based on the element information stored in the network information storage section 123. Alternatively, when the control menu generation section 112 requests element information, the network information acquisition section 122 may acquire element information, and notify it to the control menu generation section 112. In the case where element information is stored, there is an advantage in that the an improved response to user manipulation is provided. In the case where element information is acquired on demand, on the other hand, there is an advantage in that storage capacity for storing element information is unnecessary.

Although the present embodiment illustrates an example where restriction entries corresponding to new conditions are generated when generating a control menu, it is also possible to generate such restriction entries at an earlier time. For example, the generation of such restriction entries may occur upon detection of a new component element. In this case, there is an advantage in that the length of the time which lapses after a user requests a control menu until the control menu is received is reduced as compared to the case where such restriction entries are generated at the time of generating a control menu.

As described above, according to the third embodiment, even if no individual restriction entries are found that correspond to a given set of conditions, corresponding individual restriction entries are generated from already-registered individual restriction entries based on a logical AND, a logical OR, or a majority of restriction information. Since it is thus unnecessary to retain preset restriction entries, the required memory capacity is reduced according to the present embodiment. Moreover, a user does not need to set access restrictions at each time. Thus, it is possible to start using any new service to be used without having to make access settings for each service.

Since access restrictions are set based on device categories, both convenience-oriented and security-oriented restrictions can be realized by, for example, providing a relatively low level of security with respect to AV devices such as VCR's while providing a higher level of security for air-conditioning devices and the like.

### FOURTH EMBODIMENT

Hereinafter, a communication apparatus according to a fourth embodiment of the present invention will be described with reference to the figures.

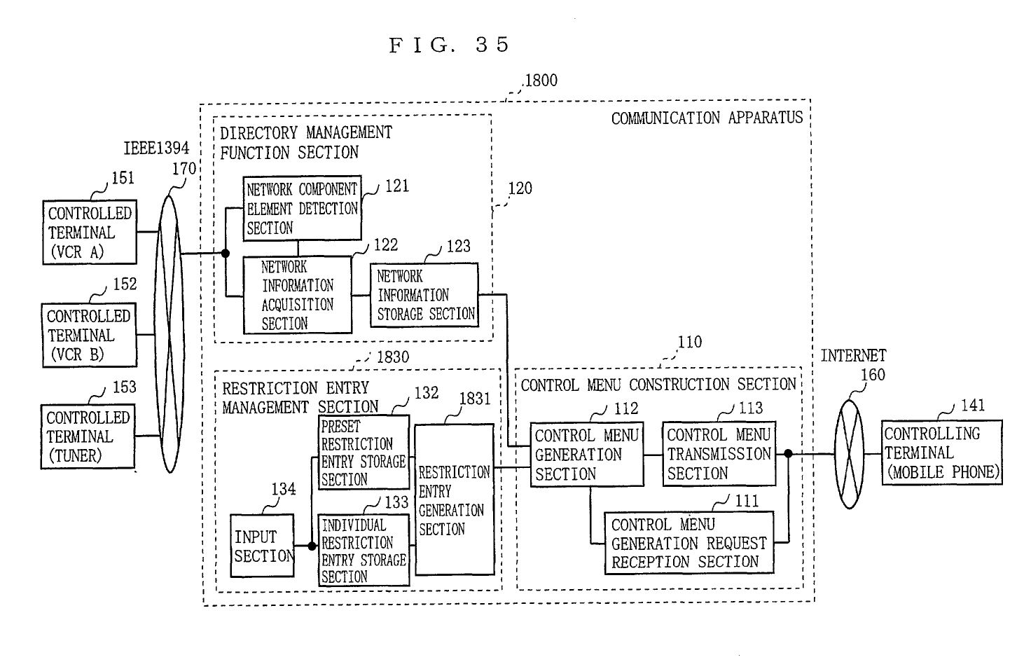

FIG. 35 illustrates the communication apparatus 1800 according to the present embodiment, networks connected thereto, and controlling terminals and controlled terminals connected to the networks. As shown in FIG. 35, the communication apparatus 1800 includes a control menu generation section 110, a directory management function section 120, and a restriction entry management section 1830. The control menu construction section 110 includes a control menu generation request reception section 111, a control menu generation section 112, and a control menu transmission section 113. The directory management function section 120 includes a network component element detection section 121, a network information acquisition section 122, and a network information storage section 123. The restriction entry management section 1830 includes a restriction entry generation section 1831, a preset restriction entry storage section 132, an individual restriction entry storage section 133, and an input section 134. The communication apparatus 1800 is connected to the Internet 160 and an IEEE1394 bus 170. A controlling terminal 141 (e.g., a mobile phone) is connected to the Internet 160. Controlled terminals 151 to 153 (e.g., VCR's (A), (B), and a tuner), which are equipped with AV/C commands, are connected to the IEEE1394 bus 170. In FIG. 35, the constituent elements which also appear in FIG. 17 are denoted by the same reference numerals as those used therein, and the descriptions thereof are omitted.

Hereinafter, the operation of the communication apparatus 1800 will be described, especially with respect to differences from the operation of the communication apparatus 100 according to the second embodiment and the operation of the communication apparatus 1000 according to the third embodiment. The following description is directed to the case where the device 151 is newly connected, and a user (“Jack”) requests a control menu in order to control the devices 151, 152, and 1054 from the device 141, which is connected to the Internet 160.

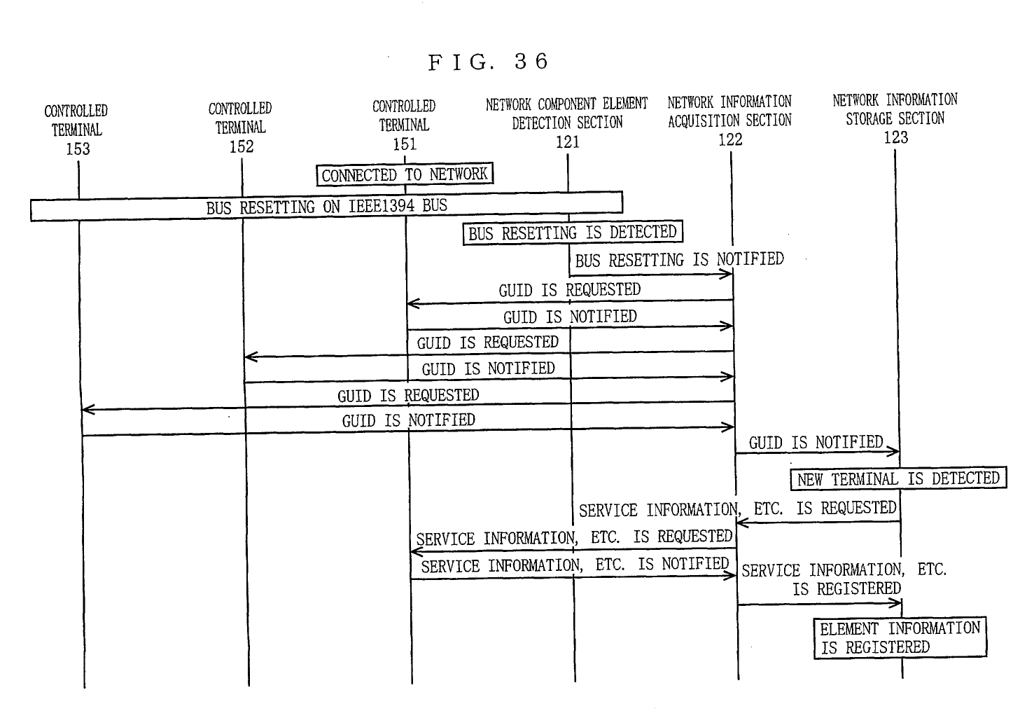

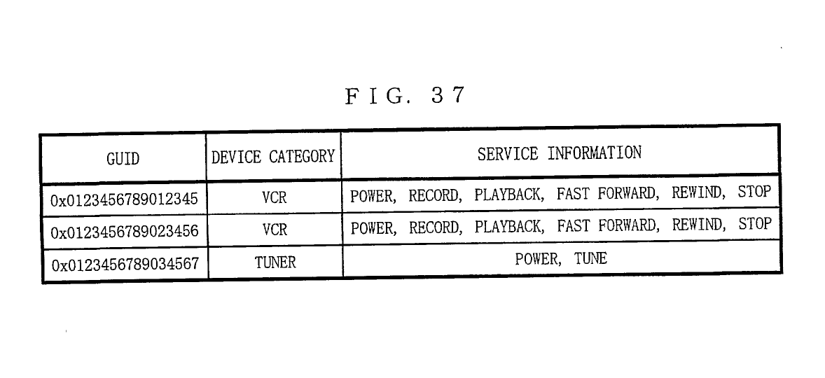

FIG. 36 illustrates an operation sequence in the case where the device 151 is connected to the IEEE1394 bus 170. As shown in FIG. 36, through an operation similar to that according to the second embodiment, element information is updated and registered in the network information storage section 123. FIG. 37 shows an example of element information stored in the network information storage section 123.

As in the second embodiment, the control menu construction section 110 generates a control menu in response to a request from the controlling terminal 141. At this time, a request for restriction entries is made to the restriction entry management section 1830. The restriction entry management section 1830 returns to the control menu generation section 112 any restriction entries that correspond to a set of conditions which is notified from the control menu generation section 112. In the case where no restriction entry that matches the notified set of conditions is found in the individual restriction entry storage section 133, different operations occur depending on the situation. Specifically, if at least a threshold number of restriction entries which are necessary for generating a restriction entry corresponding to the aforementioned set of conditions in the sense of the third embodiment are found among the restriction entries that are already stored in the individual restriction entry storage section 133, then a restriction entry to be associated with the set of conditions is generated based on such restriction entries, in a manner similar to the third embodiment. On the other hand, if at least the threshold number of restriction entries which are necessary for generating a restriction entry corresponding to the aforementioned set of conditions are not found, then a restriction entry to be associated with the set of conditions is generated based on the preset restriction entries stored in the preset restriction entry storage section 132, in a manner similar to the second embodiment. Hereinafter, the details of these operations will be described.

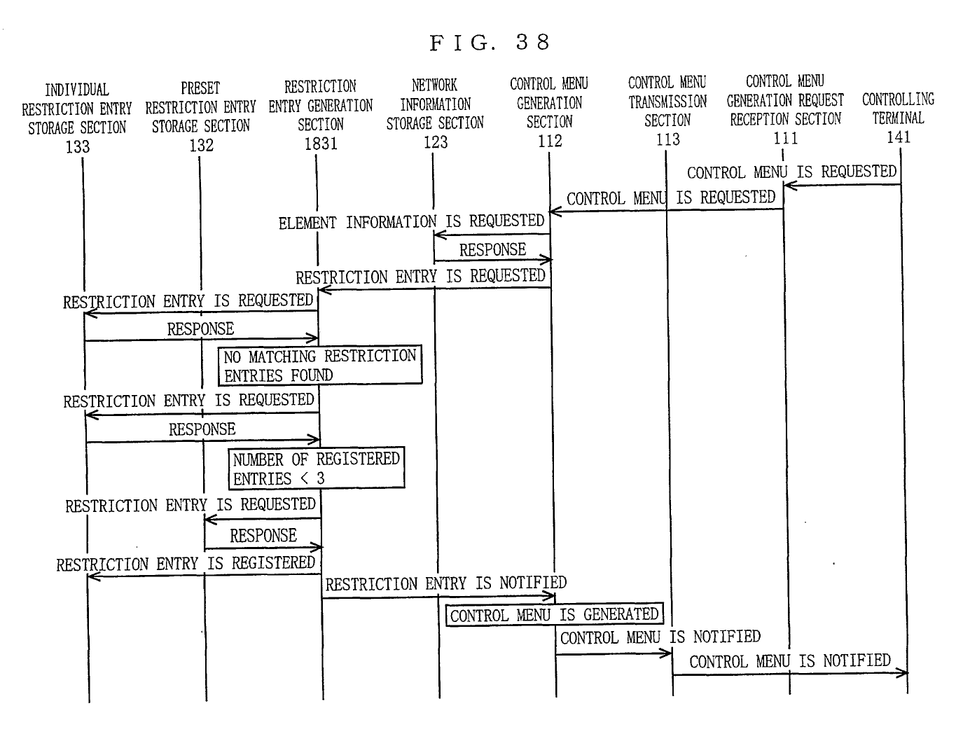

FIG. 38 illustrates an operation sequence in the case where a user which is registered with the user ID “Jack” acquires a control menu for controlling the controlled terminal 151 using the mobile phone 141 connected to the Internet. The series of processes from requesting a control menu through manipulation of the controlling terminal 141 to the issuance of a restriction entry request to the restriction entry generation section 1831 is similar to those in the second and third embodiments, and the descriptions thereof are omitted.

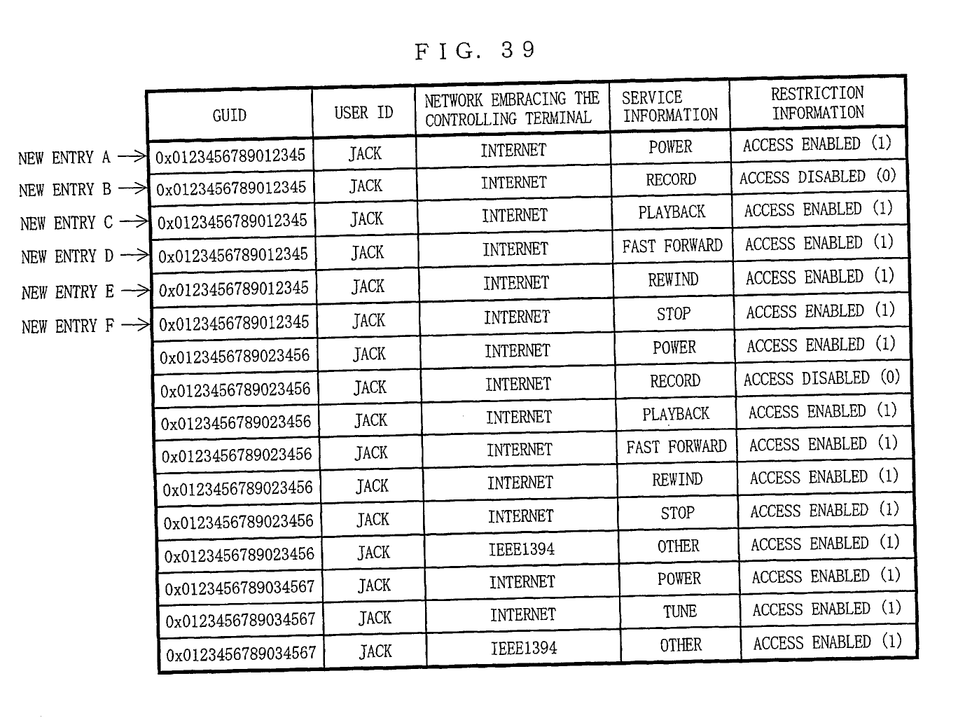

The restriction entry generation section 1831 sends the received set of conditions to the individual restriction entry storage section 133, and requests issuance of corresponding restriction entries. The individual restriction entry storage section 133 searches for restriction information that matches the received set of conditions, and notifies the result of the search to the restriction entry generation section 1831. FIG. 39 shows examples of restriction entries which may be stored in the individual restriction entry storage section 133.

Note that the individual restriction entries shown in FIG. 39 include individual restriction entries for the newly-connected device 151 (shown as new entries A, B, C, D, and F in FIG. 39) having already been registered through the below-described process. On the other hand, the presently-described operation sequence is based on the assumption that such new entries A to F are yet to be registered. Note that FIG. 39 illustrates a case where the condition defined in the service information is stipulated as a condition in the restriction entries.

Since the controlled terminal 151 is a newly-added device to the IEEE1394 bus 170, the GUID of the controlled terminal 151 is not registered in the individual restriction entry storage section 133 yet. Because no restriction entries having a matching GUID are found registered in the individual restriction entry storage section 133, the restriction entry generation section 1831 requests the individual restriction entry storage section 133 to search for restriction entries which match the conditions with respect to “user ID”, “device category”, and “network embracing the controlling terminal” information, from among the restriction entries which are registered in order to be applied to the other devices. Upon receiving this request, the individual restriction entry storage section 133 searches for the associated individual restriction entries, and notifies the result of the search to the restriction entry generation section 1831. The restriction entry generation section 1831 counts the number of notified restriction entries, and if the counted number is smaller than three, a process similar to that in the second embodiment is performed as shown in FIG. 38. Specifically, the restriction entry generation section 1831 transmits the conditions except for the GUID and the restriction information to the preset restriction entry storage section 132, and the preset restriction entry storage section 132 searches for restriction entries that match these conditions among the previously-registered preset restriction entries, and notifies the result of the search to the restriction entry generation section 1831. FIG. 40 shows examples of preset restriction entries which may be stored in the preset restriction entry storage section 132. The restriction entry generation section 1831 registers a new restriction entry, which associates the above conditions with the notified restriction information, in the individual restriction entry storage section 133, and notifies the requested restriction entries to the control menu generation section 112.

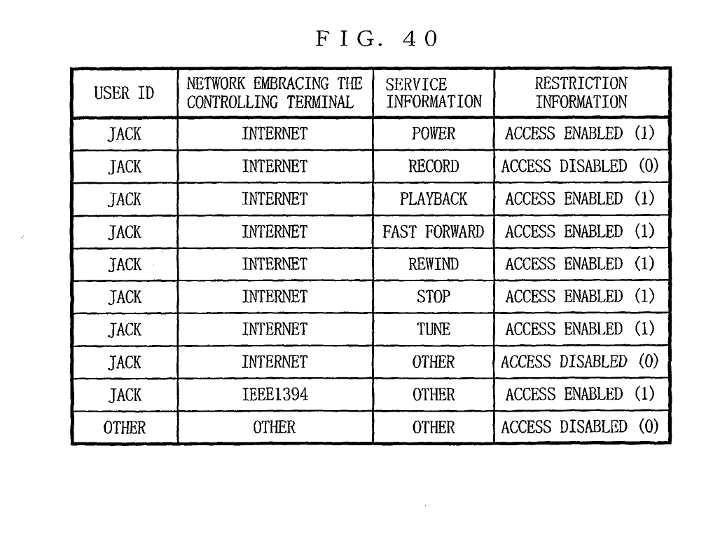

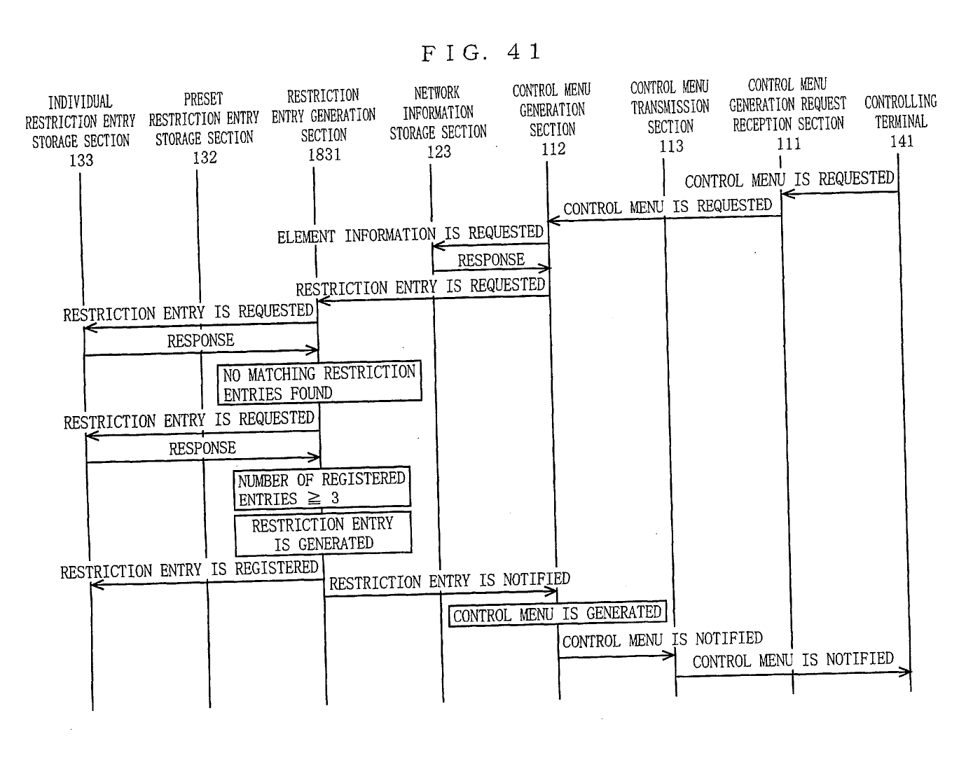

On the other hand, if the number of notified restriction entries as counted by the restriction entry generation section 1831 is equal to or greater than three, a process similar to that in the third embodiment is performed, as shown in FIG. 41. Specifically, the restriction entry generation section 1831 determines restriction information based on the restriction entries that are registered in order to be applied to the other devices, which are received from the individual restriction entry storage section 133, and accordingly generates a restriction entry. More specifically, the restriction information is determined based on a logical AND among the acquired units of restriction information, where an access enabled state of restriction information is defined as “1” and an access disabled state defined as “0”. The determination based on a logical AND is advantageous in that any newly-connected device or service will not become accessible unless all units of restriction information that have been set are in an “access enabled” state. Thus, grant of access based on insufficient stochastic reasoning can be prevented. Thereafter, the restriction entry generation section 1831 registers a new restriction entry, which associates the above conditions with the determined restriction information, in the individual restriction entry storage section 133, and notifies the requested restriction entries to the control menu generation section 112.

The operation after notifying the requested restriction entry to the control menu generation section 112 is similar to those in the second and third embodiments, and the descriptions thereof are omitted.

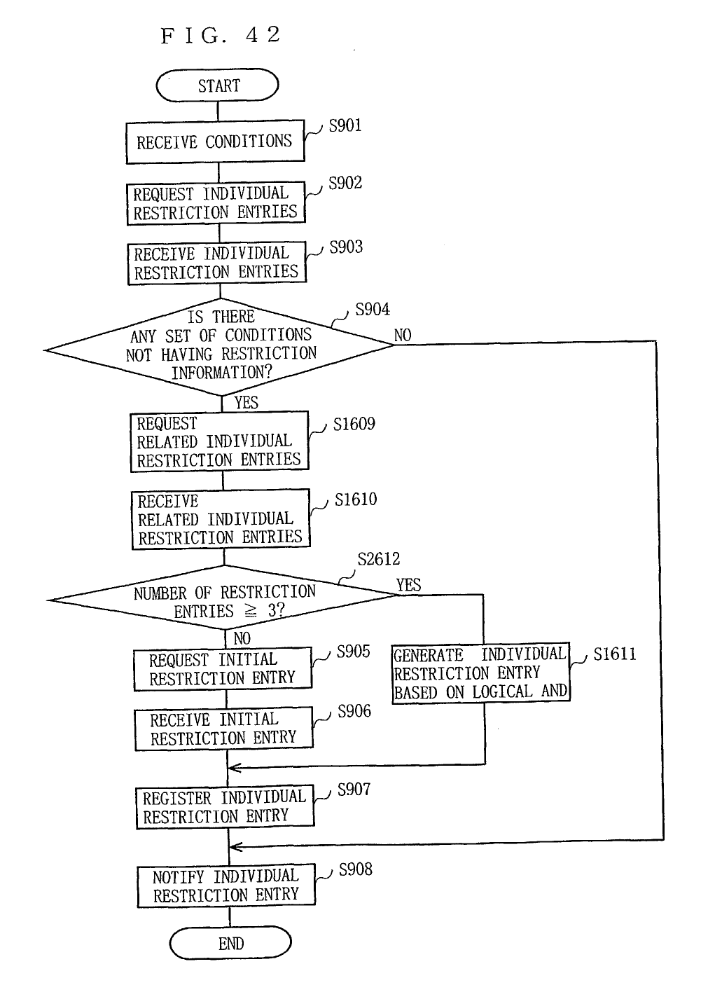

Now, with reference to the flowchart of FIG. 42, the operation of the restriction entry generation section 1831 will be described. For clarity, the following description will be directed to a specific exemplary case where the element information shown in FIG. 37 is stored in the network information storage section 123, and the preset restriction entries shown in FIG. 40 are stored in the preset restriction entry storage section 132, further assuming that the restriction entries concerning the controlled terminal 151 whose GUID is “0×0123456789012345” (i.e., new entries A to F in FIG. 39) among the individual restriction entries shown in FIG. 39 have not been registered. In the following description, any processing steps in FIG. 42 which are identical to their counterparts in the flow shown in FIG. 25 or FIG. 32 will be denoted by the same reference numerals as those used therein, and the descriptions thereof will be omitted.

In steps S901 to step S903, the restriction entry generation section 1831 notifies a set of conditions received from the control menu generation section 112 to the individual restriction entry storage section 133, and acquires restriction entries that correspond to the notified set of conditions from the individual restriction entry storage section 133. Specifically, the following entries are acquired:

GUID 0×0123456789012345

user ID=Jack

“network embracing the controlling terminal” information=Internet

service information=power

restriction information=

GUID=0×0123456789012345

user ID=Jack

“network embracing the controlling terminal” information=Internet

service information=record

restriction information=

GUID=0×0123456789012345

user ID=Jack

“network embracing the controlling terminal” information=Internet

service information=playback

restriction information=

GUID=0×0123456789012345

user ID=Jack

“network embracing the controlling terminal” information=Internet

service information=fast forward

restriction information=

GUID=0×0123456789012345

user ID=Jack

“network embracing the controlling terminal” information=Internet

service information=rewind

restriction information=

GUID=0×0123456789012345

user ID=Jack

“network embracing the controlling terminal” information=Internet

service information=stop

restriction information=

GUID=0×0123456789123456

user ID=Jack

“network embracing the controlling terminal” information=Internet

service information=power

restriction information=access enabled

GUID=0×0123456789123456

user ID=Jack

“network embracing the controlling terminal” information=Internet

service information=record

restriction information=access disabled

GUID=0×0123456789123456

user ID=Jack

“network embracing the controlling terminal” information=Internet

service information=playback

restriction information=access enabled

GUID=0×0123456789123456

user ID=Jack

“network embracing the controlling terminal” information=Internet

service information=fast forward

restriction information=access enabled

GUID=0×0123456789123456

user ID=Jack

“network embracing the controlling terminal” information=Internet

service information=rewind

restriction information=access enabled

GUID=0×0123456789123456

user ID=Jack

“network embracing the controlling terminal” information=Internet

service information=stop

restriction information=access enabled

GUID=0×0123456789234567

user ID=Jack

“network embracing the controlling terminal” information=Internet

service information=power

restriction information=access enabled

GUID=0×0123456789234567

user ID=Jack

“network embracing the controlling terminal” information=Internet

service information=tune

restriction information=access enabled

At step S904, it is confirmed whether or not any set of conditions exists which does not have corresponding restriction information. If there is such a set of conditions, the control proceeds to step S1609; otherwise, the control proceeds to step S908. In this example, the set of conditions beginning with GUID=0×0123456789012345 is a set of conditions which does not have corresponding restriction information. At step S1609, with respect to the set of conditions which does not have corresponding restriction information, a request for notifying restriction entries corresponding to this set of conditions (that is, except for the GUID and the restriction information) is made to the individual restriction entry storage section 133. At step S1610, the restriction entries requested at the preceding step S1609 are received. Specifically, the following entries are received at this step:

user ID=Jack

“network embracing the controlling terminal” information=Internet

service information=power

restriction information=access enabled

number of matching entries=2

user ID=Jack

“network embracing the controlling terminal” information=Internet

service information=record

restriction information=access disabled

number of matching entries=1

user ID=Jack

“network embracing the controlling terminal” information=Internet

service information=playback

restriction information=access enabled

number of matching entries=1

user ID=Jack

“network embracing the controlling terminal” information=Internet

service information=fast forward

restriction information=access enabled

number of matching entries=1

user ID=Jack

“network embracing the controlling terminal” information=Internet

service information=rewind

restriction information=access enabled

number of matching entries=1

user ID=Jack

network embracing the controlling terminal“information=Internet

service information=stop

restriction information=access enabled

number of matching entries=1

At step S2612, it is determined whether the number of restriction entries received is equal to or greater than the threshold value (i.e., three). If the number is smaller than three, steps S905 and S906 are executed. If the number is equal to or greater than three, the control proceeds to step S1611. Since the number of restriction entries received is one or two in this example, the control proceeds to step S905.

At step S905, with respect to the set of conditions which does not have corresponding restriction information, a request for notifying restriction entries corresponding to this set of conditions (that is, except for the GUID and the restriction information) is made to the preset restriction entry storage section 132. At step S906, the restriction entries matching the conditions as requested at the preceding step S905 are received. Specifically, the following entries are received at this step:

user ID=Jack

network embracing the controlling. terminal” information=Internet

service information=power

restriction information=access enabled

user ID=Jack

“network embracing the controlling terminal” information=Internet

service information=record

restriction information=access disabled

user ID=Jack

“network embracing the controlling terminal” information=Internet

service information=playback

restriction information=access enabled

user ID=Jack

“network embracing the controlling terminal” information=Internet

service information=fast forward

restriction information=access enabled

user ID=Jack

“network embracing the controlling terminal” information=Internet

service information=rewind

restriction information=access enabled

user ID=Jack

“network embracing the controlling terminal” information=Internet

service information=stop

restriction information=access enabled

On the other hand, At step S1611, a logical AND among the units of restriction information received in the preceding step S1610 determined as the restriction information for the services provided on the device having this GUID.

At step S907, the restriction entries received at step S906 or generated at step S1610 are registered in the individual restriction entry storage section 133. As a result, individual restriction entries (indicated as new entries A to F in FIG. 39) are newly registered. At step S908, restriction entries which associate the conditions with restriction information are notified to the control menu generation section 112. The control menu generation section 112 generates a control menu by selecting, from the service information shown in FIG. 37, only those items for which access is permitted based on the individual restriction entries shown in FIG. 39. Thus, as shown in FIG. 43, a control menu including the VCR (A) 151, the VCR (B) 152, and the tuner 153 is displayed on the controlling terminal 141 manipulated by the user “Jack”.

Although the threshold value employed in the present embodiment is three, any other value, e.g., one, two, or four or more may instead be employed.

The individual restriction entries stored in the individual restriction entry storage section 133 can be set by the user by means of the input section 134. The individual restriction entries which are generated by the restriction entry generation section 1831 and registered in the individual restriction entry storage section 133 can also be set by the user by means of the input section 134. The preset restriction entries stored in the preset restriction entry storage section 132 can also be set by the user by means of the input section 134.

Although a request for a control menu from the controlling terminal 141 which is connected to the Internet 160 is illustrated as an example of access from outside of the home in the present embodiment, the out-of-home network may be any network other than the Internet. Moreover, a control menu may be requested from a controlling terminal connected to an in-home network, e.g., the IEEE1394 bus 170 or any other network to control a “controlled” apparatus.

Although the present embodiment illustrates “Jack” as a user ID, this is merely an exemplary ID for identifying a user, and may instead be set up to the discretion of each user. Although a user ID which is directed to an individual such as “Jack” is illustrated as a condition concerning users, the condition may instead be classified based on an attribute of users, e.g., network administrators, family members, or guests.

Although the present embodiment illustrates the IEEE1394 bus 170 as a network to which controlled terminals are connected and the Internet 160 as a network to which controlling terminals are connected, any other network may be used instead. The networks may be wired or wireless. Examples of other networks include ECHONET, Bluetooth, etc.

Although the present embodiment illustrates an example where two networks are connected to the communication apparatus 1800, any number of networks, e.g., one, or three or more, may be connected to the communication apparatus 1800.

Although the services illustrated in the present embodiment are independently provided by each device, the present invention is also applicable to services which involve the use of two devices, e.g., dubbing operations between VCR's or setting of a communication path.

As conditions for restriction entries, any parameters other than those used in the present embodiment may be used instead. For example, device categories, “network embracing the controlled terminal” information, usage time, or processing abilities of devices, e.g., displaying ability/sound reproduction ability, may also be used.

Although the present embodiment illustrates VCR's (A) and (B), and a tuner as examples of “controlled” terminals, any one of these devices may act as a “controlling” terminal with which to control the other controlled devices. For example, the tuner may control the VCR (A) via the communication apparatus.

Although the present embodiment illustrates VCR's and tuners as device categories, other types of categories may also be used, such as “AV (Audio/Visual) device”, “air-conditioning device”, etc.

Although restriction entries are generated from individual restriction entries based on a logical AND of restriction information according to the present embodiment, the restriction entries may be generated based on a logical OR or a majority of restriction information.

In the present embodiment, restriction of control is made based on the element information stored in the network information storage section 123. Alternatively, when the control menu generation section 112 requests element information, the network information acquisition section 122 may acquire element information, and notify it to the control menu generation section 112. In the case where element information is stored, there is an advantage in that the an improved response to user manipulation is provided. In the case where element information is acquired on demand, on the other hand, there is an advantage in that storage capacity for storing element information is unnecessary.

Although the present embodiment illustrates an example where restriction entries corresponding to new conditions are generated when generating a control menu, it is also possible to generate such restriction entries at an earlier time. For example, the generation of such restriction entries may occur upon detection of a new component element. In this case, there is an advantage in that the length of the time which lapses after a user requests a control menu until the control menu is received is reduced as compared to the case where such restriction entries are generated at the time of generating a control menu.

As described above, according to the fourth embodiment, even if no individual restriction entries are found that correspond to a given set of conditions, access restrictions can be realized based on preset restriction entries in the case where less than a threshold number of individual restriction entries are found to be already registered, or, in the case where at least the threshold number of individual restriction entries are found to be already registered, corresponding individual restriction entries are generated based on a logical AND, a logical OR, or a majority among the already-registered individual restriction entries. Thus, it becomes possible to reflect the general trend of the access restrictions which are actually set, while preventing access restrictions from being applied due to an insufficient number of individual restriction entries to base stochastic reasoning on. Moreover, a user does not need to set access restrictions at each time. Thus, it is possible to start using any new service to be used without having to make access settings for each service.

Since the access restrictions are set depending on the service type, both convenience-oriented and security-oriented restrictions can be realized by, for example, permitting the playback function while prohibiting the recording function.

### FIFTH EMBODIMENT

Hereinafter, a communication apparatus according to a fifth embodiment of the present invention will be described with reference to the figures.

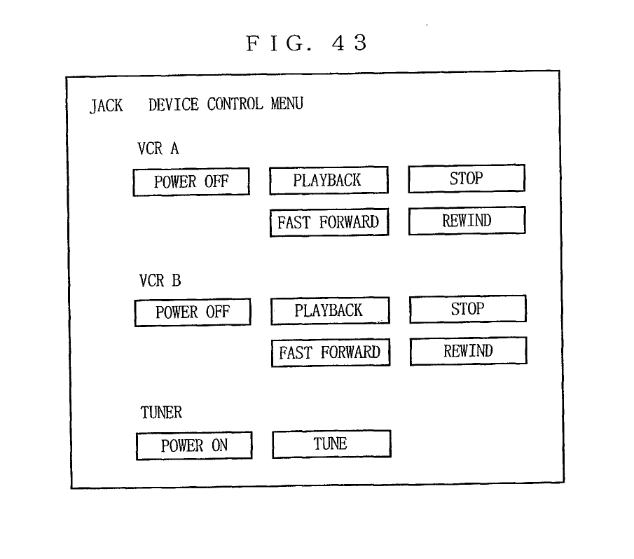

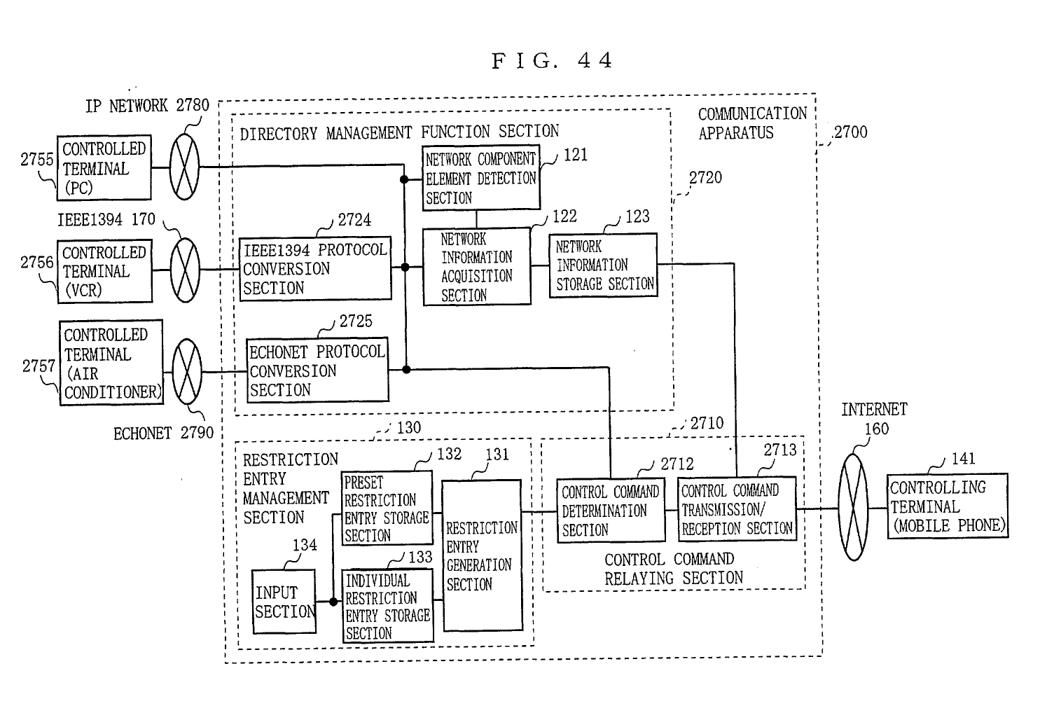

FIG. 44 illustrates the communication apparatus 2700 according to the present embodiment, networks connected thereto, and controlling terminals and controlled terminals connected to the networks. As shown in FIG. 44, the communication apparatus 2700 includes a control command relaying section 2710, a directory management function section 2720, and a restriction entry management section 130. The control command relaying section 2710 includes a control command transmission/reception section 2713 and a control command determination section 2712. The directory management function section 2720 includes a network component element detection section 121, a network information acquisition section 122, a network information storage section 123, a IEEE1394 protocol conversion section 2724 which converts the Internet protocol to the IEEE1394 protocol, and an ECHONET protocol conversion section 2725 which converts the Internet protocol to the ECHONET protocol. The restriction entry management section 130 includes a restriction entry generation section 131, a preset restriction entry storage section 132, an individual restriction entry storage section 133, and an input section 134.

The communication apparatus 2700 is connected to the following networks: the Internet 160, the IP network 2780, the IEEE1394 bus 170, and the ECHONET 2790. A controlling terminal 141 (e.g., a mobile phone) is connected to the Internet 160. A controlled terminal 2755 (e.g., a PC) is connected to the IP network 2780. A controlled terminal 2756 (e.g., a VCR), as a device equipped with AV/C commands, is connected to the IEEE1394 bus 170. A controlled terminal 2757 (e.g., an air conditioner) is connected to the ECHONET 2790. The Internet 160 is an out-of-home network, whereas the other networks 2780, 170, and 2790 are in-home networks.

In FIG. 44, the constituent elements which also appear in FIG. 17 are denoted by the same reference numerals as those used therein, and the descriptions thereof are omitted. Hereinafter, the operation of the communication apparatus 2700 will be described. As an example illustrative of this operation, a case will be described where the in-home device 2757 is to be used for the first time by utilizing the device 141 which is connected to the out-of-home network (i.e., the Internet 160).

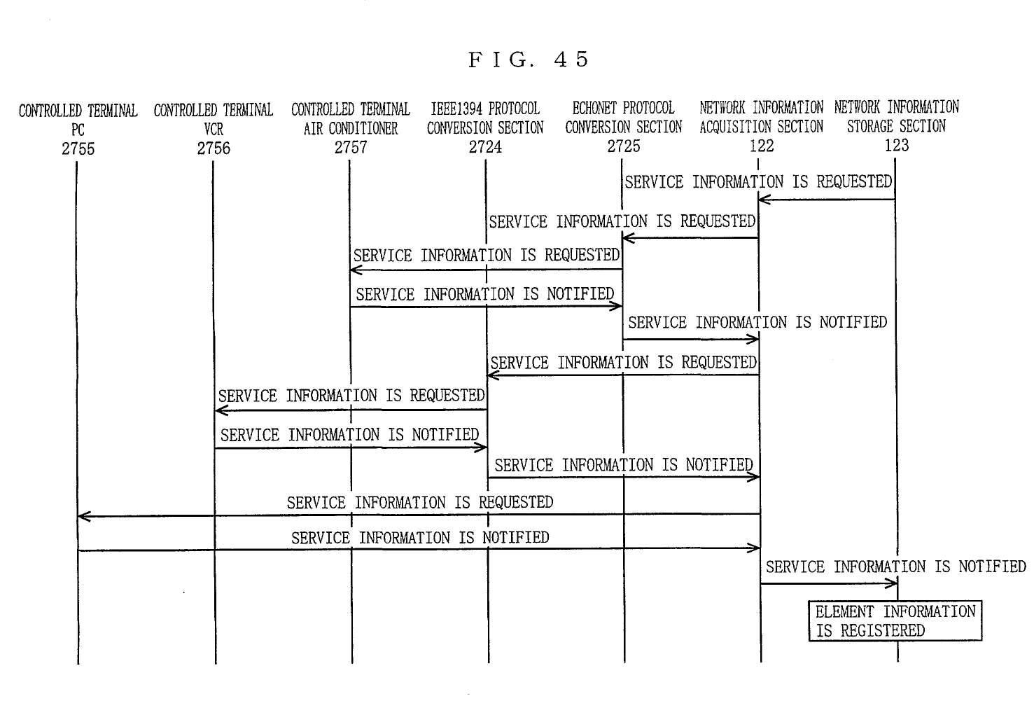

FIG. 45 illustrates an operation sequence in the case where the network information storage section 123 acquires service information concerning a device in order to generate a control menu of services.

The network information storage section 123 makes a request (“service information acquisition request”) to the network information acquisition section 122 to collect service information concerning the devices connected to the in-home network. Upon receiving the service information acquisition request, the network information acquisition section 122 requests the controlled terminal (air conditioner) 2757, the controlled terminal (VCR) 2756, and the controlled terminal (PC) 2755 connected to the respective networks to notify the service information associated therewith. Since the VCR 2756 and the air conditioner 2757 are connected to different networks, the aforementioned requests are issued through protocol conversions by the IEEE1394 protocol conversion section 2724 and the ECHONET protocol conversion section 2725, respectively.

In response to the service information acquisition request, the air conditioner 2757, the VCR 2756, and the PC 2755 transmit control commands for the services which the device can provide to the network to the network information acquisition section 122. At this time, the previously-register device names, device categories, and service names are also notified. The “device category” represents device types, e.g., “PC”, “AV device”, or “air-conditioning device”. The “device name” and the “service name” are used for allowing the users to identify the services. Preferable device names are “PC”, “VCR”, etc., and preferable service names are names indicative of the operations of control commands, e.g., “record” and “playback”.

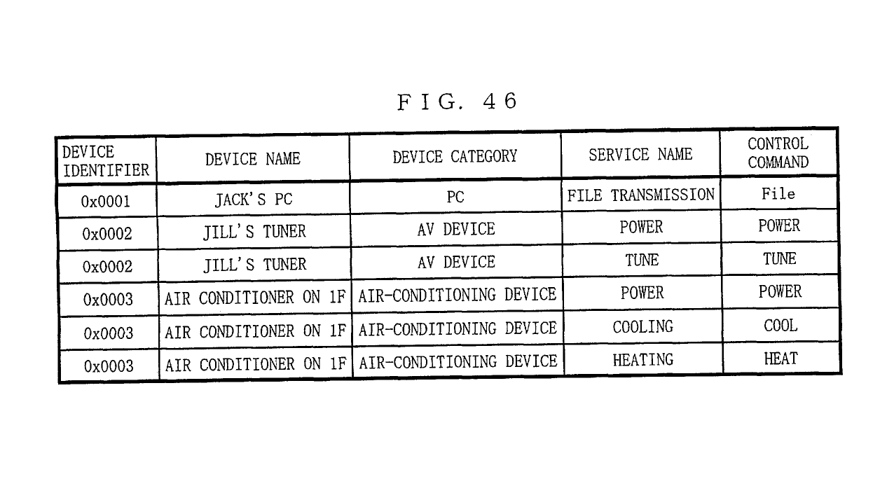

The network information acquisition section 122 registers information such as the service information collected from the respective devices in the network information storage section 123, FIG. 46 shows an example of information which may be stored in the network information storage section 123. Based on the registered information, the network information storage section 123 generates a control menu.

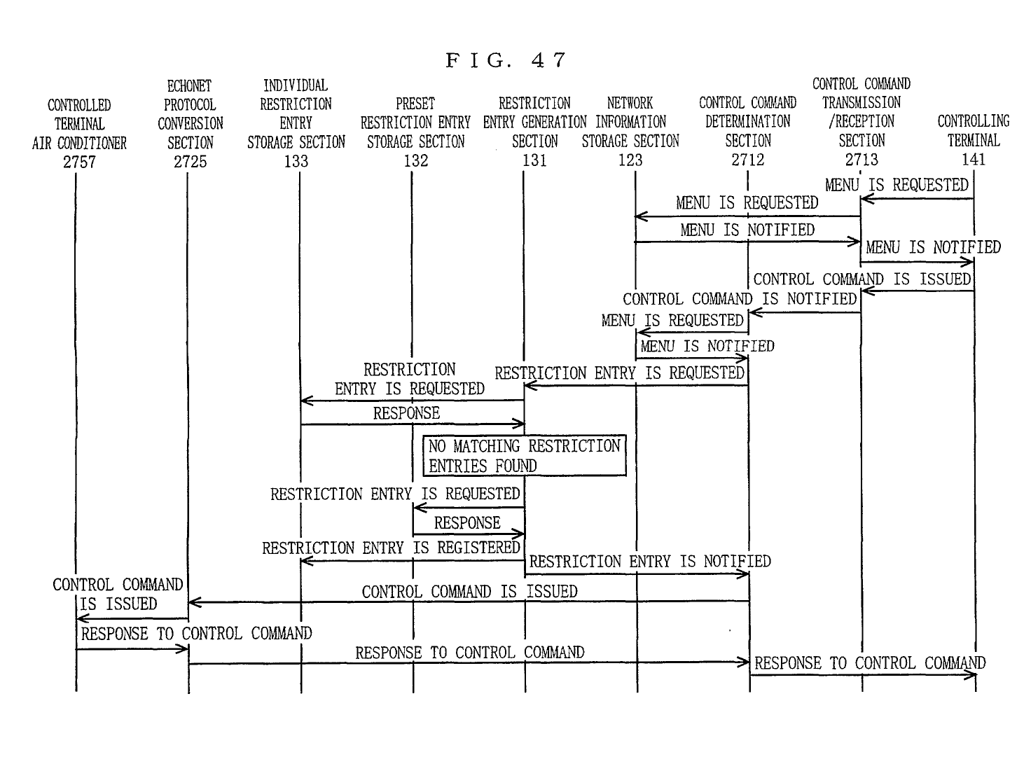

FIG. 47 illustrates an operation sequence in the case where a user acquires a control menu from the communication apparatus 2700 by using the mobile phone 141 connected to the out-of-home network (i.e., the Internet 160), and controls the air conditioner 2757 on the in-home network 2790 by issuing a control command which is available in the control menu. By manipulating the mobile phone 141, the user requests the communication apparatus 2700 to transmit the control menu retained by the communication apparatus 2700. Upon receiving the menu request, the control command transmission/reception section 2713 in the communication apparatus 2700 requests a control menu stored in the network information storage section 123. Accordingly, the network information storage section 123 transmits the control menu to the control command transmission/reception section 2713.

In turn, the control command transmission/reception section 2713 transmits the received control menu to the controlling terminal 141. The control menu may be in the form of an application which is executable by the controlling terminal 141, but is preferably a source which is described in HTML. In the case where the control menu is described in HTML, the controlling terminal 141'needs to be equipped with an HTML browser to be able to, control the device. Furthermore, it is preferable that the items displayed in the control menu are associated with control commands based on CGI or the like.

Next, the user manipulates controlling terminal 141 based on the control menu to issue a desired control command. Together with the command, the device identifier information of the controlled device is also sent. The device identifiers, which are used for the communication apparatus 2700 to uniquely identify the devices connected to each in-home network, are generated by the network information storage section 123 from an address system which is specific to each network.

The control command which is issued from the controlling terminal 141 is received by the control command transmission/reception section 2713. The control command transmission/reception section 2713 transfers the received command and device identifier to the control command determination section 2712. At this time, the information of the network embracing the controlling terminal 141 is also notified. The control command determination section 2712 requests the network information storage section 123 to notify a device category corresponding to the device identifier. In response to this request, the network information storage section 123 notifies the relevant device category.

Next, the control command determination section 2712 requests the restriction entry generation section 131 to notify restriction information corresponding to the control command received from the controlling terminal 141. As the conditions with which to search for restriction information, the device identifier, the “network embracing the controlling terminal” information, the device category, and the control command are transmitted. The restriction information indicates whether the control command is available or not.

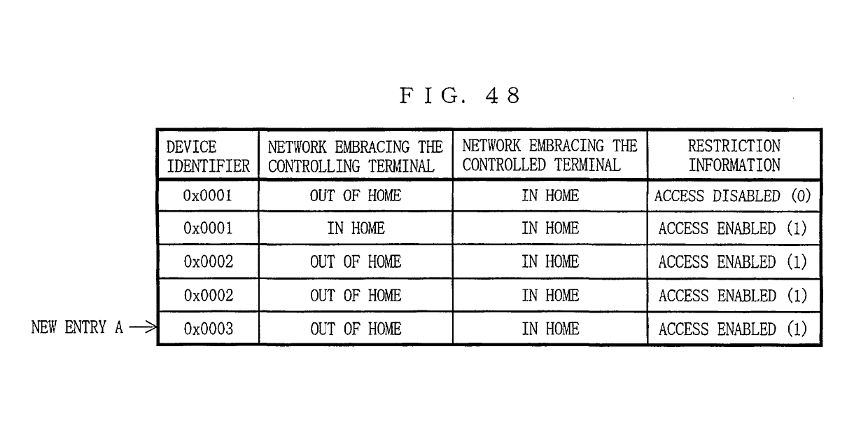

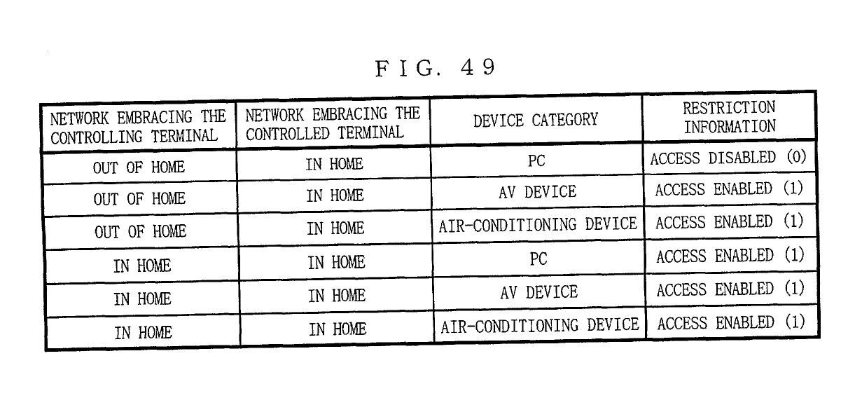

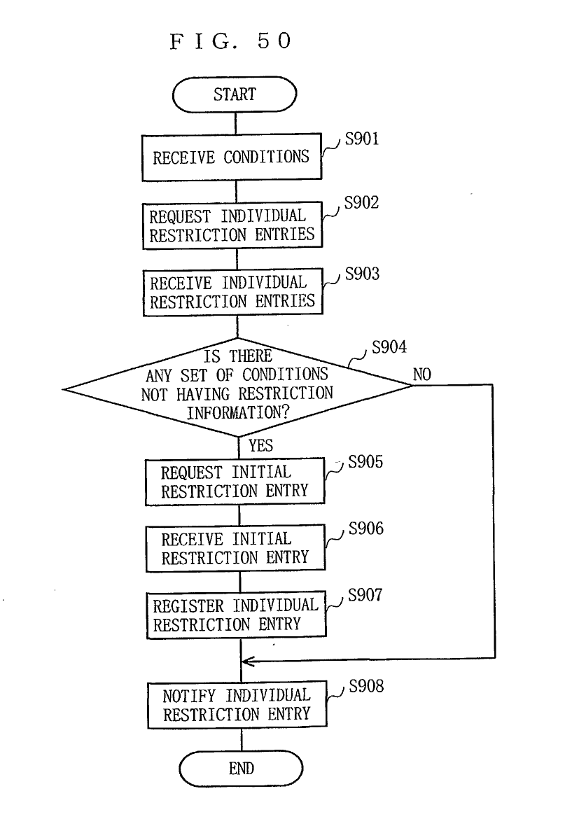

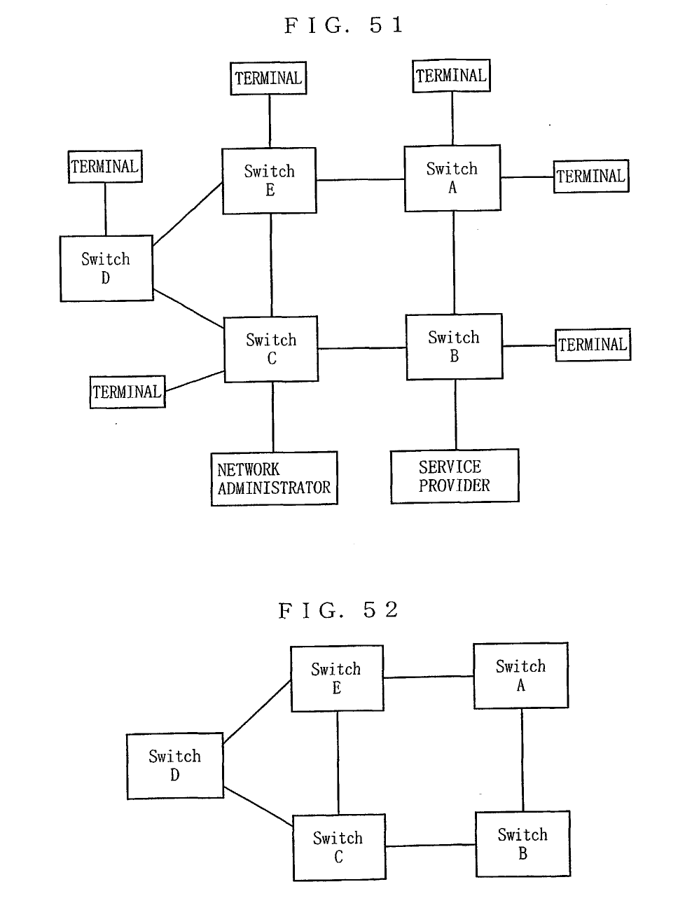

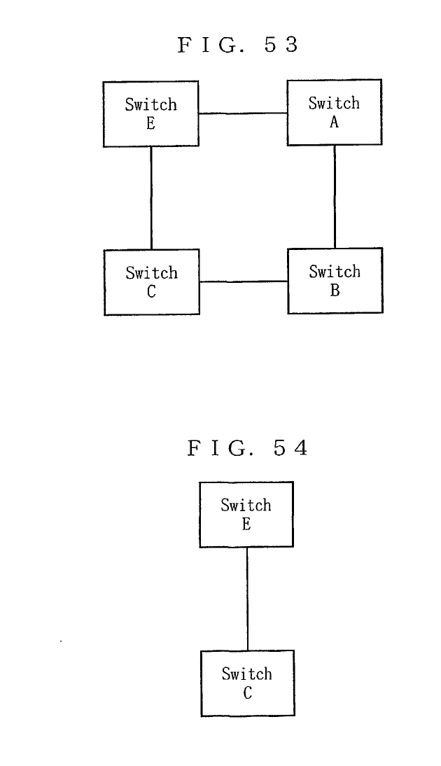

The restriction entry generation section 131 combines the received device identifier and “network embracing the controlling terminal” information, and issues a restriction entry request to the individual restriction entry storage section 133. FIG. 48 shows examples of restriction entries which may be stored in the individual restriction entry storage section 133. Note that the restriction entries shown in FIG. 48 include an individual restriction entry for the newly-connected device 2575 (shown as new entry A in FIG. 48) having already been registered through the below-described process. On the other hand, the presently-described operation sequence is based on the assumption that such a new entry A is yet to be registered. The individual restriction entry storage section 133 searches for restriction entries that match the received device identifier and “network embracing the controlling terminal” information, and notifies the result of the search to the restriction entry generation section 131. If the restriction entry generation section 131 determines that no restriction entry exists in the individual restriction entry storage section 133 that matches the conditions, the restriction entry generation section 131 transmits the “network embracing the controlling terminal” information and the device category to the preset restriction entry storage section 132. The preset restriction entry storage section 132 searches for searches for restriction entries that match these conditions among the preset restriction entry, and notifies the result of the search to the restriction entry generation section 131. FIG. 49 shows examples of preset restriction entries which may be stored in the preset restriction entry storage section 132. Since the air conditioner 2757 is to be controlled for the first time via the out-of-home network, the device identifier of the air conditioner 2757 has not been registered in the individual restriction entry storage section 133. Therefore, the restriction entry generation section 131 acquires a matching restriction entry from the preset restriction entry storage section 132. The restriction entry generation section 131 registers the notified preset restriction entry, in association with the device identifier and the “network embracing the controlling terminal” information, in the individual restriction entry storage section 133.

The restriction entry generation section 131 notifies the restriction entry, the device identifier, and the “network embracing the controlling terminal” information to the control command determination section 2712. Based on the notified restriction entry, the control command determination section 2712 determines whether the received control command may be issued or not. If the restriction entry stipulates “access enabled”, the control command determination section 2712 issues the received control command to the ECHONET protocol conversion section 2725. Then, the ECHONET protocol conversion section 2725 may alter the control command in accordance with the ECHONET specifications as necessary, and issues the control command to the air conditioner 2757.

Now, with reference to the flowchart of FIG. 50, the operation of the restriction entry generation section 131 will be described. For clarity, the following description will be directed to a specific exemplary case where the information shown in FIG. 46 is stored in the network information storage section 123, and the preset restriction entries shown in FIG. 49 are stored in the preset restriction entry storage section 132, further assuming that the restriction entry (i.e., new entry A in FIG. 48) concerning the controlled terminal 141 connected to the out-of-home network (i.e., the Internet 160) among the individual restriction entries shown in FIG. 48 has not been registered. In the following description, any processing steps in FIG. 50 which are identical to their counterparts in the flow shown in FIG. 25 will be denoted by the same reference numerals as those used therein, and the descriptions thereof will be omitted.

At step S901, from the control command determination section 2712, the restriction entry generation section 131 receives the device identifier, the “network embracing the controlling terminal” information, and the device category as conditions based on which to generate a restriction entry. Specifically, the following entry is received at this step:

device identifier 0×0003

“network embracing the controlling terminal” information=out-of-home

device category=air-conditioning device

At step S902, based on the device identifier and the “network embracing the controlling terminal” information, a request for sending individual restriction entries is made to the individual restriction entry storage section 133. At step S903, the restriction entries corresponding to the conditions as requested at step S902 are received. In this example, the absence of any restriction entries corresponding to the conditions is notified. At step S904, it is confirmed whether or not any set of conditions exists which does not have corresponding restriction information. If there is such a set of conditions, the control proceeds to step S905; otherwise, the control proceeds to step S908. In this example, the control proceeds to step S905.

At step S905, with respect to the set of conditions which does not have corresponding restriction information, a request for notifying restriction entries corresponding to this set of conditions (that is, except for the device identifier) is made to the preset restriction entry storage section 132. At step S906, the restriction information matching the conditions as requested at step S905 is received. Specifically, the following entry is received at this step:

“network embracing the controlling terminal” information=out-of-home

device category=air-conditioning device

restriction information=access enabled

At step S907, the restriction entry received at step S906 is registered in the individual restriction entry storage section 133. As a result, an individual restriction entry (indicated as new entry A in FIG. 48) is newly registered. At step S908, the conditions, in association with restriction information, is notified to the control command determination section 2712. As a result, since the restriction information designates “access enabled” with respect to controlling the air conditioner 2757 from an out-of-home network, the control command determination section 2712 notifies to the controlling terminal 141 that the execution of the command is permitted. On the other hand, if the notified restriction information designates “access disabled”, the control command determination section 2712 notifies “control disabled” to the controlling terminal 141 via the control command transmission/reception section 2713. In response to this notification, the controlling terminal 141 displays an image which may indicate“YOU DO NOT HAVE ACCESS TO THIS CONTROL COMMAND”, for example.

The individual restriction entries stored in the individual restriction entry storage section 133 can be set by the user by means of the input section 134. The individual restriction entries which are generated by the restriction entry generation section 131 and registered in the individual restriction entry storage section 133 can also be set by the user by means of the input section 134. The preset restriction entries stored in the preset restriction entry storage section 132 can also be set by the user by means of the input section 134.

Although issuance of a control command from the controlling terminal 141 which is connected to the Internet 160 is illustrated as an example of access from outside of the home in the present embodiment, the out-of-home network may be any network other than the Internet. Moreover, a control command may be issued from a controlling terminal connected to an in-home network, e.g., the IP network 2780, the IEEE1394 bus 170, the ECHONET 2790, or any other network to control a “controlled” apparatus. As an example of access from within the home, a control command may be issued from the PC 2755 to control a “controlled” apparatus.

Although the present embodiment illustrates the IEEE1394 bus 170, the IP network 2780, and the ECHONET 2790 as in-home networks and the Internet 160 as an out-of-home network, any other network may be used instead. The networks may be wired or wireless. Examples of other networks include ECHONET, Bluetooth, etc.

Although the present embodiment illustrates an example where four networks are connected to the communication apparatus 2700, any number of networks, e.g., one to three, or five or more, may be connected to the communication apparatus 2700.

Although the services illustrated in the present embodiment are independently provided by each device, the present invention is also applicable to services which involve the use of two devices, e.g., dubbing operations between VCR's or setting of a communication path.

As conditions for restriction entries, any parameters other than those used in the present embodiment may be used instead. For example, device categories, service information, user ID's, usage time, or processing abilities of devices, e.g., displaying ability/sound reproduction ability, may also be used.

Although the present embodiment illustrates a PC, a VCR, and an air conditioner as examples of “controlled” terminals, any one of these devices may act as a “controlling” terminal with which to control the other controlled devices. For example, the PC may control the VCR via the communication apparatus.

Although the present embodiment illustrates AV devices and air conditioning devices as device categories, other types of categories may also be used, such as “VCR”, “tuner”, etc.

In the present embodiment, a menu is previously generated based on the element information stored in the network information storage section 123. Alternatively, the network information acquisition section 122 may acquire element information and generate a menu when the control command transmission/reception section 2713 requests a menu. In the case where a menu is previously generated, there is an advantage in that the an improved response to user manipulation is provided. In the case where a menu is generated on demand, on the other hand, there is an advantage in that storage capacity for storing element information is unnecessary.

Although the present embodiment illustrates an example where restriction entries for a new service are generated when a control command is issued from the controlling terminal 141, it is also possible to perform the generation upon detection of a new service. Such an arrangement is preferable to the former case because the time required after the issuance of a control command by a user and before the control command relaying section 2710 determines the validity of the issued control command and issues it to the controlled terminal can be reduced.

As described above, according to the fifth embodiment, even if no individual restriction entries are found that correspond to a given set of conditions, access restrictions can be realized based on preset restriction entries. Therefore, a user does not need to set access restrictions at each time. Thus, it is possible to start using any new service to be used without having to make access settings for each service.

According to the present embodiment, access restrictions can be realized with respect to a control command which is issued from a controlling terminal, as opposed to the second embodiment where the contents of access restrictions are reflected on a control menu which is transmitted from the communication apparatus to the user. Since access restrictions are set based on the networks to which a controlling terminal and a controlled terminal are connected, both convenience-oriented and security-oriented restrictions can be realized by, for example, permitting access with respect to an out-of-home network which are open to the indefinite public (e.g., the Internet) while prohibiting access with respect to in-home networks such as IEEE1394 buses.

Hereinafter, some technological concepts which are not directly set forth in the claims but can be grasped from the embodiments of the present invention will be described, each followed by a description of the effect attained by such a concept.

A first technological concept is directed to a communication apparatus connected to one or more networks having a plurality of devices connected thereto, the plurality of devices including a controlling device and a controlled device. The communication apparatus conditionally restricts control by the controlling device over the controlled device. The communication apparatus comprises directory management means, restriction entry management means, and control restriction means. The directory management means acquires and manages information concerning the one or more networks and the plurality of devices connected to the one or more networks as element information. The restriction entry management means manages individual restriction entries each comprising control conditions and restriction information associated therewith, where the restriction information stipulates whether or not to permit control by the controlling device over the controlled device under the control conditions. The control conditions comprise at least one of: the element information, information concerning the controlling device, and an identifier of a user wishing to exert control over the controlled device by using the controlling device. The control restriction means restricts control between the devices based on the element information and the individual restriction entries. For any new control conditions not having associated restriction information, the restriction entry management means dynamically generates restriction information to be associated therewith, and registers the new control conditions and the generated restriction information as a new individual restriction entry.

Thus, according to the first technological concept, control between devices on networks can be realized in such a manner that, if no information indicating whether such control-is enabled or disabled has been registered (e.g., when a new device has been connected to a network), a restriction entry indicating whether such control is enabled or-disabled is generated in a dynamic manner, so that it is unnecessary for the user to set restrictions at each time. Therefore, even if a person without sufficient knowledge on network management happens to connect a device to a network, it is possible to allow such control to occur over the networks while maintaining a high level of network security. Security-oriented preferable settings can be dynamically made in accordance with information concerning the devices connected to the networks and information concerning the controlling device (e.g., information concerning the network embracing the controlling terminal or information concerning the abilities of the controlling device such as displaying ability/reproduction ability), information of an identifier of a user who wishes such control, and/or various other conditions, or any combinations thereof.

According to a second technological concept based on the first technological concept, the restriction entry management means comprises preset restriction entry storage means for storing preset restriction entries to be applied when no individual restriction entries exist that match a given set of control conditions. If no individual restriction entries exist that match a given set of control conditions, a new individual restriction entry corresponding to the set of control conditions is generated based on the preset restriction entries.

Thus, according to the second technological concept, in order to realize restrictions with respect to a set of control conditions which does not exist among the individual restriction entries, a security-oriented preferable control item which matches the control conditions is generated based on predetermined preset restriction entries. As a result, when a new device is connected to a network, for example, security-oriented preferable settings can be automatically set for the new device based on the predetermined preset restriction entries.

According to a third technological concept based on the first technological concept, if no individual restriction entries exist that match a given set of control conditions, the restriction entry management means selects from among the currently-managed individual restriction entries an individual restriction entry which matches the set of conditions except for one or more conditions, and generates a new individual restriction entry corresponding to the set of control conditions based on the selected individual restriction entry.

Thus, according to the third technological concept, even if no individual restriction entries have been registered that match a given set of control conditions, enablement or disablement of control concerning the set of control conditions can be automatically set based on an individual restriction entry which matches the set of conditions except for one or more conditions, as selected from among the already-registered individual restriction entries. The excluded one or more conditions may be, for example, a device identifier or an identifier of a user manipulating the controlling device. Thus, when a new device is connected to a network and a restriction entry pertinent to the identifier for the new device has not been registered, security-oriented preferable settings can be automatically made through inferences based on individual restriction entries among the already-registered individual restriction entries that match the conditions except for the device identifier, without previously requiring any special settings to be made for the new device.

According to a fourth technological concept based on the third technological concept, if no individual restriction entries exist that match a given set of control conditions, the restriction entry management means selects an individual restriction entry which matches the set of conditions except for one or more conditions from among the currently-managed individual restriction entries. If the restriction information in all of the selected individual restriction entries stipulates “control enabled”, the restriction entry management means generates a new individual restriction entry with restriction information which stipulates “control enabled” as an individual restriction entry corresponding to the set of control conditions; or, if the restriction information in any of the selected individual restriction entries stipulates “control disabled”, the restriction entry management means generates a new individual restriction entry with restriction information which stipulates “control disabled” as an individual restriction entry corresponding to the set of control conditions.

Thus, according to the fourth technological concept, with respect to a set of control conditions for which control is to be restricted, restriction information stipulating “control enabled” will be set only if all of the selected individual restriction entries stipulate “control enabled”. Thus, the danger of “control enabled” being registered (through the automatic setting of a restriction entry) for any set of conditions with respect to which control should not be permitted is precluded. As a result, the automatic setting of a restriction entry can be made in a more secure manner.

According to a fifth technological concept based on the first technological concept, the restriction entry management means comprises preset restriction entry storage means for storing preset. restriction entries to be applied when no individual restriction entries exist that match a given set of control conditions. If no individual restriction entries exist that match a given set of control conditions, the restriction entry management means performs individual restriction entry generation such that: if a predetermined number or more of individual restriction entries that match the set of conditions except for one or more conditions exist among the currently-managed individual restriction entries, the restriction entry management means generates a new individual restriction entry corresponding to the set of control conditions based on the restriction information in the individual restriction entries pertinent to the set of control conditions; or, if a predetermined number or more of individual restriction entries that match the set of conditions except for one or more conditions do not exist among the currently-managed individual restriction entries, the restriction entry management means generates a new individual restriction entry corresponding to the set of control conditions based on the preset restriction entries.

Thus, according to the fifth technological concept, with respect to a set of control conditions for which no restriction entries are registered yet, restriction information can be set in the following manner. That is, if there is a predetermined number or more of individual restriction entries based on which to infer restriction information for the set of control conditions, the restriction information is set based on such individual restriction entries. On the other hand, if a predetermined number or more of such individual restriction entries do not exist, the restriction information is set based on preset restriction entries. As a result, it is possible to preclude the danger of any undesirable settings being made by relying on an insufficient number of individual restriction entries to infer restriction information for the control conditions with.

According to a sixth technological concept based on the first technological concept, the control restriction means restricts the control by the controlling device by transmitting a control menu to the controlling device, where the control menu consists of one or more services which are controllable to the controlling device, based on the individual restriction entries managed in the restriction entry management means.

Thus, according to the sixth technological concept, control over a device can be restricted simply by reflecting the contents of restriction on a control menu which is notified to a controlling device itself. Since a user who wishes to exert control can know which items are controllable in advance, device control can be realized in a manner free from the problem concerning any uncertainty as to whether control will be enabled or not prior to the execution of a control command.

According to a seventh technological concept based on the first technological concept, the control restriction means restricts the control by the controlling device by transmitting, among control commands issued from the controlling device, only those which pertain to services that are controllable to the controlling device to the controlled device, based on the individual restriction entries managed in the restriction entry management means.

Thus, according to the seventh technological concept, enablement or disablement of control is determined when a user issues a command from a controlling device. Therefore, after a control item has been altered, for example, the alteration will be immediately reflected on the control restriction, thereby facilitating even securer restrictions in a simple manner.

According to an eighth technological concept based on the first technological concept, the directory management means comprises component element detection means for detecting a new device being connected to the one or more networks.

Thus, according to the eighth technological concept, new devices connected to a network can be detected, so that the latest element information can be automatically acquired by the directory management means.

According to a ninth technological concept based on the first technological concept, the control conditions comprise a condition concerning whether the network to which the controlling device is connected is an in-home network or an out-of-home network.

Thus, according to the ninth technological concept, control can be restricted depending on whether the access is being made from within the home or from outside of the home. For example, highly secure settings can be dynamically made by permitting access from within the home while prohibiting access from outside of the home.

A tenth technological concept is directed to a communication restriction method, concerning one or more networks having a plurality of devices connected thereto, the plurality of devices including a controlling device and a controlled device, for conditionally restricting control by the controlling device over the controlled device. The communication restriction method comprises a directory management step, a restriction entry management step, and a control restriction step. The directory management step acquires and manages information concerning the one or more networks and the plurality of devices connected to the one or more networks as element information. The restriction entry management step manages individual restriction entries each comprising control conditions and restriction information associated therewith, where the restriction information stipulates whether or not to permit control by the controlling device over the controlled device under the control conditions. The control conditions comprise at least one of: the element information, information concerning the controlling device, and an identifier of a user wishing to exert control over the controlled device by using the controlling device. The control restriction step restricts control between the devices based on the element information and the individual restriction entries. For any new control conditions not having associated restriction information, the restriction entry management step dynamically generates restriction information to be associated therewith, and registers the new control conditions and the generated restriction information as a new individual restriction entry.

Thus, according to the tenth technological concept, control between devices on networks can be realized in such a manner that, if no information indicating whether such control is enabled or disabled has been registered (e.g., when a new device has been connected to a network), a restriction entry indicating whether such control is enabled or disabled is generated in a dynamic manner, so that it is unnecessary for the user to set restrictions at each time. Therefore, even if a person without sufficient knowledge on network management happens to connect a device to a network, it is possible to allow such control to occur over the networks while maintaining a high level of network security. Security-oriented preferable settings can be dynamically made in accordance with information concerning the devices connected to the networks and information concerning the controlling device (e.g., information concerning the network embracing the controlling terminal or information concerning the abilities of the controlling device such as displaying ability/reproduction ability), information of an identifier of a user who wishes such control, and/or various other conditions, or any combinations thereof.

According to an eleventh technological concept based on the tenth technological concept, the restriction entry management step comprises a preset restriction entry storage step of storing preset restriction entries to be applied when no individual restriction entries exist that match a given set of control conditions. If no individual restriction entries exist that match a given set of control conditions, a new individual restriction entry corresponding to the set of control conditions is generated based on the preset restriction entries.

Thus, according to the eleventh technological concept, in order to realize restrictions with respect to a set of control conditions which does not exist among the individual restriction entries, a security-oriented preferable control item which matches the control conditions is generated based on predetermined preset restriction entries. As a result, when a new device is connected to a network, for example, security-oriented preferable settings can be automatically set for the new device based on the predetermined preset restriction entries.

According to a twelfth technological concept based on the tenth technological concept, if no individual restriction entries exist that match a given set of control conditions, the restriction entry management step selects from among the currently-managed individual restriction entries an individual restriction entry which matches the set of conditions except for one or more conditions, and generates a new individual restriction entry corresponding to the set of control conditions based on the selected individual restriction entry.

Thus, according to the twelfth technological concept, even if no individual restriction entries have been registered that match a given set of control conditions, enablement or disablement of control concerning the set of control conditions can be automatically set based on an individual restriction entry which matches the set of conditions except for one or more conditions, as selected from among the already-registered individual restriction entries. The excluded one or more conditions may be, for example, a device identifier or an identifier of a user manipulating the controlling device. Thus, when a new device is connected to a network and a restriction entry pertinent to the identifier for the new device has not been registered, security-oriented preferable settings can be automatically made through inferences based on individual restriction entries among the already-registered individual restriction entries that match the conditions except for the device identifier, without previously requiring any special settings to be made for the new device.

According to a thirteenth technological concept based on the twelfth technological concept, if no individual restriction entries exist that match a given set of control conditions, the restriction entry management step selects an individual restriction entry which matches the set of conditions except for one or more conditions from among the currently-managed individual restriction entries. If the restriction information in all of the selected individual restriction entries stipulates “control enabled”, the restriction entry management step generates a new individual restriction entry with restriction information which stipulates “control enabled” as an individual restriction entry corresponding to the set of control conditions; or, if the restriction information in any of the selected individual restriction entries stipulates “control disabled”, the restriction entry management step generates a new individual restriction entry with restriction information which stipulates “control disabled” as an individual restriction entry corresponding to the set of control conditions.

Thus, according to the thirteenth technological concept, with respect to a set of control conditions for which control is to be restricted, restriction information stipulating “control enabled” will be set only if all of the selected individual restriction entries stipulate “control enabled”. Thus, the danger of “control enabled” being registered (through the automatic setting of a restriction entry) for any set of conditions with respect to which control should not be permitted is precluded. As a result, the automatic setting of a restriction entry can be made in a more secure manner.

According to a fourteenth technological concept based on the tenth technological concept, the restriction entry management step comprises a preset restriction entry storage step of storing preset restriction entries to be applied when no individual restriction entries exist that match a given set of control conditions. If no individual restriction entries exist that match a given set of control conditions, the restriction entry management step performs individual restriction entry generation such that: if a predetermined number or more of individual restriction entries that match the set of conditions except for one or more conditions exist among the currently-managed individual restriction entries, the restriction entry management step generates a new individual restriction entry corresponding to the set of control conditions based on the restriction information in the individual restriction entries pertinent to the set of control conditions; or, if a predetermined number or more of individual restriction entries that match the set of conditions except for one or more conditions do not exist among the currently-managed individual restriction entries, the restriction entry management step generates a new individual restriction entry corresponding to the set of control conditions based on the preset restriction entries.

Thus, according to the fourteenth technological concept, with respect to a set of control conditions for which no restriction entries are registered yet, restriction information can be set in the following manner. That is, if there is a predetermined number or more of individual restriction entries based on which to infer restriction information for the set of control conditions, the restriction information is set based on such individual restriction entries. On the other hand, if a predetermined number or more of such individual restriction entries do not exist, the restriction information is set based on preset restriction entries. As a result, it is possible to preclude the danger of any undesirable settings being made by relying on an insufficient number of individual restriction entries to infer restriction information for the control conditions with.

According to a fifteenth technological concept based on the tenth technological concept, the control restriction step restricts the control by the controlling device by transmitting a control menu to the controlling device, where the control menu consists of one or more services which are controllable to the controlling device, based on the individual restriction entries managed in the restriction entry management step.

Thus, according to the fifteenth technological concept, control over a device can be restricted simply by reflecting the contents of restriction on a control menu which is notified to a controlling device itself. Since a user who wishes to exert control can know which items are controllable in advance, device control can be realized in a manner free from the problem concerning any uncertainty as to whether control will be enabled or not prior to the execution of a control command.

According to a sixteenth technological concept based on the tenth technological concept, the control restriction step restricts the control by the controlling device by transmitting, among control commands issued from the controlling device, only those which pertain to services that are controllable to the controlling device to the controlled device, based on the individual restriction entries managed in the restriction entry management step.

Thus, according to the sixteenth technological concept, enablement or disablement of control is determined when a user issues a command from a controlling device. Therefore, after a control item has been altered, for example, the alteration will be immediately reflected on the control restriction, thereby facilitating even securer restrictions in a simple manner.

According to a seventeenth technological concept based on the tenth technological concept, the directory management step comprises a component element detection step of detecting a new device being connected to the one or more networks.

Thus, according to the seventeenth technological concept, new devices connected to a network can be detected, so that the latest element information can be automatically acquired by the directory management step.

According to an eighteenth technological concept based on the tenth technological concept, the control conditions comprise a condition concerning whether the network to which the controlling device is connected is an in-home network or an out-of-home network.

Thus, according to the eighteenth technological concept, control can be restricted depending on whether the access is being made from within the home or from outside of the home. For example, highly secure settings can be dynamically made by permitting access from within the home while prohibiting access from outside of the home.

### INDUSTRIAL APPLICABILITY

As described above, a method and apparatus for setting a fire wall according to the present invention can reconcile both security and convenience by restricting users who are entitled to accessing each terminal on an internal network from an external network, and by allowing the user to access a selected terminal on an internal network.

1. A fire wall apparatus for preventing unauthorized external access to an internal network having a plurality of servers which are coupled to an external terminal via an external network, wherein each of the plurality of servers provides a service, comprising:
a data processing section for processing communication data which is transmitted from the external terminal and setting a communication path between at least one of the plurality of servers and the external terminal based on the communication data, wherein the communication data at least comprises an external address of the external terminal and user identification data for identifying a user of the external terminal; and
a switching section for connecting the at least one server and the external terminal based on the communication path which is set by the data processing section,
wherein the data processing section includes:
a plurality of function sections; and
a communication section for receiving at least the communication data and requesting the plurality of function sections to perform processing based on the contents of the data,
wherein the plurality of function sections comprise:
an authentication function section for authenticating the user identification data;
a directory management function section for registering units of service information, where each unit of service information represents an internal address of one of the plurality of servers and a service type in association with predetermined permitted-recipient data designating an external user who is entitled to connecting to the server, and allowing a user who is given authentication by the authentication function section to select one of the units of service information whose permitted-recipient data designates the user; and
a communication path setting function section for setting the communication path using the internal address of the server represented by the unit of service information selected by means of the directory management function section and the external address of the external terminal.

2. The fire wall apparatus according to claim 1,
wherein each unit of service information registered in the directory management function section is registered based on service data at least comprising the internal address and the service type, wherein the service data is transmitted from the server.

3. The fire wall apparatus according to claim 2,
wherein the service data further comprises service deletion data indicating that the service provided by the server is unavailable, and
wherein each unit of service information registered in the directory management function section is deletable based on the service deletion data.

4. The fire wall apparatus according to claim 2,
wherein the service data further comprises permitted-recipient alteration data for altering the permitted-recipient data, and
wherein an external user who is entitled to connecting to a service, as designated in each unit of service information registered in the directory management function section, is alterable based on the permitted-recipient alteration data.

5. The fire wall apparatus according to claim 2,
wherein the service data further comprises server identification information for identifying the server in a fixed manner, and
wherein the directory management function section updates each unit of service information with respect to the internal address based on the server identification information.

6. The fire wall apparatus according to claim 1,
wherein each unit of service information registered in the directory management function section is registered based on service data at least comprising the internal address and the service type, wherein the service data is acquired from the server by the directory management function section.

7. The fire wall apparatus according to claim 1,
wherein the directory management function section registers each unit of service information based on service data at least comprising the internal address and the service type, and
wherein, if no permitted-recipient data is registered in association with the internal address of one of the plurality of servers and the service type in the directory management function section, the directory management function section automatically generates permitted-recipient data for the service data.

8. The fire wall apparatus according to claim 7,
wherein the directory management function section comprises preset permitted-recipient data storage means for storing preset permitted-recipient data to be applied if no permitted-recipient data is registered in association with the internal address of one of the plurality of servers and the service type, and
wherein, if no permitted-recipient data is registered in association with the internal address of one of the plurality of servers and the service type in the directory management function section, the directory management function section newly generates the permitted-recipient data for the service data based on the preset permitted-recipient data.

9. The fire wall apparatus according to claim 7,
wherein, if no permitted-recipient data is registered in association with the internal address of one of the plurality of servers and the service type in the directory management function section, the directory management function section selects from among the currently registered permitted-recipient data those permitted-recipient data which match a set of conditions stipulated in the service data except for one or more of the conditions, and newly generates the permitted-recipient data for the service data based on the selected permitted-recipient data.

10. The fire wall apparatus according to claim 7,
wherein the directory management function section comprises preset permitted-recipient data storage means for storing preset permitted-recipient data to be applied if no permitted-recipient data is registered in association with the internal address of one of the plurality of servers and the service type, and
wherein, if no permitted-recipient data is registered in association with the internal address of one of the plurality of servers and the service type in the directory management function section, the directory management function section selects from among the currently registered permitted-recipient data those permitted-recipient data which match a set of conditions stipulated in the service data except for one or more of the conditions, and
a) newly generates the permitted-recipient data for the service data based on the selected permitted-recipient data if the number of selected permitted-recipient data is equal to or greater than a predetermined value; or
b) newly generates the permitted-recipient data for the service data based on the preset permitted-recipient data if the number of selected permitted-recipient data is smaller than the predetermined value.

11. The fire wall apparatus according to claim 1,
wherein each unit of service information registered in the directory management function section is deleted when a predetermined period of time expires.

12. The fire wall apparatus according to claim 1,
wherein the communication path setting function section monitors data transmitted through the communication path having been set, and closes the communication path if no data is transmitted through the communication path in a predetermined period.

13. The fire wall apparatus according to claim 1,
wherein the communication path setting function section closes the communication path upon receiving service communication termination data transmitted from the external terminal, wherein the service communication termination data indicates termination of a service communication with the server.

14. The fire wall apparatus according to claim 1,
wherein the communication path setting function section closes the communication path upon receiving service communication termination data transmitted from the server, wherein the service communication termination data indicates termination of a service communication with the external terminal.

15. A fire wall apparatus for preventing unauthorized external access to an internal network having a plurality of servers which are coupled to a plurality of external terminals via an external network, wherein each of the plurality of servers provides a service, comprising:
a data processing section for processing communication data containing service data which is transmitted from at least one of the plurality of servers and setting a communication path between the server and at least one of the plurality of external terminals based on the communication data, wherein the service data at least comprises an internal address of the server and a service type; and
a switching section for connecting the server and the external terminal based on the communication path which is set by the data processing section,
wherein the data processing section includes:
a plurality of function sections; and
a communication section for receiving at least the service data and requesting the plurality of function sections to perform processing based on the contents of the data,
wherein the plurality of function sections comprise:
a directory management function section for registering units of service information, where each unit of service information represents the internal address and the service type in association with predetermined permitted-recipient data designating at least one of the plurality of external terminals which is entitled to connecting to the server; and
a communication path setting function section for, when the service information is registered, setting the communication path using the external address of at least one of the plurality of external terminals designated by the permitted-recipient data and the internal address of the, server.

16. The fire wall apparatus according to claim 15,
wherein the permitted-recipient data registered in the directory management function section designate all of the plurality of external terminals to be entitled to connecting to the server.

17. A fire wall setting method for preventing unauthorized external access to an internal network having a plurality of servers which are coupled to an external terminal via an external network, wherein each of the plurality of servers provides a service, comprising:
a data processing step of processing communication data which is transmitted from the external terminal and setting a communication path between at least one of the plurality of servers and the external terminal based on the communication data, wherein the communication data at least comprises an external address of the external terminal and user identification data for identifying a user of the external terminal; and
a connection step of connecting the at least one server and the external terminal based on the communication path which is set by the data processing step,
wherein the data processing step includes:
a communication step of receiving at least the communication data and requesting a plurality of steps to perform processing based on the contents of the data,
wherein the plurality of steps comprise:
an authentication step of authenticating the user identification data;
a directory management step of registering units of service information, where each unit of service information represents an internal address of one of the plurality of servers and a service type in association with predetermined permitted-recipient data designating an external user who is entitled to connecting to the server, and allowing a user who is given authentication by the authentication step to select one of the units of service information whose permitted-recipient data designates the user; and
a communication path setting step of setting the communication path using the internal address of the server represented by the unit of service information selected by means of the directory management step and the external address of the external terminal.

18. The fire wall setting method according to claim 17,
wherein each unit of service information registered in the directory management step is registered based on service data at least comprising the internal address and the service type, wherein the service data is transmitted from the server.

19. The fire wall setting method according to claim 18,
wherein the service data further comprises service deletion data indicating that the service provided by the server is unavailable, and
wherein each unit of service information registered in the directory management step is deletable based on the service deletion data.

20. The fire wall setting method according to claim 18,
wherein the service data further comprises permitted-recipient alteration data for altering the permitted-recipient data, and
wherein an external user who is entitled to connecting to a service, as designated in each unit of service information registered in the directory management step, is alterable based on the permitted-recipient alteration data.

21. The fire wall setting method according to claim 18,
wherein the service data further comprises server identification information for identifying the server in a fixed manner, and
wherein the directory management step updates each unit of service information with respect to the internal address based on the server identification information.

22. The fire wall setting method according to claim 17,
wherein each unit of service information registered in the directory management step is registered based on service data at least comprising the internal address and the service type, wherein the service data is acquired from the server by the directory management step.

23. The fire wall setting method according to claim 17,
wherein the directory management step registers each unit of service information based on service data at least comprising the internal address and the service type, and
wherein, if no permitted-recipient data is registered in association with the internal address of one of the plurality of servers and the service type in the directory management step, the directory management step automatically generates permitted-recipient data for the service data.

24. The fire wall setting method according to claim 23,
wherein the directory management step comprises a preset permitted-recipient data storage step of storing preset permitted-recipient data to be applied if no permitted-recipient data is registered in association with the internal address of one of the plurality of servers and the service type, and
wherein, if no permitted-recipient data is registered in association with the internal address of one of the plurality of servers and the service type in the directory management step, the directory management step newly generates the permitted-recipient data for the service data based on the preset permitted-recipient data.

25. The fire wall setting method according to claim 23,
wherein, if no permitted-recipient data is registered in association with the internal address of one of the plurality of servers and the service type in the directory management step, the directory management step selects from among the currently registered permitted-recipient data those permitted-recipient data which match a set of conditions stipulated in the service data except for one or more of the conditions, and newly generates the permitted-recipient data for the service data based on the selected permitted-recipient data.

26. The fire wall setting method according to claim 23,
wherein the directory management step comprises a preset permitted-recipient data storage step of storing preset permitted-recipient data to be applied if no permitted-recipient data is registered in association with the internal address of one of the plurality of servers and the service type, and
wherein, if no permitted-recipient data is registered in association with the internal address of one of the plurality of servers and the service type in the directory management step, the directory management step selects from among the currently registered permitted-recipient data those permitted-recipient data which match a set of conditions stipulated in the service data except for one or more of the conditions, and
a) newly generates the permitted-recipient data for the service data based on the selected permitted-recipient data if the number of selected permitted-recipient data is equal to or greater than a predetermined value; or
b) newly generates the permitted-recipient data for the service data based on the preset permitted-recipient data if the number of selected permitted-recipient data is smaller than the predetermined value.

27. The fire wall setting method according to claim 17,
wherein each unit of service information registered in the directory management step is deleted when a predetermined period of time expires.

28. The fire wall setting method according to claim 17,
wherein the communication path setting step monitors data transmitted through the communication path having been set, and closes the communication path if no data is transmitted through the communication path in a predetermined period.

29. The fire wall setting method according to claim 17,
wherein the communication path setting step closes the communication path upon receiving service communication termination data transmitted from the external terminal, wherein the service communication termination data indicates termination of a service communication with the server.

30. The fire wall setting method according to claim 17,
wherein the communication path setting step closes the communication path upon receiving service communication termination data transmitted from the server, wherein the service communication termination data indicates termination of a service communication with the external terminal.

31. A fire wall setting method for preventing unauthorized external access to an internal network having a plurality of servers which are coupled to a plurality of external terminals via an external network, wherein each of the plurality of servers provides a service, comprising:
a data processing step of processing communication data containing service data which is transmitted from at least one of the plurality of servers and setting a communication path between the server and at least one of the plurality of external terminals based on the communication data, wherein the service data at least comprises an internal address of the server and a service type; and
a connection step of connecting the server and the external terminal based on the communication path which is set by the data processing step,
wherein the data processing step includes:
a communication step of receiving at least the service data and requesting a plurality of steps to perform processing based on the contents of the data,
wherein the plurality of steps comprise:
a directory management step of registering units of service information, where each unit of service information represents the internal address and the service type in association with predetermined permitted-recipient data designating at least one of the plurality of external terminals which is entitled to connecting to the server; and
a communication path setting step of, when the service information is registered, setting the communication path using the external address of at least one of the plurality of external terminals designated by the permitted-recipient data and the internal address of the server.

32. The fire wall setting method according to claim 31,
wherein the permitted-recipient data registered in the directory management step designate all of the plurality of external terminals to be entitled to connecting to the server.
